(19) United States
(12) Patent Application Publication
(10) Pub. No.: US 2011/0020600 A1
(43) Pub. Date: Jan. 27, 2011

(54) Cellulose Acylate Film, Method for Producing Same, Optically Compensatory Film, Anti-Reflection Film, Polarizing Plate and Image Display Device

(75) Inventors: Katsumi Sasata, Kanagawa (JP); Koju Ito, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku, Tokyo (JP)

(21) Appl. No.: 12/088,810

(22) PCT Filed: Sep. 29, 2006
(86) PCT No.: PCT/JP2006/320021

§ 371 Date: Mar. 31, 2009

(30) Foreign Application Priority Data
Sep. 29, 2005 (JP) 2005-285199

(51) Int. Cl. D06N 7/04; B29D 7/01; G02F 1/13; G02F 1/1335; G02B 5/30; G02B 1/11

(52) U.S. Cl. 428/141; 264/212; 349/193; 349/96; 359/485

(57) ABSTRACT

A cellulose acylate film that has a maximum thickness difference (P−V value) of 1 μm or less within a range of a diameter of 60 mm with an arbitrary point as center, and that has an in-plane retardation Re_{(λ)} satisfying a relationship Re₍₅₉₀₎)≦5 nm and a thickness-direction retardation Rth_{(λ)} satisfying a relationship |Rth₍₅₉₀₎|≦60 nm, wherein Re_{(λ)} represents an in-plane retardation (Re) value (unit: nm) at a wavelength of λnm; and Rth_{(λ)}) represents a thickness-direction retardation (Rth) value (unit: nm) at a wavelength of λnm.

### TECHNICAL FIELD

The present invention relates to a cellulose acylate film, a method for producing same, an optically compensatory film, an anti-reflection film, a polarizing plate and an image display device.

### BACKGROUND ART

A cellulose acylate film has heretofore been used for photographic support and various optical materials due to its toughness and fire retardance. In particular, in recent years, the cellulose acylate film has bee widely used as an optical transparent film for liquid crystal display device. Because of its high optical transparency and high optical isotropy, the cellulose acylate film is an excellent optical material for devices that handle polarization such as liquid crystal display device and thus has been heretofore used as protective film for polarizer or support for optically compensatory film capable of improving display as viewed in oblique direction (viewing angle compensation).

A polarizing plate which is one of members of liquid crystal display device has a polarizer protective film stuck to at least one side of a polarizer. An ordinary polarizer is obtained by dyeing a stretched polyvinyl alcohol (PVA)-based film with iodine or a dichroic dye.

In most cases, as the protective film for polarizer there is used a cellulose acylate film, particularly triacetyl cellulose film, which can be directly stuck to PVA. It is important that the protective film for polarizer is excellent in optical isotropy. The optical properties of the protective film for polarizer drastically governs the properties of the polarizing plate.

The recent liquid crystal display devices have been required to have improvement in viewing angle properties. The optically transparent films such as protective film for polarizer and support for optically compensatory film have been required to be further optically isotropic. In order that the optical film might be optically isotropic, it is important that the retardation value represented by the product of the birefringence and the thickness of the optical resin film is small. In particular, it is necessary that not only the in-plane retardation (Re) but also the thickness-direction retardation (Rth) of the optical film be reduced to improve display as viewed in oblique direction. In some detail, when the optical properties of the optically transparent film are evaluated, it is required that Re as measured on the front side of the film be small and, even when measured at varying angles, Re show no change.

A cellulose acylate film is normally produced by a solution film-forming method. A solution film-forming method can produce a film excellent in physical properties such as optical properties as compared with other producing methods such as melt film-forming method. The solution film-forming method is normally effected in the following manner. In some detail, a polymer solution (hereinafter referred to as “dope”) having a polymer dissolved in a mixed solvent containing dichloromethane or methyl acetate as a main solvent is prepared. The dope is discharged from a casting die to form a casting bead which is then spread over a support to form a cast film. When the cast film becomes self-supporting on the support, the cast film is then peeled off the support as a film (hereinafter referred to as “swollen film”) which is then dried and wound as a film (see, e.g., Kokai Giho No. 2001-1745, Japan Institute of Invention and Innovation).

In the solution film-forming method, it is normally practiced to blow drying air against the surface of the cast film to accelerate the drying of the cast film. However, when the cast film is rapidly dried, it is likely that the surface conditions of the cast film can be deteriorated. As an approach for preventing this trouble, there is known a method which comprises predetermining the rate of drying of the cast film to 300% by mass/min (=5% by mass/s) or less as calculated in terms of dried solvent content so that drying is effected slowly (see, e.g., JP-A-11-123732). Also is known a co-casting method involving the formation of a multi-layer cast film. For example, a cast film comprising a skin layer formed on the both surfaces of a core layer as an intermediate layer is known. In this case, the viscosity of the dope constituting the core layer is raised to assure the strength of the cast film while the viscosity of the dope constituting the skin layer is lowered to enhance the smoothness of the skin layer (see, e.g., JP-A-2003-276037).

The method disclosed in the above cited reference is advantageous in that an inexpensive thin liquid crystal display device can be obtained. In the art of liquid crystal display devices for TV use, etc., however, there has been a growing demand for the enhancement of display fidelity. At the same time, the demand for the enhancement of planarity of the film has been growing. In a liquid crystal display device comprising as a retardation film a cellulose acylate film having a high retardation given by spreading an optically anisotropic layer thereover as a support, even slight thickness unevenness can be recognized as optical unevenness. Further, when an anti-reflection film is prepared from a cellulose acylate film as a support, the thickness unevenness of the support can cause reflection unevenness.

On the other hand, under conventional film-forming conditions, problems rise that the wind velocity during drying causes the occurrence of streak-like and mottle-like unevennesses. The unevennesses occurring during drying deteriorate the quality of optical film requiring excellent planarity to great disadvantage. Further, it is practiced to raise the casting speed as well as the drying speed for the purpose of enhancing the productivity of film. In this case, the aforementioned method for lowering the drying speed to smoothen the surface of the film is disadvantageous in that the productivity of film is lowered. In the aforementioned method involving the formation of a skin layer on the both surfaces of the core layer, it is always necessary that multi-layer casting be effected. Thus, this production method is not suitable for the production of desired film.

### DISCLOSURE OF THE INVENTION

An aim of the invention is to provide a cellulose acylate film having less thickness unevenness which can be used as an optical film for image display devices such as liquid crystal display device to advantage. Another aim of the invention is to provide an optically compensatory film and an anti-reflection film which are made of a cellulose acylate film having less thickness unevenness and thus are free of optical unevenness and a polarizing plate and an image display device having excellent display properties.

In some detail, the invention concerns a cellulose acylate film having the following constitution, a solution method for preparing a film, and an optically compensatory film, an anti-reflection film, a polarizing plate and an image display device comprising the cellulose acylate film. Thus, the aforementioned aims of the invention can be attained.

(1) A cellulose acylate film that has a maximum thickness difference (P−V value) of 1 μM or less within a range of a diameter of 60 mm with an arbitrary point as center, and that has an in-plane retardation Re_{(λ)} satisfying a relationship Re₍₅₉₀₎≦5 nm and a thickness-direction retardation Rth_{(λ)} satisfying a relationship |Rth₍₅₉₀₎≦60 nm,

wherein Re_{(λ)} represents an in-plane retardation (Re) value (unit: nm) at a wavelength of λnm; and

Rth_{(λ)} represents a thickness-direction retardation (Rth) value (unit: nm) at a wavelength of λnm.

(2) The cellulose acylate film as described in (1) above,

wherein the in-plane retardation Re_{(λ)} and the thickness-direction retardation Rth_{(λ)} satisfy relationships |Re₍₄₀₀₎−Re₍₇₀₀₎|≦10 and |Rth₍₄₀₀₎−Rth_{(700)|}≦35, respectively.

(3) The cellulose acylate film as described in (1) or (2) above, which comprises:

a cellulose acylate having an acyl substitution degree of from 2.85 to 3.00; and

at least one compound represented by any of formulae (1) and (2) as a compound for decreasing Re(λ) and Rth(λ) in an amount of from 0.01% to 30% by mass based on an amount of the cellulose acylate:

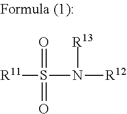

wherein R¹¹ represents an alkyl group or an aryl group; and

R¹² and R¹³ each independently represent a hydrogen atom, an alkyl group or an aryl group:

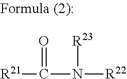

wherein R²¹ represents an alkyl group or an aryl group; and

R²² and R²³ each independently represent a hydrogen atom, an alkyl group or an aryl group.

(4) The cellulose acylate film as described in any of (1) to (3) above, which has a thickness of the film of from 40 μm to 180 μm.

(5) A solution method for preparing a film of any of (1) to (4) above, which comprises:

flow-casting a dope containing a polymer and a solvent from a casting die over a support which is endlessly running to form a cast film on the support from the dope; and then

blowing drying air onto the cast film at a velocity of 3 m/s or more since 15 seconds or less after the flow casting of the dope over the support on condition that an air flows over a surface of the cast film at a velocity of less than 3 m/s before a hitting of the drying air against the cast film; and

peeling the cast film as a film.

(6) The solution method as described in (5) above, wherein a temperature of the drying air is from not lower than 40° C. to not higher than 150° C.

(7) A solution method for preparing a film of any of (1) to (4) above, which comprises:

flow-casting a dope containing a polymer and a solvent from a casting die over a support which is endlessly running to form a cast film on the support from the dope; and then

peeling the cast film as a film,

wherein an initial film which acts as a film for initiating a formation of the film is formed on a surface of the cast film to exert a leveling effect by which the surface of the cast film is smoothened.

(8) An optically compensatory film, which comprises:

a cellulose acylate film as described in any of (1) to (4) above; and

an optically anisotropic layer provided on the cellulose acylate film.

(9) The optically compensatory film as described in (8) above,

wherein the optically anisotropic layer contains a discotic liquid crystal layer.

(10) The optically compensatory film as described in (8) or (9) above,

wherein the optically anisotropic layer contains a rod-shaped liquid crystal layer.

(11) The optically compensatory film as described in any of (8) to (10) above,

wherein the optically anisotropic layer contains a polymer film.

(12) The optically compensatory film as described in (11) above,

wherein the polymer film contained in the optically anisotropic layer contains at least one polymer material selected from the group consisting of polyamide, polyimide, polyester, polyether ketone, polyamideimide, polyesterimide and polyarylether ketone.

(13) An anti-reflection film, which comprises:

a cellulose acylate film as described in any of (1) to (4) above; and

at least one layer selected from the group consisting of a hard coat layer, an anti-glare layer and an anti-reflection layer provided on the cellulose acylate film.

(14) A polarizing plate, which comprises:

a polarizer; and

at least one of films as described in any of (1) to (4) and (8) to (13) above as a protective film for the polarizer.

(15) The polarizing plate as described in (14) above, which further comprises at least one of a hard coat layer, an anti-glare layer and an anti-reflection layer on a surface of a protective film disposed on a side of the polarizing plate opposite a liquid crystal cell.

(16) An image display device, which comprises at least one of a film as described in any of (1) to (4) and (8) to (13) above and a polarizing plate as described in (14) or (15) above.

### BRIEF DESCRIPTION OF THE DRAWING

FIG. 1 is an example of schematic diagram of film production line for effecting the solution method for producing a film of the invention;

FIG. 2 is an enlarged diagram of an essential part of FIG. 1;

FIG. 3A to 3C are examples of another embodiment of the method of blowing drying air for effecting the solution method for producing a film of the invention;

FIG. 4 is a diagrammatic view illustrating an example of the method for sticking a cellulose acylate film during the production of the polarizing plate of the invention;

FIG. 5 is a sectional view diagrammatically illustrating an example of the sectional structure of the polarizing plate of the invention; and

FIG. 6 is a sectional view diagrammatically illustrating an example of the sectional structure of the liquid crystal display device of the invention,

wherein 20 denotes film production line; 21 denotes stock tank; 22 denotes dope; 30 denotes filtering device; 31 denotes casting die; 32 denotes revolving roller; 33 denotes revolving roller; 34 denotes casting band; 35 denotes tenter drying machine; 40 denotes trimming device; 41 denotes drying chamber; 42 denotes cooling chamber; 43 denotes winding chamber; 46 denotes casting band; 50 denotes labyrinth seal; 51 denotes air supplying device; 52a, 52b denote nozzle for blowing drying air against the central portion of cast film 69 on the both edges thereof; 53 denotes nozzle for blowing drying air against the both edges of the crosswise central portion of cast film 69; 54 denotes nozzle for blowing drying air against cast film 69 toward suction port 55; 55 denotes suction port; 57 denotes drying air; 60 denotes motor; 61 denotes agitator; 62 denotes pump; 63 denotes heat transfer medium circulating device; 64 denotes casting chamber; 65 denotes temperature controlling device; 66 denotes condenser; 67 denotes recovering device; 68 denotes pressure reducing chamber; 69 denotes cast film; 69a denotes initial film; 70, 71, 72 denote other blowing ports; 73 denotes rapid drying air blowing port; 73a denotes plural nozzles; 76 denotes pressure reducing device (e.g., root blower); 80 denotes transportation portion; 81 denotes blower; 82 denotes film; 90 denotes crusher; 91 denotes multiple rollers; 93 denotes adsorption/recovering device; 94 denotes knurling roller; 95 denotes winding roller; 96 denotes press roller; and A denotes spontaneous air region.

### BEST MODE FOR CARRYING OUT THE INVENTION

The invention will be further described hereinafter.

The invention concerns a cellulose acylate film having a maximum thickness difference(P−V value) of 1 μm or less within a range of a diameter of 60 mm with an arbitrary point as center.

For the measurement of the maximum height difference (P−V) value of the film thickness, a Type FX-03 FUJINON striping analyzer was used. The area to be measured was a range having a diameter φ of 60 mm.

P−V value of film thickness thus measured is preferably 1 μm or less, more preferably from not smaller than 0 μm to not greater than 0.8 μm, even more preferably from not smaller than 0 μm to not greater than 0.6 μm, most preferably from not smaller than 0 μm to not greater than 0.4 μm. When P−V value of the thickness of the cellulose acylate film falls within the above defined range, the liquid crystal display device comprising the film or an optically compensatory film or anti-reflection film having the optically compensatory film incorporated therein as a support can undergo less optical unevenness or display unevenness.

The optical properties, i.e., Re retardation value and Rth retardation value of the cellulose acylate film of the invention satisfy the relationships Re₍₅₉₀₎≦5 nm and |Rth₍₅₉₀₎|≦60 nm, preferably Re₍₅₉₀₎≦5 nm and |Rth₍₅₉₀₎|≦25 nm, more preferably Re₍₅₉₀₎≦2 nm and |Rth₍₅₉₀₎|≦10 nm, respectively. The use of the cellulose acylate film having a small optical anisotropy makes it possible to develop substantially only the optical properties of an optically anisotropic layer having birefringence used in combination therewith. Further, the use of the cellulose acylate film having a small optical anisotropy as a protective film for polarizing plate makes it possible to suppress the occurrence of excessive birefringence attributed to protective film.

In the invention, Re_{(λ)} and Rth_{(λ)} represent the in-plane retardation and thickness-direction retardation at a wavelength of λ, respectively. Re_{(λ)} can be measured by the incidence of light having a wavelength λnm in the direction normal to the film using an automatic birefringence meter such as Type KOBRA 21 ADH birefringence meter (produced by Ouji Scientific Instruments Co. Ltd.). Rth_{(λ)} can be calculated by an automatic birefringence meter such as KOBRA 21ADH on the basis of retardation values measured in the total three directions, i.e., retardation value measured by the incidence of light having a wavelength λnm in the direction inclined at an angle of +40° from the direction normal to the film with the in-plane slow axis (judged from “KOBRA 21ADH”) as an inclined axis (rotary axis), retardation value measured by the incidence of light having a wavelength λnm in the direction inclined at an angle of −40° from the direction normal to the film with the in-plane slow axis as an inclined axis (rotary axis). As the hypothetical average refractive index there may be used one disclosed in “Polymer Handbook”, John Wiley & Sons, Inc. and various catalogues of optical films. For the cellulose acylate films having an unknown average refractive index, an Abbe refractometer may be used. The average refractive index of main optical films are exemplified below.

Cellulose acylate (1.48), cycloolefin polymer (1.52), polycarbonate (1.59), polymethylene methacrylate (1.49), polystyrene (1.59). By inputting the hypothetic average refractive indexes and film thicknesses, the automatic birefringence meter such as KOBRA 21ADH calculates n_{λ}, n_{y} and n_{z}. From n_{λ}, n_{y} and n_{z} thus calculated is calculated Nz=(nx−nz)/(nx−nz). These measurements are effected in an atmosphere of 25° C. and 60% RH unless otherwise specified. As the hypothetical average value of refractive index, the aforementioned average refractive index (1.48) of cellulose acylate was used. For the determination of the retardation at a wavelength which cannot be directly measured, fitting was made on retardation values at wavelengths close to the wavelength in question using Cauthy's equation.

The cellulose acylate film of the invention preferably has a small in-plane dispersion of optical anisotropy, particularly |Re(MAX)−Re(MIN)|≦6 and |Rth(MAX)−Rth(MIN)|≦10, preferably |Re(MAX)−Re(MIN)|≦3 and |Rth(MAX)−Rth(MIN)|≦5 (in which Re(MAX) and Rth(MAX) are maximum retardation value Re and Rth (unit: nm) of a 1 m square film arbitrarily cut out of the cellulose acylate film of the film, respectively, and Re(MIN) and Re(MIN) are minimum retardation value Re and Rth (unit: nm) of the 1 m square film, respectively.

The suppression of the in-plane dispersion of optical anisotropy of the cellulose acylate film makes it possible to exert an effect of reducing the dispersion of optical anisotropy of an optically compensatory polarizing plate prepared from the cellulose acylate film and hence the display unevenness of the liquid crystal panel comprising the optically compensatory polarizing plate.

The film of the invention which has small Re and Rth values and thus is optically anisotropic produces small Re values even when stretched. Even when various conveyance tensions are generated during production, the film of the invention can keep its in-plane dispersion of retardation values small and thus show a small in-plane dispersion of optical properties.

The cellulose acylate film of the invention preferably has a small wavelength dispersion of retardation. In particular, the cellulose acylate film preferably satisfies the relationships |Re₍₄₀₀₎−Re₍₇₀₀₎|≦10 and |Rth₍₄₀₀₎−Rth₍₇₀₀₎|≦35, more preferably |Re₍₄₀₀₎−Re₍₇₀₀₎|≦5 and |Rth₍₄₀₀₎−Rth₍₇₀₀₎|≦25, particularly preferably |Re₍₄₀₀₎−Re₍₇₀₀₎|≦3 and |Rth₍₄₀₀₎−Rth₍₇₀₀₎|≦15. When the wavelength dispersion of retardation falls within the above defined range, no unnecessary birefringence occurs in the entire visible light range, making it possible to reduce tint change to advantage.

In the invention, the thickness of the cellulose acylate film is preferably from 40 μm to 180 μm, more preferably from 60 μm to 140 μm, even more preferably from 70 μm to 120 μm.

In order to obtain the cellulose acylate film of the invention, the following solution film-forming method may be employed, though described in detail later.

A solution method for preparing a film comprising a step of flow-casting a dope containing a polymer and a solvent from a casting die over a support which is endlessly running to form a cast film on the support from the dope and then blowing drying air onto the cast film at a velocity of 3 m/s or more since 15 seconds or less after the flow casting of the dope over the support on condition that the air flows over the surface of the cast film at a velocity of less than 3 m/s before the hitting of the drying air against the cast film and a step of peeling the cast film as a film.

A solution method for preparing a film which comprises flow-casting a dope containing a polymer and a solvent from a casting die over a support which is endlessly running to form a cast film on the support from the dope, and then peeling the cast film as a film, wherein an initial film which acts as a film for initiating the formation of the film is formed on the surface of the cast film to exert a leveling effect by which the surface of the cast film is smoothened.

The term “initial film” as used herein is meant to indicate a film formed on the surface of the cast film by rapidly drying the cast film. The initial film is a layer having a relatively lower volatile content than the cast film on the bulk or support side. The initial film accelerates the growth of the cast film while the surface thereof is being smoothened by its leveling effect.

The cellulose acylate film which is preferably used in the invention will be further described hereinafter.

### <Cellulose Acylate>

The β-1,4 bonded glucose unit constituting the cellulose has a free hydroxyl group in 2-position, 3-position and 6-position. The cellulose acylate of the invention is a cellulose having its hydroxyl group acylated. The acyl group as substituent may range from acetyl group, which has two carbon atoms, to one having 22 carbon atoms. In the cellulose acylate of the invention, the degree of substitution and the average acetylation degree can be determined by measuring the degree of bonding of acetic acid and/or C₃-C₂₂ aliphatic acid which replaces the hydroxyl group in cellulose and then subjecting the measurements to calculation. The measurement can be made according to ASTM D-817-91.

In the cellulose acylate of the invention, the degree of substitution of acyl group on the hydroxyl group in the cellulose is preferably from 2.50 to 3.00, more preferably from 2.85 to 3.00, even more preferably from 2.90 to 3.00. The use of a cellulose acylate having a great substitution degree makes it possible to obtain a cellulose acylate film having a smaller optical anisotropy.

Among acetic acid and/or C₃-C₂₂ aliphatic acid which replaces the hydroxyl group in cellulose, the C₂-C₂₂ acryl group is not specifically limited and may be an aliphatic group or allyl group. These acyl groups may be used singly or in admixture of two or more thereof. Examples of these acyl groups include alkylcarbonylester, alkenylcarbonylester, aromatic carbonylester and aromatic alkylcarbonylester of cellulose. These esters each may have substituted groups. Preferred examples of these acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl. Preferred among these acyl groups are acetyl, propionyl, butanoyl, dodecanoyl, octadecanoyl, t-butanoyl, oleoyl, benzoyl, naphthylcarbonyl, and cinnamoyl. More desirable among these acyl groups are acetyl, propionyl, and butanoyl.

### <Method for Synthesis of Cellulose Acylate>

For the basic principle of method for the synthesis of cellulose acylate, reference can be made to Migita et al, “Mokuzai Kagaku (Wood Chemistry)”, Kyoritsu Shuppan, 1968, pp. 180-190. A representative synthesis method is a liquid phase acetylation method with a carboxylic anhydride-acetic acid-sulfuric acid catalyst.

In order to obtain the aforementioned cellulose acylate, explaining in detail, a raw material of cellulose such as cotton linter and wood pulp is pretreated with a proper amount of acetic acid, and then added to a previously cooled carboxylating mixture so that it is esterified to synthesize a complete cellulose acylate (sum of the acyl substitution degree in the 2-, 3- and 6-positions: approx. 3.00). The aforementioned carboxylating mixture normally contains acetic acid as a solvent, a carboxylic anhydride as an esterifying agent and sulfuric acid as a catalyst. The carboxylic anhydride is normally used in a stoichiometrically excess at the sum of the amount of the cellulose that reacts therewith and the water content in the system. After the termination of the esterification reaction, an aqueous solution of a neutralizing agent (e g., carbonate, acetate or oxide of calcium, magnesium, iron, aluminum or zinc) is added to the reaction mixture to hydrolyze excessive carboxylic anhydride left in the system and neutralize part of the esterifying catalyst. Subsequently, the complete cellulose acylate film thus obtained is kept at a temperature of from 50° C. to 90° C. in the presence of a small amount of an acetylation reaction catalyst (normally remaining sulfuric acid) so that it is saponified and ripened to a cellulose acylate having a desired acyl substitution degree and polymerization degree. When the desired cellulose acylate is obtained, the catalyst remaining in the system is completely neutralized with the aforementioned neutralizing agent. Alternatively, instead of neutralizing the catalyst, the cellulose acylate solution is added to water or diluted sulfuric acid (or water or diluted sulfuric acid is added to the cellulose acylate solution) to separate the cellulose acylate. The cellulose acylate thus separated is washed and stabilized or otherwise treated to obtain the aforementioned specific cellulose acylate.

In the aforementioned cellulose acylate film, the polymer component constituting the film is preferably composed of substantially the aforementioned specific cellulose acylate. The term “substantially” as used above is meant to indicate 55% by mass or more (preferably 70% by mass or more, more preferably 80% by mass) of the amount of the polymer component. (In this specification, mass ratio is equal to weight ratio.)

The aforementioned cellulose acylate is preferably used in particulate form. 90% by mass or more of the particles used preferably have a diameter of from 0.5 mm to 5 mm. Further, 50% by mass or more of the particles used preferably have a diameter of from 1 mm to 4 mm. The particulate cellulose acylate preferably has a shape which is as close to sphere as possible.

The polymerization degree of the cellulose acylate which is preferably used in the invention is preferably from 200 to 700, more preferably from 250 to 550, even more preferably from 250 to 400, particularly preferably from 250 to 350 as calculated in terms of viscosity-average polymerization degree. For the measurement of average polymerization degree, an intrinsic viscosity method proposed by Uda et al (Kazuo Uda and Hideo Saito, “Seni Gakkaishi (JOURNAL OF THE SOClETY OF FIBER SCIENCE AND TECHNOLOGY, JAPAN)”, vol, 18, No. 1, pp. 105-120, 1962) may be employed. For details of this intrinsic viscosity method, reference can be made to JP-A-9-95538.

When low molecular components have been removed, the resulting cellulose acylate exhibits a raised average molecular weight (polymerization degree) but a lower viscosity than ordinary cellulose acylates. Therefore, as the aforementioned cellulose acylate, those freed of low molecular components are useful. The cellulose acylate having little low molecular components can be obtained by removing low molecular components from a cellulose acylate synthesized by an ordinary method. The removal of low molecular components from a cellulose acylate can be carried out by washing the cellulose acylate with a proper organic solvent. In order to prepare a cellulose acylate having little low molecular components, it is preferred that the amount of a sulfuric acid catalyst to be used in acetylation reaction be adjusted to a range of from 0.5 to 25 parts by mass based on 100 parts by mass of cellulose. When the amount of a sulfuric acid catalyst falls within the above defined range, a cellulose acylate which is desirable also in molecular weight distribution (uniform molecular weight distribution) can be synthesized. In the production of the cellulose acylate of the invention, the cellulose acylate preferably has a water content of 2% by mass or less, more preferably 1% by mass or less, particularly preferably 0.7% by mass or less. In general, a cellulose acylate contains water and is known to have a water content of from 2.5% to 5% by mass. In order to adjust the water content of the cellulose acylate of the invention to the above defined range, it is necessary that the cellulose acylate be dried. The drying method is not specifically limited so far as the desired water content can be attained.

For the details of the cotton from which these cellulose acylates of the invention are prepared and their synthesis methods, reference can be made to Kokai Giho 2001-1745, Japan Institute of Invention and Innovation, pp. 7-12, Mar. 15, 2001.

### <Additives>

The cellulose acylate film of the invention and the solution from which it is produced may comprise various additives (e.g., compound for decreasing optical anisotropy, release accelerator, wavelength dispersion adjustor, ultraviolet inhibitor, plasticizer, deterioration inhibitor, particulate material, optical property adjustor) incorporated therein depending on the purpose at the various preparation steps. These additives will be further described hereinafter. These additives may be added at any time during the preparation of the dope but may be added at an additive step of adding them during the final preparation step of preparing the dope.

The cellulose acylate film of the invention preferably contains at least a compound for decreasing the thickness-direction retardation Rth (hereinafter occasionally referred to as “Rth decreasing agent”) in an amount satisfying the following relationships (3) and (4):

(Rth_{λA}−Rth_{λ0})/A≦−1.0 (3)

0.01≦A≦30 (4)

Preferably, the aforementioned relationships (3) and (4) are:

(Rth_{λA}−Rth_{λ0})/A≦−2.0 (3-1)

0.01≦A≦20 (4-1)

More preferably, the aforementioned relationships (3) and (4) are:

(Rth_{λA}−Rth_{λ0})/A≦−3.0 (3-2)

0.01≦A≦15 (4-2)

In the aforementioned relationships, Rth_{λA} represents Rth_{λ} (nm) of the film containing Rth_{λ} decreasing agent in an amount of A % by mass, Rth_{λ0} represents Rth_{λ} (nm) of the film free of Rth_{λ} decreasing agent, and A represents the mass (%) of Rth_{λ}, decreasing agent based on the mass of 100 of the polymer from which the film is prepared.

### (Structural Characteristics of Rth Decreasing Agent)

Rth decreasing agent for cellulose acylate film will be further described hereinafter.

In order to decrease the optical anisotropy sufficiently enough to make both Re and Rth close to zero, a compound for inhibiting the alignment of cellulose acylate in the film in the in-plane direction and in the thickness-direction is preferably used. The compound for decreasing optical anisotropy is sufficiently compatible with cellulose acylate and itself has neither rod-shaped structure nor planar structure to advantage. In some detail, when the compound has a plurality of planar functional groups such as aromatic group, these functional groups are preferably present on a non-planar surface rather than on the same planar surface.

### (Log P Value)

In order to prepare the cellulose acylate film of the invention, a compound having an octanol/water distribution coefficient (log P value) of from 0 to 7 is preferably used among the Rth decreasing agents for inhibiting the alignment of cellulose acylate in in-plane direction and thickness-direction in the film to decrease the optical anisotropy of the film. A compound having a log P value of 7 or less exhibits an excellent compatibility with cellulose acylate and thus can cause no defects such as clouding and dusting of the film. Further, a compound having a log P value of 0 or more doesn't exhibit too high a hydrophilicity and thus cannot deteriorate the water resistance of the cellulose acylate film. The aforementioned compound more preferably has a log P value of from 1 to 6, particularly preferably from 1.5 to 5.

For the measurement of octanol/water distribution coefficient (log P value), the flask shaking method disclosed in JIS Z7260-107 (2000) can be employed. The octanol/water distribution coefficient (log P value) can be estimated by a computational chemistry or empirical method instead of measured. Preferred examples of the computational chemistry employable herein include Crippen's fragmentation method (J. Chem. Inf. Comput. Sci., 27, p. 21 (1987).), Viswanadhan's fragmentation method (J. Chem. Inf. Comput. Sci., 29, p. 163 (1989).), and Broto's fragmentation method (Eur. J. Med. Chem.-Chim. Theor., 19, p. 71 (1984).). More desirable among these computational methods is Crippen's fragmentation method (J. Chem. Inf. Comput. Sci., 27, p. 21 (1987)). Whether or not a compound falls within the scope of the invention if the log P value of the compound differs by the measuring method or computational method is preferably judged by Crippen's fragmentation method.

Rth decreasing agent preferably has a molecular weight of from not smaller than 150 to not greater than 3,000, more preferably from not smaller than 170 to not greater than 2,000, particularly preferably from not smaller than 200 to not greater than 1,000. Rth decreasing agent may have a specific monomer structure or an oligomer or polymer structure formed by the combination of a plurality of these monomer units so far as the molecular weight thereof falls within the above defined range.

Rth decreasing agent preferably stays liquid at 25° C. or is a solid having a melting point of from 25° C. to 250° C., more preferably stays liquid at 25° C. or is a solid having a melting point of from 25° C. to 200° C. Rth decreasing agent preferably doesn't volatilize at the dope flow casting step and drying step during the preparation of cellulose acylate film.

The amount of Rth decreasing agent to be incorporated is preferably from 0.01 to 30% by mass, more preferably from 0.05 to 25% by mass, even more preferably from 0.1 to 20% by mass based on the amount of cellulose acylate.

Rth decreasing agents may be used singly or in admixture of two or more thereof at arbitrary ratio. Rth decreasing agent may be added at any time during the preparation of the dope or may be added at the end of the dope preparation step.

As Rth decreasing agent there is preferably used a compound represented by the following formula (1).

The compound of the formula (1) will be described hereinafter.

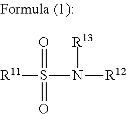

In the formula (1), R¹¹ represents an alkyl or aryl group and R¹² and R¹³ each independently represent a hydrogen atom or an alkyl or aryl group. It is particularly preferred that the total sum of the number of carbon atoms in R¹¹, R¹² and R¹³ be 10 or more. The alkyl and aryl groups may have substituents.

Preferred examples of these substituents include fluorine atoms, alkyl groups, aryl groups, alkoxy groups, sulfone groups, and sulfonamide groups.

The aforementioned alkyl group may be straight-chain, branched or cyclic. The alkyl group preferably has from 1 to 25 carbon atoms, more preferably from 6 to 25 atoms, particularly preferably from 6 to 20 carbon atoms (e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamanthyl, decyl, t-octyl, undecyl, dodecyl, tridecyl, tetradecyl, pentadecyl, hexadecyl, heptadecyl, octadecyl, nonadecyl, didecyl).

The aforementioned aryl group preferably has from 6 to 30 carbon atoms, particularly preferably from 6 to 24 carbon atoms (e.g., phenyl, biphenyl, terphenyl, naphthyl, binaphthyl, triphenylphenyl). Preferred examples of the compounds represented by the formula (1) will be given below, but the invention is not limited thereto.

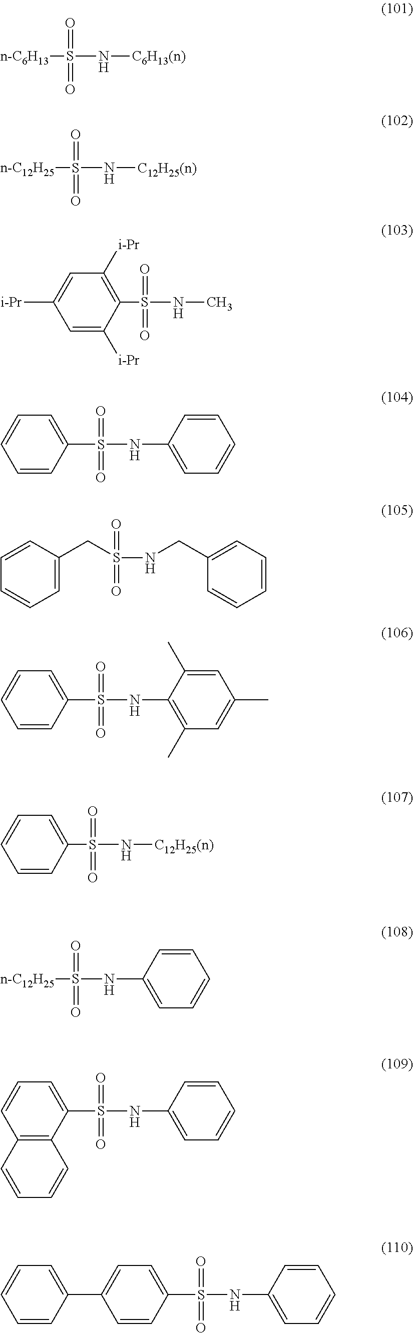

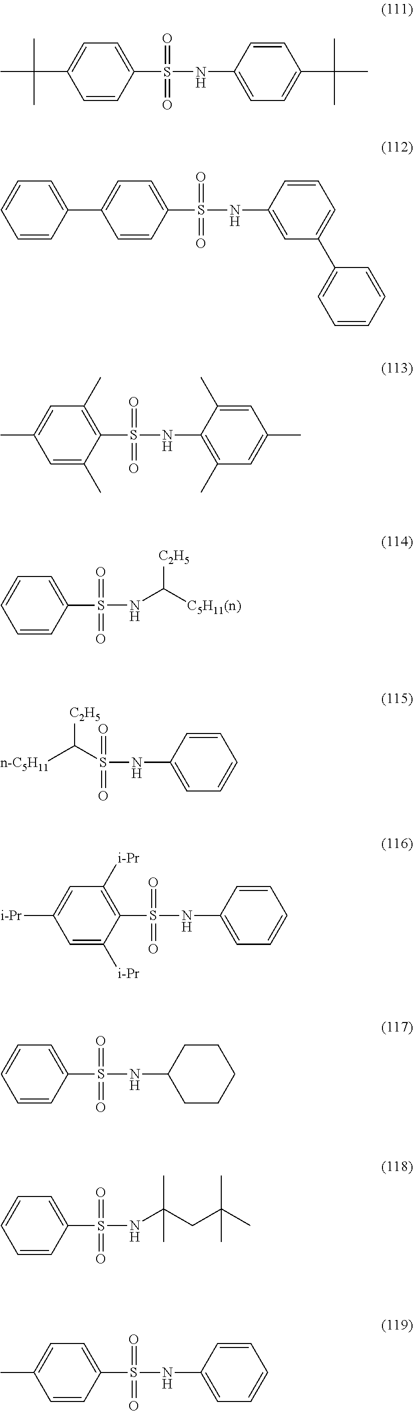

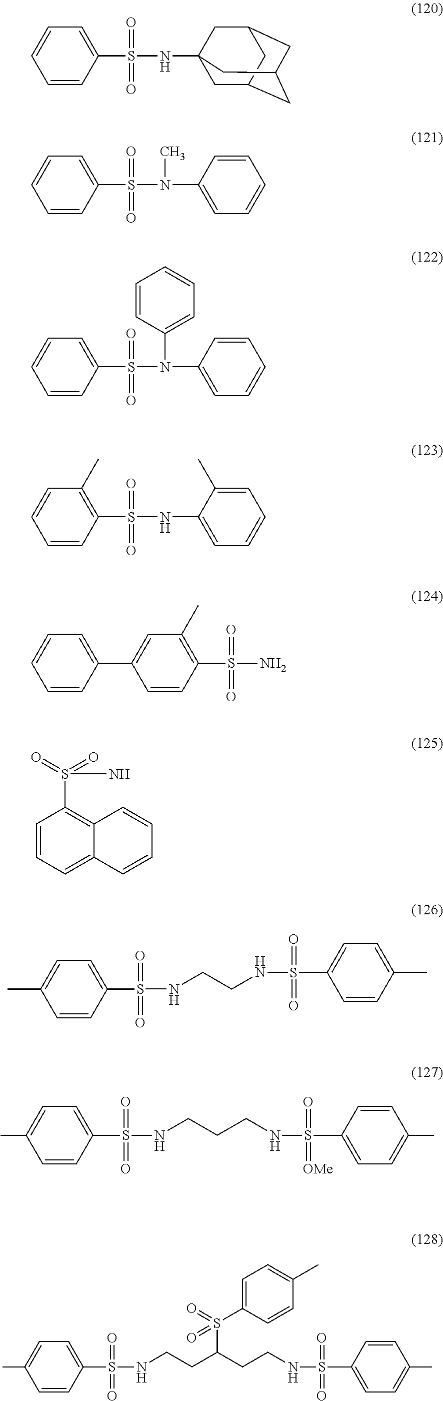

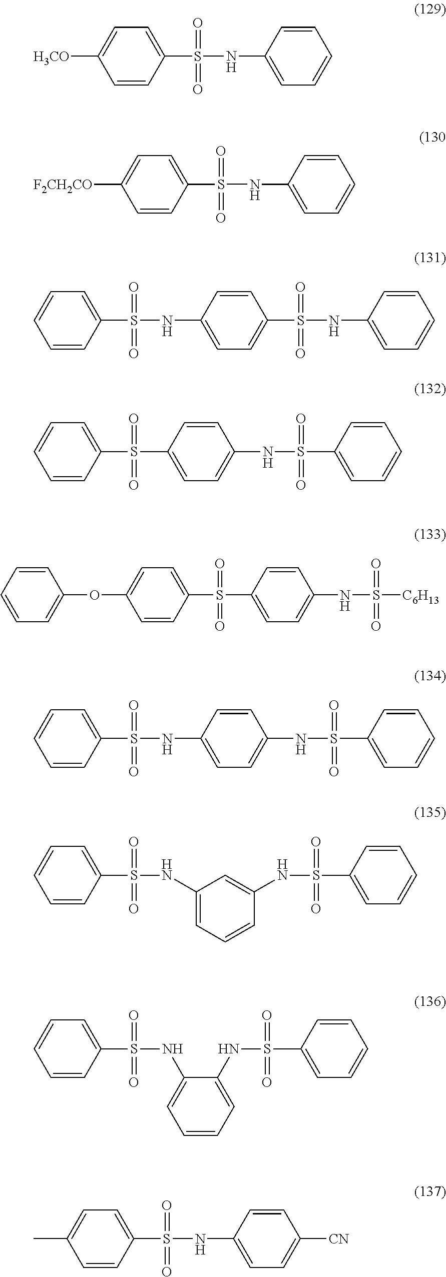

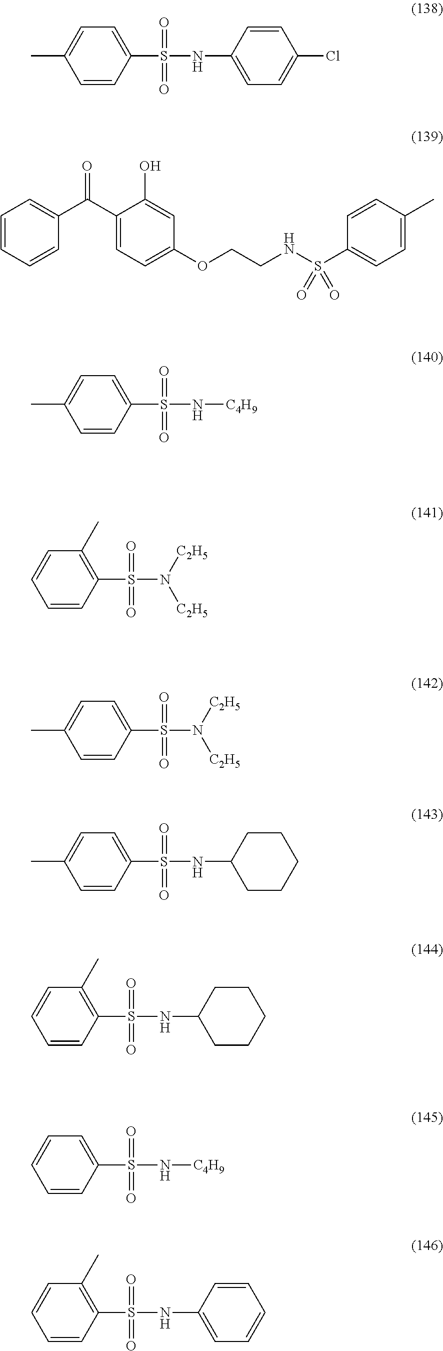

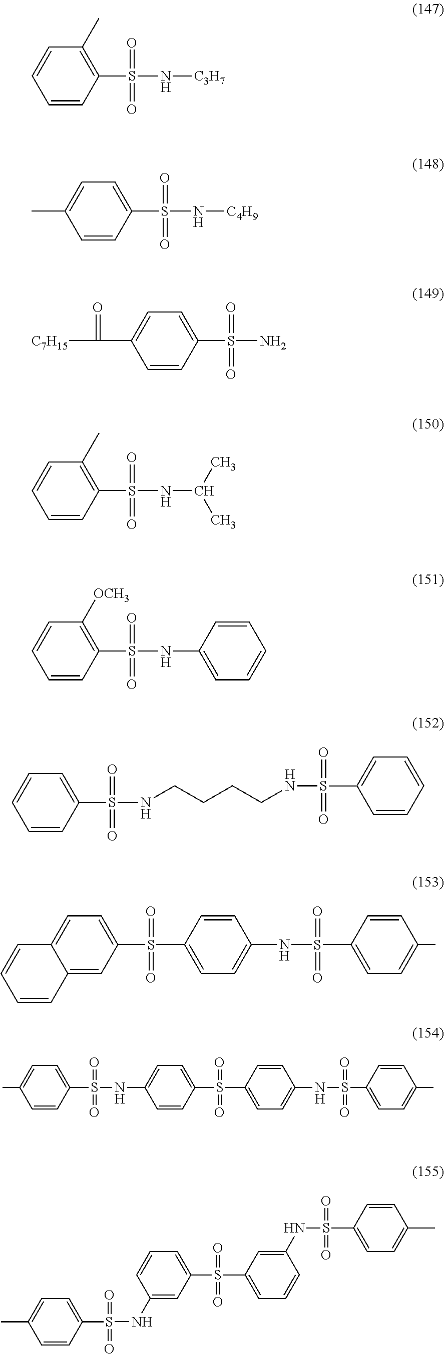

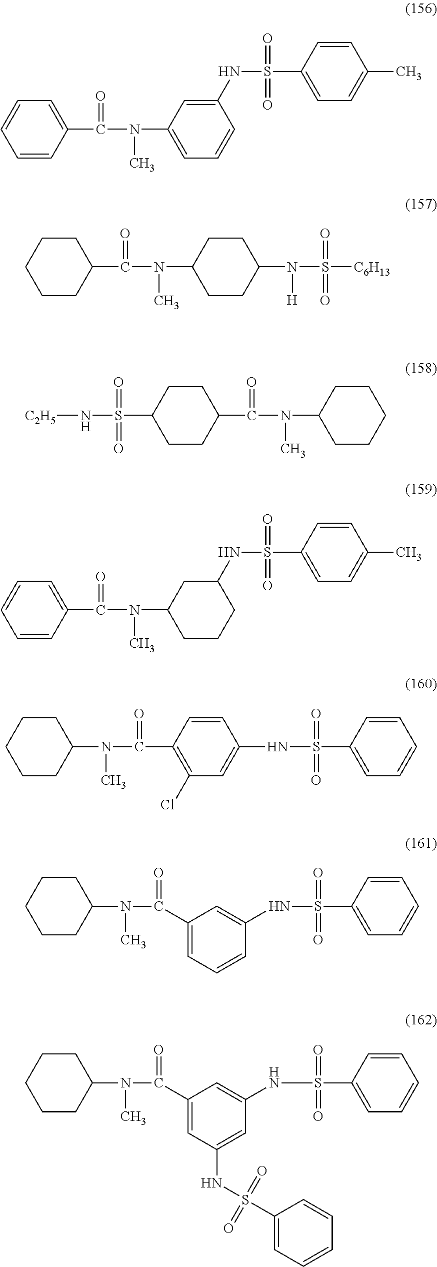

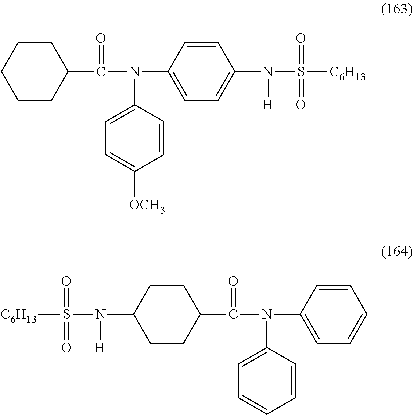

As Rth decreasing agent there may be exemplified a compound represented by the following formula (2).

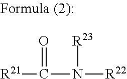

In the formula (2), R²¹ represents an alkyl or aryl group and R²² and R²³ each independently represent a hydrogen atom or an alkyl or aryl group. The aforementioned alkyl group may be straight-chain, branched or cyclic. The alkyl group preferably has from 1 to 20 carbon atoms, more preferably from 1 to 15 atoms, particularly preferably from 1 to 12 carbon atoms. The cyclic alkyl group is particularly preferably a cyclohexyl group. The aryl group preferably has from 6 to 36 carbon atoms, more preferably from 6 to 24 carbon atoms, even more preferably from 6 to 24 carbon atoms. Further, the sum of the number of carbon atoms in R²¹ and R²² is preferably 10 or more. The alkyl group and aryl group each may have substituents.

The aforementioned alkyl group and aryl group may have substituents. Examples of these substituents include halogen atoms (e.g., chlorine, bromine, fluorine, iodine), alkyl groups, aryl groups, alkoxy groups, aryloxy groups, acyl groups, alkoxycarbonyl groups, aryloxycarbonyl groups, acyloxy groups, sulfonylamino groups, hydroxyl groups, cyano groups, amino groups, and acylamino groups. More desirable among these substituents are halogen atoms, alkyl groups, aryl groups, alkoxy groups, aryloxy groups, sulfonylamino groups, and acylamino groups. Particularly preferred among these substituents are alkyl groups, aryl groups, sulfonylamino groups, and acylamino groups.

Preferred examples of the compound represented by the formula (2) will be given below, but the invention is not limited thereto.

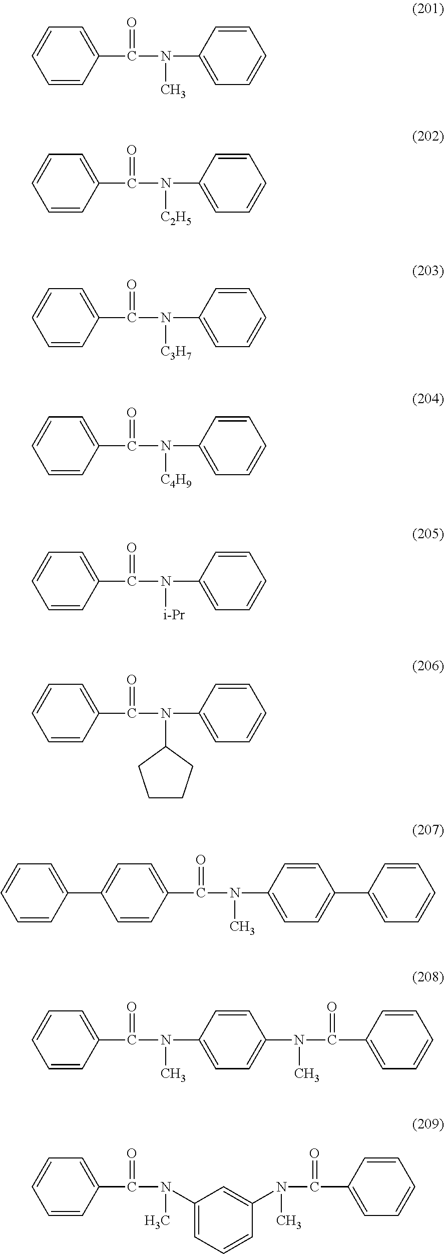

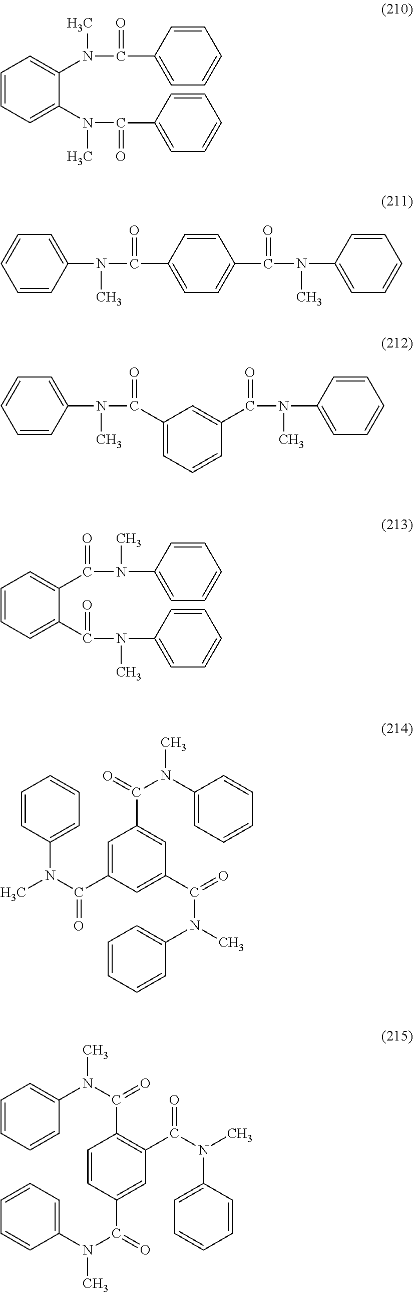

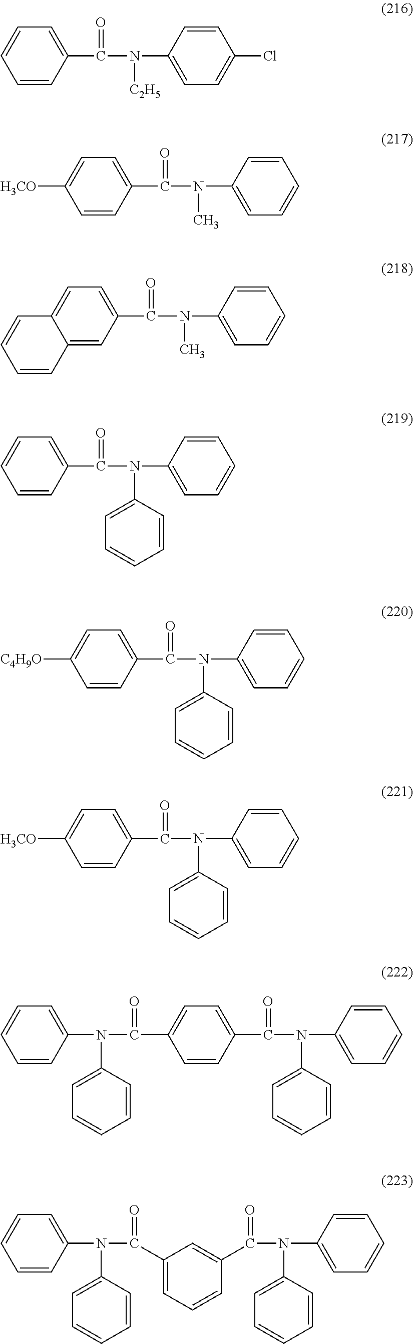

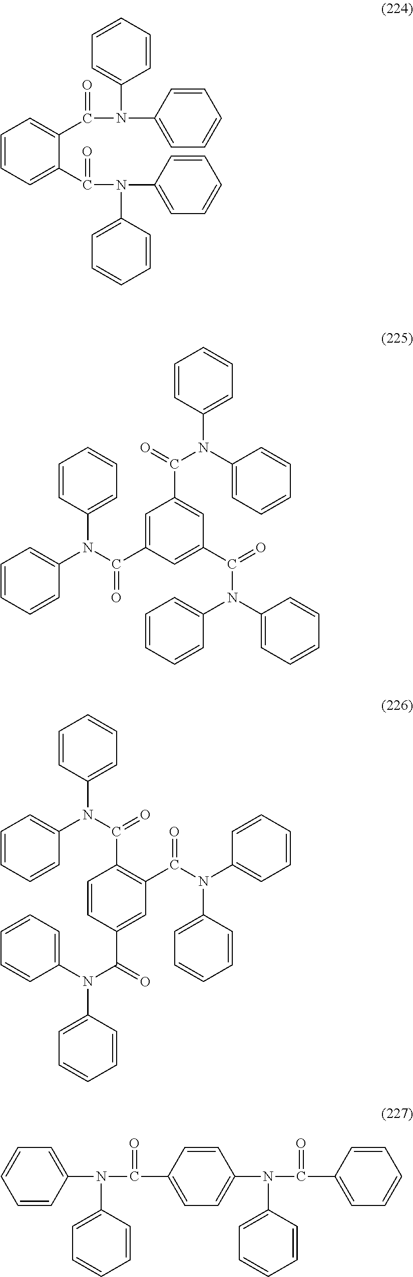

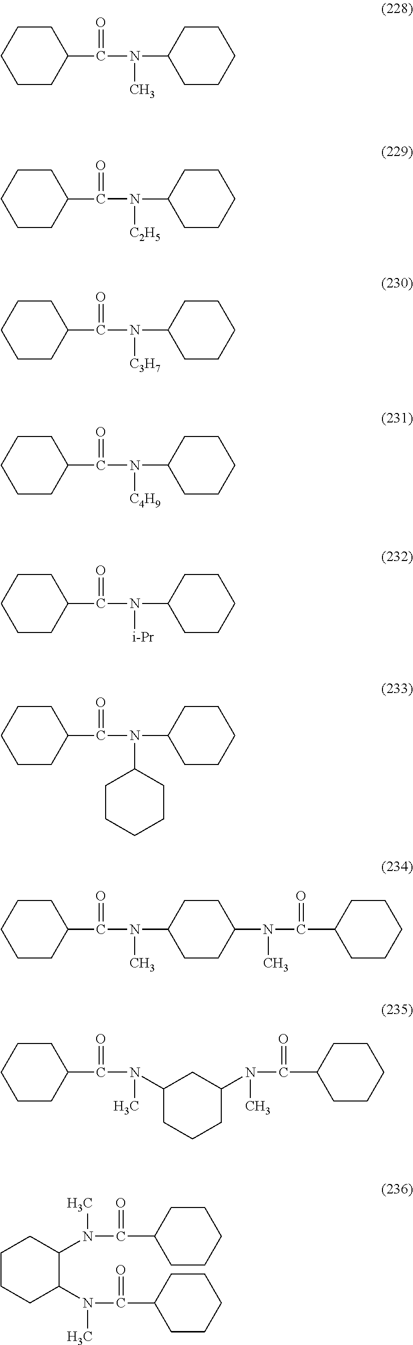

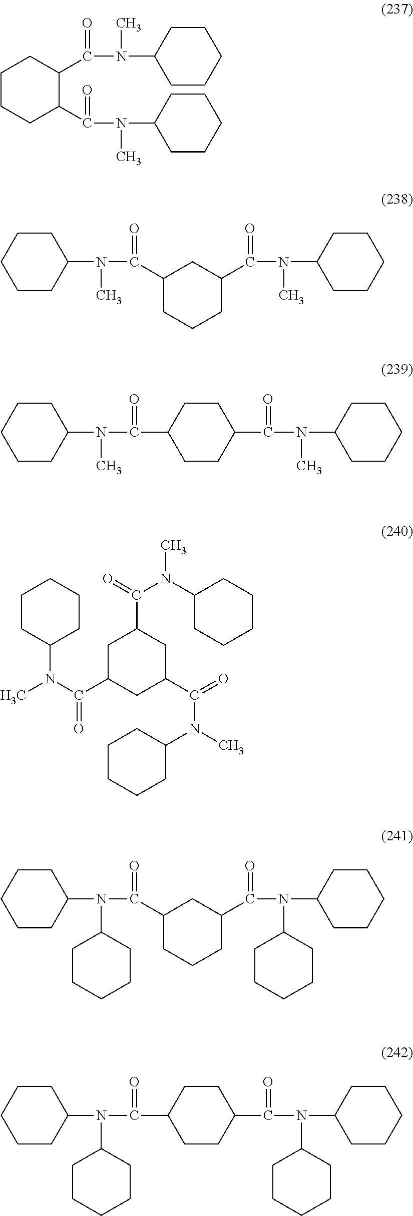

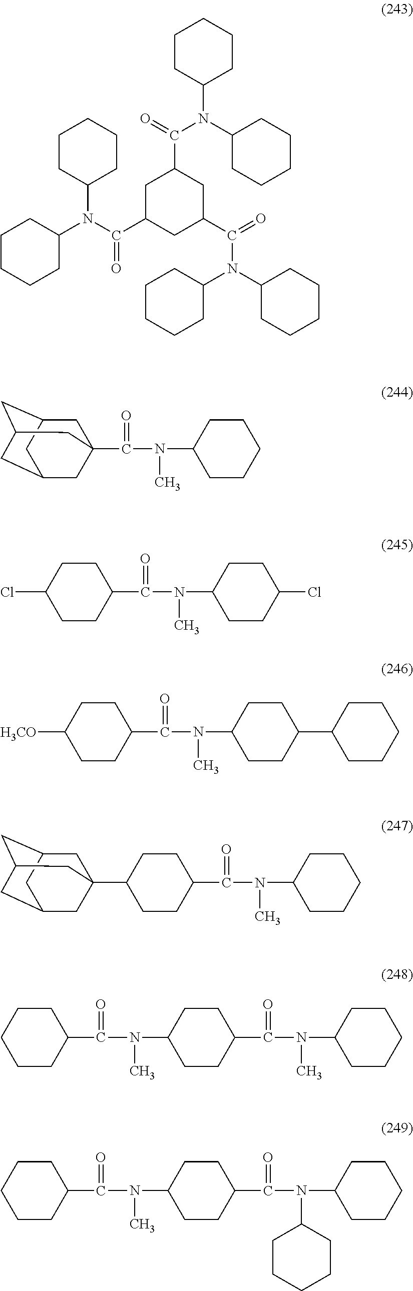

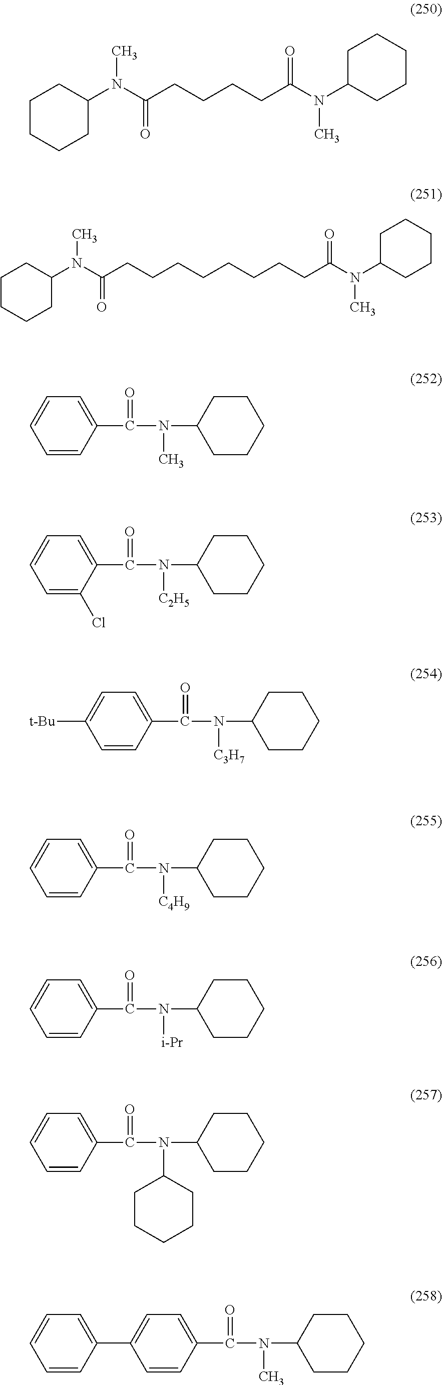

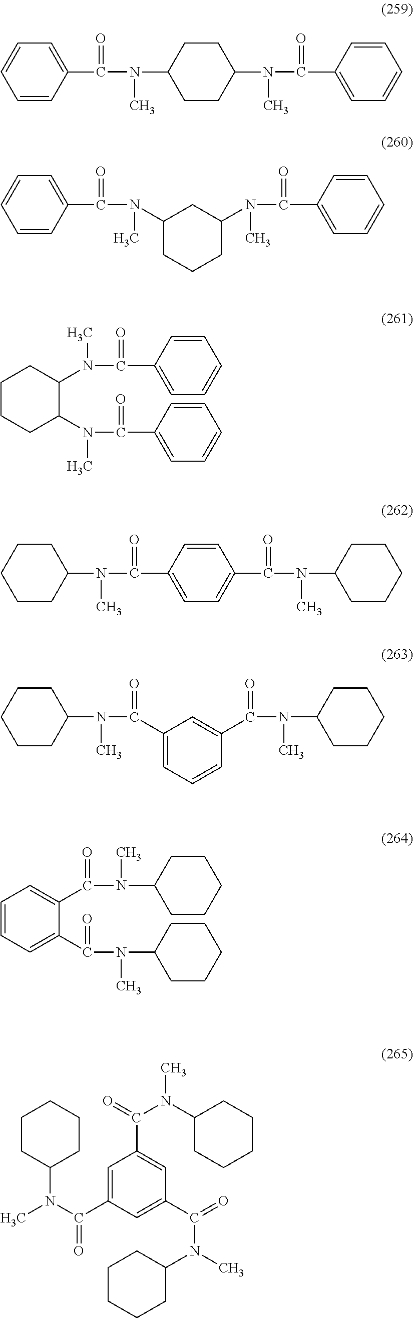

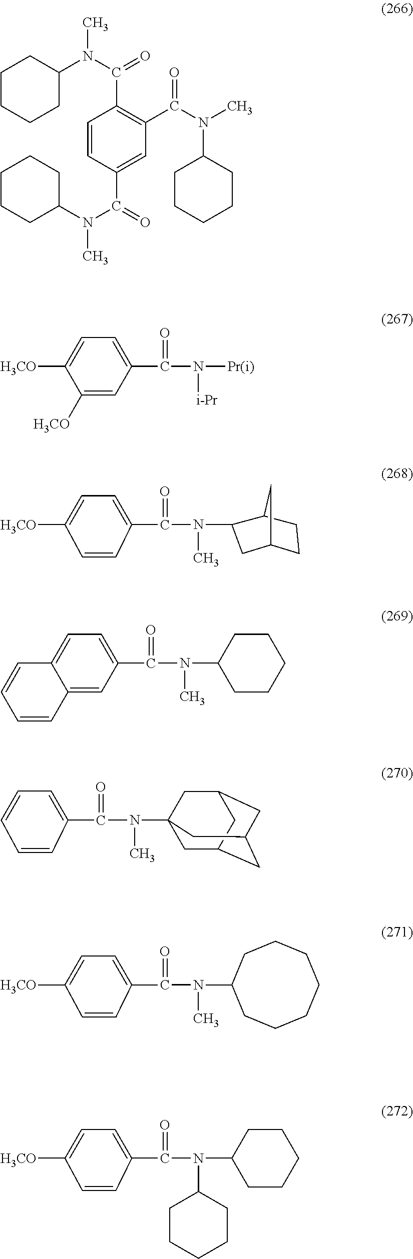

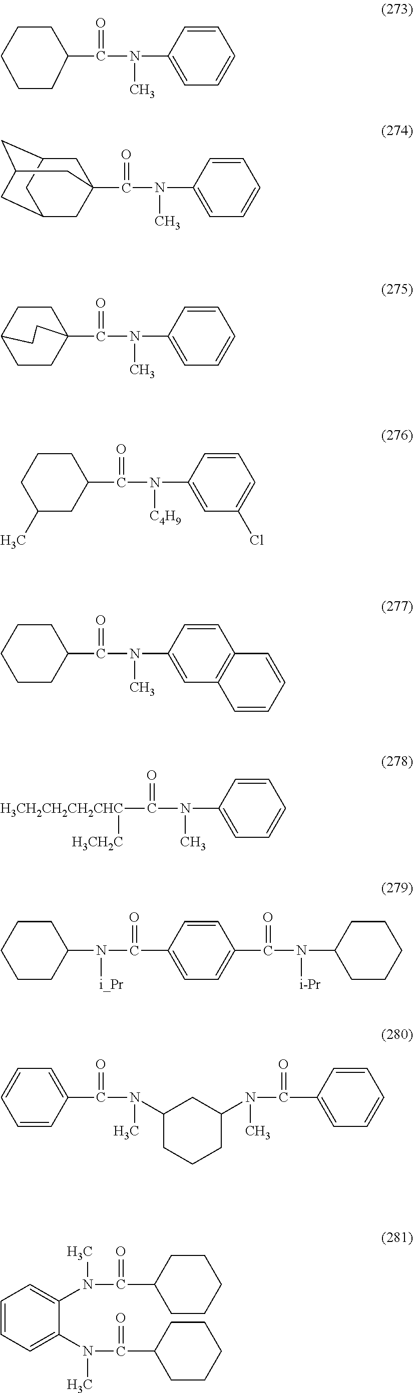

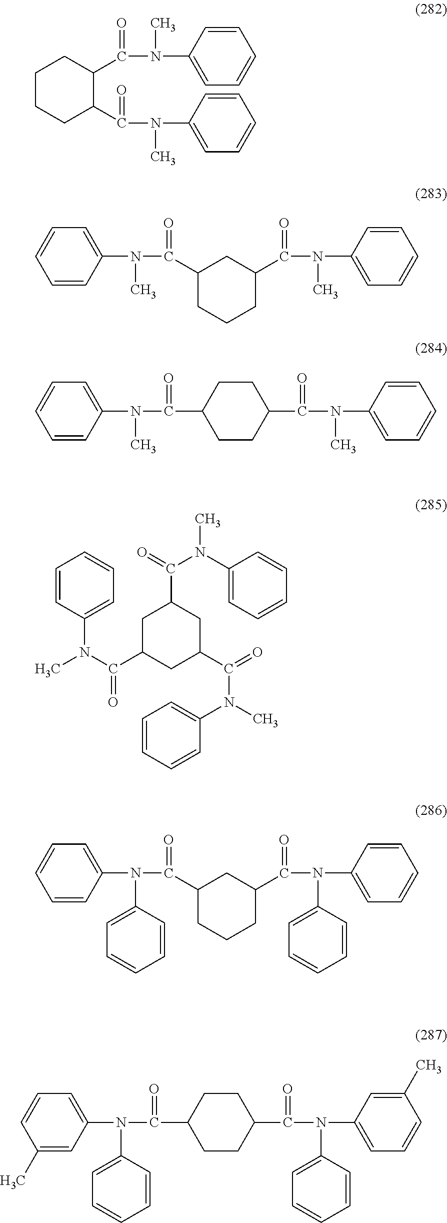

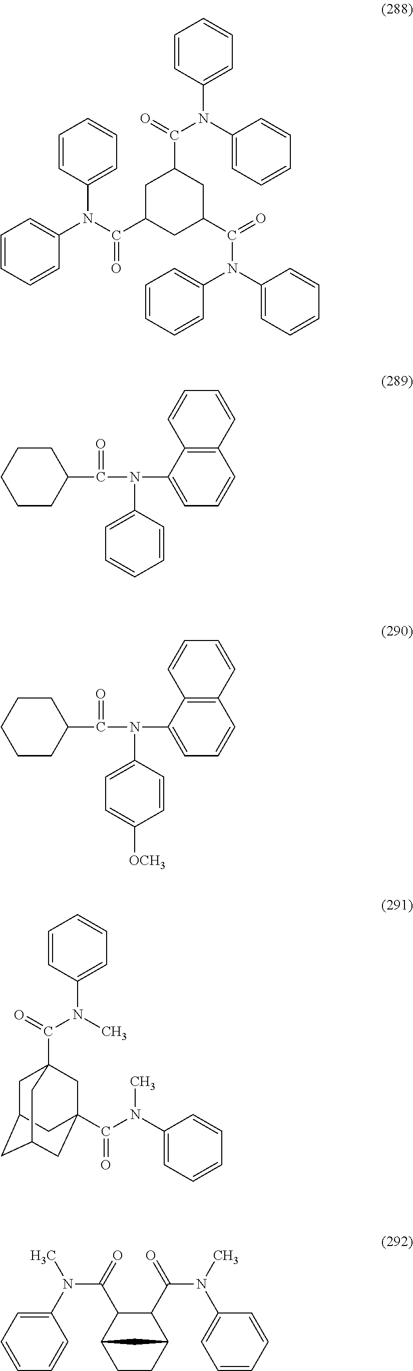

### <Wavelength Dispersion Adjustor>

The cellulose acylate film of the invention preferably contains at least a compound for decreasing |Re₍₄₀₀₎−Re₍₇₀₀₎| and |Rth₍₄₀₀₎−Rth₍₇₀₀₎| of the film, i.e., compound for decreasing the wavelength dispersion of retardation (hereinafter occasionally referred to as “wavelength dispersion adjustor”) in an amount of from 0.01 to 30% by mass based on the solid content of the polymer from which cellulose acylate film is prepared. The wavelength dispersion adjustor will be further described hereinafter.

In order to improve the wavelength dispersion of Rth of the cellulose acylate film of the invention, it is preferred that at least one compound for decreasing the wavelength dispersion ΔRth of Rth represented by the following numeral expression (6) be incorporated in the cellulose acylate film in an amount satisfying the following relationships (7) and (8).

ΔRth=|Rth₍₄₀₀₎−Rth₍₇₀₀₎| (6)

(ΔRth_{B}−ΔRth₀)/B≦−2.0 (7)

0.01≦B≦30 (8)

Preferably, the aforementioned relationships (7) and (8) are:

(ΔRth_{B}−ΔRth₀)/B≦−3.0 (7-2)

0.05≦B≦25 (8-2)

More preferably, the aforementioned relationships (7) and (8) are:

(ΔRth_{B}−ΔRth₀)/B≦−4.0 (7-3)

0.1≦B≦20 (8-3)

In the aforementioned numeral expressions, ΔRth_{B} represents ΔRth (nm) of the film containing the wavelength dispersion adjustor in an amount of B % by mass, ΔRth₀ represents ΔRth (nm) of the film free of the wavelength dispersion adjustor, and B represents the mass (%) of the wavelength dispersion adjustor based on the mass of 100 of the polymer from which the film is prepared.

### (Method for Adding Wavelength Dispersion Adjustor)

These wavelength dispersion adjustors may be used singly or in admixture of two or more thereof in an arbitrary proportion. These wavelength dispersion adjustors may be added at any time during the preparation of the dope or may be added at the end of the preparation of the dope.

Specific examples of the wavelength dispersion adjustor which is preferably used in the invention include benzotriazole-based compounds, benzophenone-based compounds, compounds containing cyano group, oxybenzophenone-based compounds, salicylic acid ester-based compounds, and nickel complex salt-based compounds. However, the invention is not limited to these compounds.

As the benzotriazole-based compound to be used as wavelength dispersion adjustor of the invention there is preferably used one represented by the formula (3).

Formula (3):

Q³¹-Q³²-OH (3)

wherein Q³¹ represents a nitrogen-containing aromatic heterocyclic group; and Q³² represents an aromatic ring.

Q³¹ represents a nitrogen-containing aromatic heterocyclic group, preferably a 5- to 7-membered nitrogen-containing aromatic heterocyclic ring, more preferably a 5- or 6-membered nitrogen-containing aromatic heterocyclic ring. Examples of these nitrogen-containing aromatic heterocyclic rings include imidazole, pyrazole, triazole, tetrazole, thiazole, oxazole, selenazole, penzotriazole, benzothiazole, benzoxazole, benzoselenazole, thiadiazole, oxadiazole, naphthothiazole, naphthooxazole, azabenzimidazole, purine, pyridine, pyrazine, pyridazine, triazine, triazaindene, and tetrazaindene. Five-membered nitrogen-containing aromatic heterocyclic rings are more preferred and specific examples thereof include imidazole, pyrazole, triazole, tetrazole, thiazole, oxazole, benzotriazole, benzothiazole, benzoxazole, thiadiazole, and oxadiazole. Particularly preferred among these nitrogen-containing aromatic heterocyclic rings is benzotriazole.

The nitrogen-containing aromatic heterocyclic group represented by Q³¹ may further contain substituents. As these substituents there may be used the substituents T exemplified later. A plurality of these substituents, if any, may be condensed to further form rings.

The aromatic ring represented by Q³² may be an aromatic hydrocarbon ring or aromatic heterocyclic ring. These rings may each be monocyclic or may form condensed rings with other rings.

The aromatic hydrocarbon ring is preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, still more preferably benzene ring.

The aromatic heterocyclic ring is preferably an aromatic heterocyclic ring containing nitrogen atom or sulfur atom. Specific examples of the heterocyclic ring include thiophene, imidazole, pyrazole, pyridine, pyrazine, pyridazine, triazine, indole, indazole, purine, thiazoline, thiazole, thiadiazole, oxazoline, oxazole, oxadiazole, quinoline, isoquinoline, phthaladine, naphthylidene, quinoxaline, quinazoline, cinnoline, pteridine, acridine, phenanthroline, phenazine, tetrazole, benzimidazole, benzoxazole, benzthiazole, benzotriazole, and tetrazaindene. More desirable among these aromatic heterocyclic rings are pyridine, triazine, and quinoline.

The aromatic ring represented by Q³² is preferably an aromatic hydrocarbon ring, more preferably a naphthalene ring or benzene ring, particularly preferably a benzene ring. Q³² may further have substituents which are preferably the substituents T exemplified later.

Examples of the substituents T include alkyl groups (preferably a C₁-C₂₀, more preferably a C₁-C₁₂, particularly preferably a C₁-C₈ alkyl group, e.g., methyl, ethyl, i-propyl, t-butyl, n-octyl, n-decyl, n-hexadecyl, cyclopropyl, cyclopentyl, cyclohexyl), alkenyl groups (preferably a C₂-C₂₀, more preferably a C₂-C₁₂, particularly preferably a C₂-C₈ alkenyl group, e.g., vinyl, allyl, 2-butenyl, 3-pentenyl), alkynyl groups (preferably a C₂-C₂₀, more preferably a C₂-C₁₂, particularly preferably a C₂-C₈ alkynyl group, e.g., propargyl, 3-pentynyl), aryl groups (preferably a C₆-C₃₀, more preferably a C₆-C₂₀, particularly preferably a C₆-C₁₂ aryl group, e.g., phenyl, p-methylphenyl, naphthyl), substituted or unsubstituted amino groups (preferably a C₀-C₂₀, more preferably a C₀-C₁₀, particularly preferably a C₀-C₆ amino group, e.g., amino, methylamino, dimethylamino, diethylamino, dibenzylamino), alkoxy groups (preferably a C₁-C₂₀, more preferably a C₁-C₁₂, particularly preferably a C₁-C₈ alkoxy group, e.g., methoxy, ethoxy, butoxy), aryloxy groups (preferably a C₆-C₂₀, more preferably a C₆-C₁₆, particularly preferably a C₆-C₁₂ aryloxy group, e.g., phenyloxy, 2-naphthyloxy), acyl groups (preferably a C₁-C₂₀, more preferably a C₁-C₁₆ acyl group, particularly preferably a C₁-C₁₂ acyl group, e.g., acetyl, benzoyl, formyl, pivaloyl), alkoxycarbonyl groups (preferably a C₂-C₂₀, more preferably a C₂-C₁₆, particularly preferably a C₂-C₁₂ alkoxycarbonyl group, e.g., methoxycarbonyl, ethoxycarbonyl), aryloxycarbonyl groups (preferably a C₇-C₂₀, more preferably a C₇-C₁₆, particularly preferably a C₇-C₁₀ aryloxycarbonyl group, e.g., phenyloxycarbonyl), acyloxy groups (preferably a C₂-C₂₀, more preferably a C₂-C₁₆, particularly preferably a C₂-C₁₀ acyloxy group, e.g., acetoxy, benzoyloxy), acylamino groups (preferably a C₂-C₂₀, more preferably a C₂-C₁₆, particularly preferably a C₂-C₁₀ acylamino group, e.g., acetylamino, benzoylamino), alkoxycarbonylamino groups (preferably a C₂-C₂₀, more preferably a C₂-C₁₆, particularly preferably a C₂-C₁₂ alkoxycarbonylamino group, e.g., methoxycarbonylamino), aryloxycarbonyl amino groups (preferably a C₇-C₂₀, more preferably a C₇-C₁₆, particularly preferably a C₇-C₁₂ aryloxycarbonylamino group, e.g., phenyloxycarbonylamino), sulfonylamino groups (preferably a C₁-C₂₀, more preferably a C₁-C₁₆, particularly preferably a C₁-C₁₂ sulfonylamino group, e.g., methanesulfonylamino, benzenesulfonylamino), sulfamoyl groups (preferably a C₀-C₂₀, more preferably a C₀-C₁₆, particularly preferably a C₀-C₁₂ sulfamoyl group, e.g., sulfamoyl, methylsulfamoyl, dimethylsulfamoyl, phenylsulfamoyl), carbamoyl groups (preferably a C₁-C₂₀, more preferably a C₁-C₁₆, particularly preferably a C₁-C₁₂ carbamoyl group, e.g., carbamoyl, methyl carbamoyl, diethyl carbamoyl, phenyl carbamoyl), alkylthio groups (preferably a C₁-C₂₀, more preferably a C₁-C₁₆, particularly preferably a C₁-C₁₂ alkylthio group, e.g., methylthio, ethylthio), arylthio groups (preferably a C₆-C₂₀, more preferably a C₆-C₁₆, particularly preferably a C₆-C₁₂ arylthio group, e.g., phenylthio), sulfonyl groups (preferably a C₁-C₂₀, more preferably a C₁-C₁₆, particularly preferably a C₁-C₁₂ sulfonyl group, e.g., mesyl, tosyl), sulfinyl groups (preferably a C₁-C₂₀, more preferably a C₁-C₁₆, particularly preferably a C₁-C₁₂ sulfinyl group, e.g., methanesulfinyl, benzenesulfinyl), ureido groups (preferably a C₁-C₂₀, more preferably a C₁-C₁₆, particularly preferably a C₁-C₁₂ ureido group, e.g., ureido, methylureido, phenylureido), phosphoric amide groups (preferably a C₁-C₂₀, more preferably a C₁-C₁₆, particularly preferably a C₁-C₁₂ phosphoric amide group, e.g., amide diethylphosphate, amide phenylphosphate), hydroxyl groups, mercapto groups, halogen atoms (e.g., fluorine, chlorine, bromine, iodine), cyano groups, sulfo groups, carboxyl groups, nitro groups, hydroxamic acid groups, sulfino groups, hydrazino groups, imino groups, heterocyclic groups (preferably a C₁-C₃₀, more preferably a C₁-C₁₂ heterocyclic group having nitrogen atom, oxygen atom or sulfur atom as hetero atom, e.g., imidazolyl, pyridyl, quinolyl, furyl, piperidyl, morpholino, benzooxazolyl, benzimidazolyl, benzthiazolyl), and silyl groups (preferably a C₃-C₄₀, more preferably a C₃-C₃₀, particularly preferably a C₃-C₂₄ silyl group, e.g., trimethylsilyl, triphenylsilyl). These substituents may be further substituted. Two or more of these substituents, if any, may be the same or different. If possible, these substituents may be connected to each other to form a ring.

The compound of the formula (3) is preferably a compound represented by the following formula (3-1).

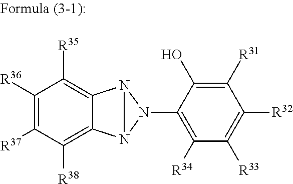

wherein R³¹, R³², R³³, R³⁴, R³⁵, R³⁶, R³⁷ and R³⁸ each independently represent a hydrogen atom or substituent. As such substituents there may be used the aforementioned substituents T. These substituents may be further substituted by other substituents or may be condensed with each other to form a cyclic structure.

R³¹ and R³³ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a C₁-C₁₂ alkyl group (preferably a C₄-C₁₂ alkyl group).

R³² and R³⁴ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R³⁵ and R³⁸ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R³⁶ and R³⁷ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or halogen atom, particularly preferably a hydrogen atom or chlorine atom.

The compound of the formula (3) is preferably a compound represented by the following formula (3-2).

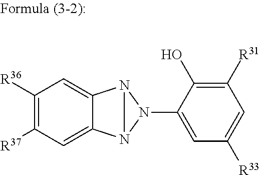

wherein R³¹, R³³, R³⁶ and R³⁷ are as defined in the formula (3-1), including their preferred range.

Specific examples of the compound represented by the formula (3) will be given below, but the invention is not limited thereto.

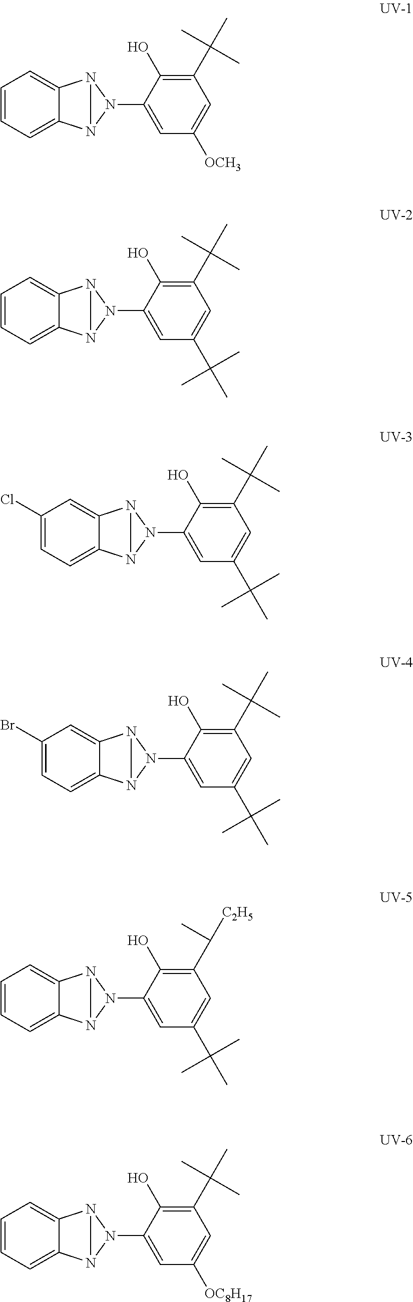

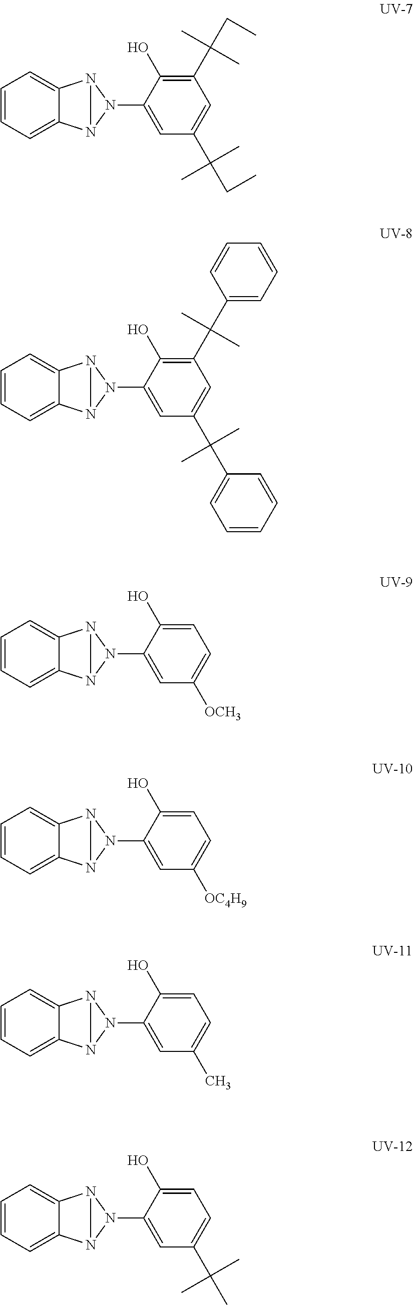

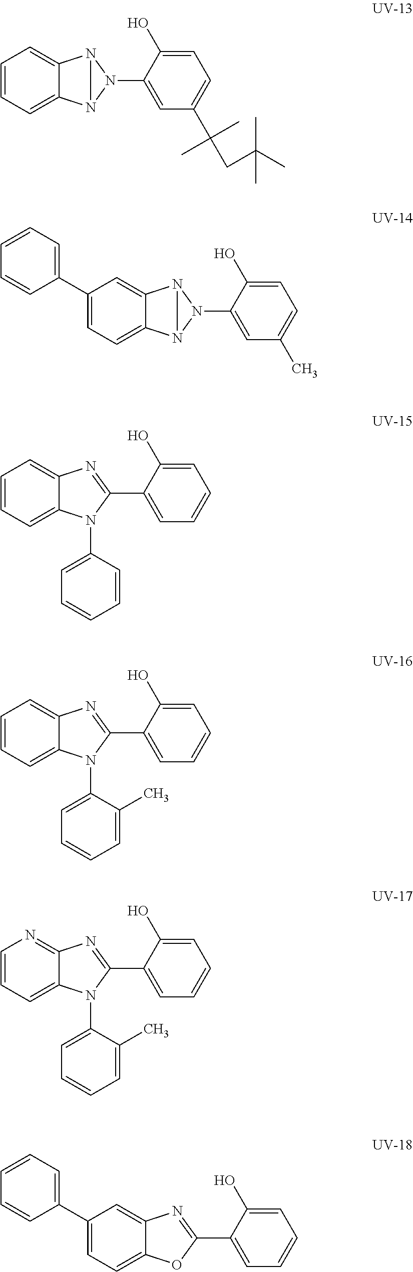

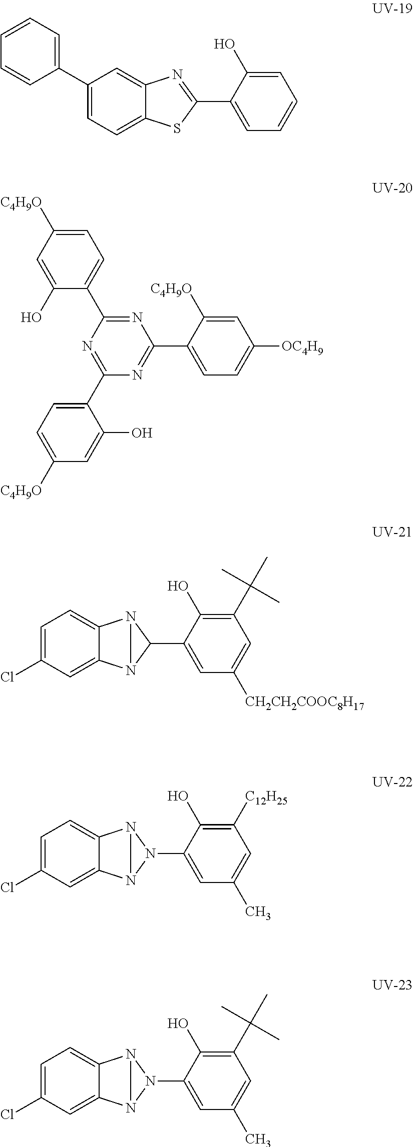

It was confirmed that a cellulose acylate film of the invention prepared free of those having a molecular weight of 320 or less among the above exemplified benzotriazole-based compounds is advantageous in retention.

As the benzophenone-based compound which is one of the wavelength dispersion adjustors to be used in the invention there is preferably used one represented by the formula (4).

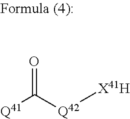

wherein Q⁴¹ and Q⁴² each independently represent an aromatic ring; and X⁴¹ represents NR⁴¹ (in which R⁴¹ represents a hydrogen atom or substituent), oxygen atom or sulfur atom.

The aromatic rings represented by Q⁴¹ and Q⁴² each may be an aromatic hydrocarbon ring or aromatic heterocyclic ring. These rings may be each monocyclic or may form condensed rings with other rings.

The aromatic hydrocarbon rings represented by Q⁴¹ and Q⁴² each are preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, still more preferably a benzene ring.

The aromatic heterocyclic groups represented by Q⁴¹ and Q⁴² each are preferably an aromatic heterocyclic group containing at least one of oxygen atom, nitrogen atom and sulfur atom. Specific examples of the heterocyclic group include furane, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine, triazine, and quinoline.

The aromatic groups represented by Q⁴¹ and Q⁴² each are preferably an aromatic hydrocarbon ring, more preferably a C₆-C₁₀ aromatic hydrocarbon ring, even more preferably a substituted or unsubstituted benzene ring.

Q⁴¹ and Q⁴² may further have substituents which are preferably the substituents T exemplified later, with the proviso that these substituents are free of carboxylic acid, sulfonic acid and quaternary ammonium salt. If possible, these substituents may be connected to each other to form a cyclic structure.

X⁴¹ represents NR⁴² (in which R⁴² represents a hydrogen atom or substituent which may be one of the substituents T exemplified later), oxygen atom or sulfur atom, X⁴¹ is preferably NR⁴² (R⁴² is preferably an acyl group or sulfonyl group. These substituents may be further substituted) or oxygen atom, particularly preferably oxygen atom.

The compound of the formula (4) is preferably a compound represented by the following formula (4-1).

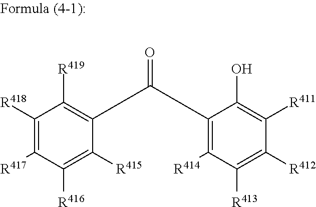

wherein R⁴¹¹, R⁴¹², R⁴¹³, R⁴¹⁴, R⁴¹⁵, R⁴¹⁶, R⁴¹⁷, R⁴¹⁸ and R⁴¹⁹ each independently represent a hydrogen atom or substituent which may be one of the aforementioned substituents T. These substituents may be further substituted by other substituents. These substituents may be condensed with each other to form a cyclic structure.

R⁴¹¹, R⁴¹³, R⁴¹⁴, R⁴¹⁵, R⁴¹⁶, R⁴¹⁸ and R⁴¹⁹ each are preferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or C₁-C₁₂ alkyl group, particularly preferably a hydrogen atom or methyl group, most preferably a hydrogen atom.

R⁴¹² is preferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₂₀ alkyl group, C₀-C₂₀ amino group, C₁-C₂₀ alkoxy group, C₆-C₁₂ aryloxy group or hydroxyl group, even more preferably a C₁-C₂₀ alkoxy group, particularly preferably a C₁-C₁₂ alkoxy group.

R⁴¹⁷ ispreferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₁₂ alkyl group, C₀-C₂₀ amino group, C₁-C₁₂ alkoxy group, C₆-C₁₂ aryloxy group or hydroxyl group, even more preferably a hydrogen atom or C₁-C₂₀ alkyl group (preferably a C₁-C₁₂ alkyl group, more preferably a C₁-C₈ alkyl group, even more preferably methyl), particularly preferably a methyl group or hydrogen atom.

The compound of the formula (4) is preferably a compound represented by the following formula (4-2).

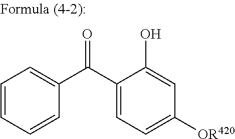

wherein R⁴²⁰ represents a hydrogen atom or a substituted or unsubstituted alkyl, alkenyl, alkynyl or aryl group. R⁴²⁰ represents a hydrogen atom or a substituted or unsubstituted alkyl, alkenyl, alkynyl or aryl group. As the substituents on these groups there may be used the substituents T exemplified above. R⁴²⁰ is preferably a substituted or unsubstituted alkyl group, more preferably a C₅-C₂₀ substituted or unsubstituted alkyl group, even more preferably a C₅-C₁₂ substituted or unsubstituted alkyl group (e.g., n-hexyl group, 2-ethynylhexyl group, n-octyl group, n-decyl group, n-dodecyl group, benzyl group), particularly preferably a C₆-C₁₂ substituted or unsubstituted alkyl group (e.g., 2-ethylhexyl group, n-octyl group, n-decyl group, n-dodecyl group, benzyl group).

The compound represented by the formula (4) can be synthesized by a known method disclosed in JP-A-11-12219.

Specific examples of the compound represented by the formula (4) will be given below, but the invention is not limited thereto.

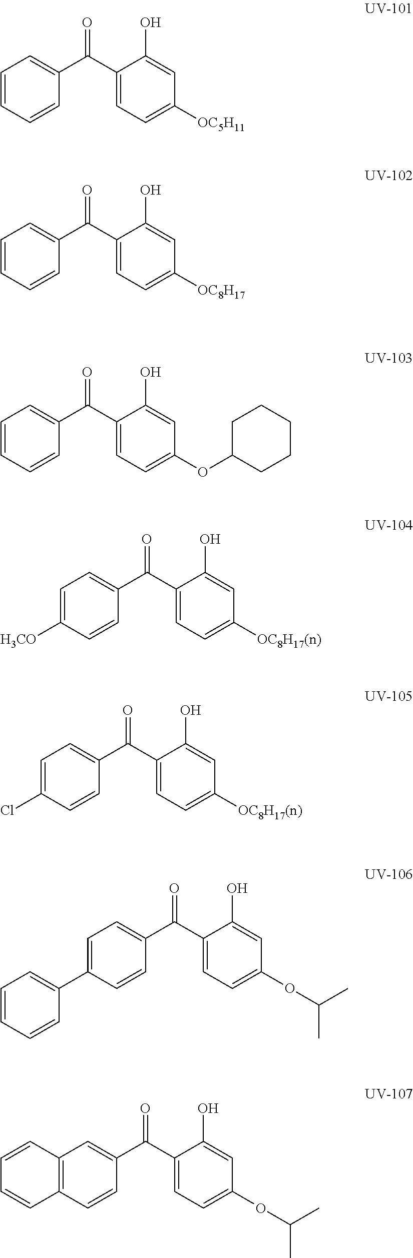

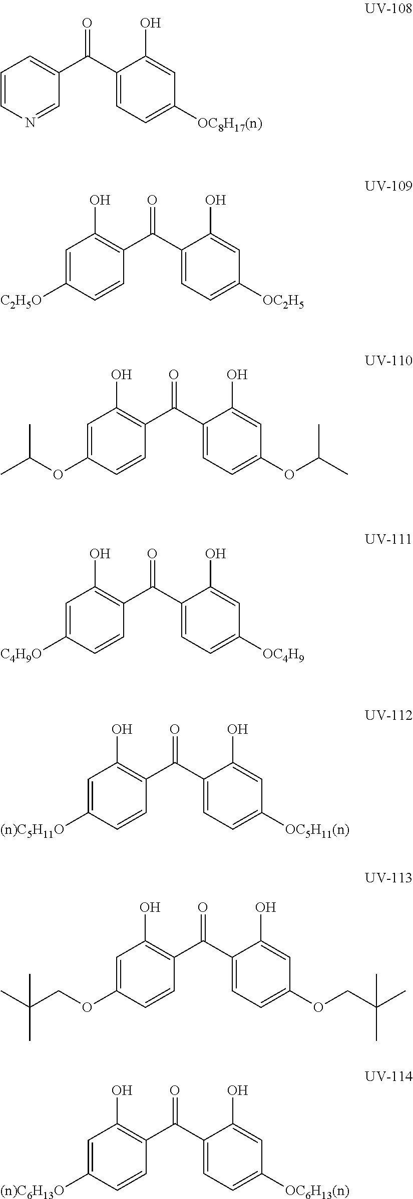

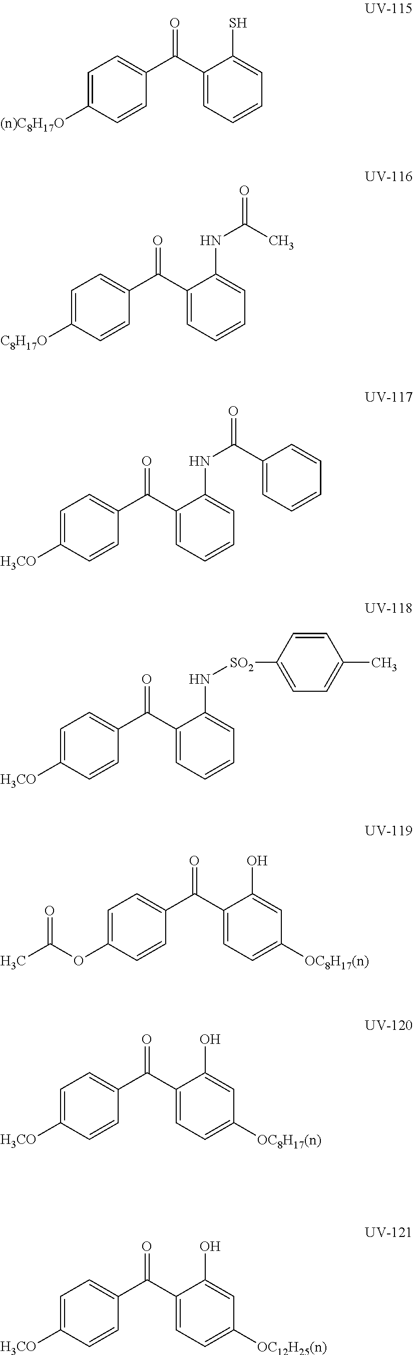

As the compound containing a cyano group which is one of the wavelength dispersion adjustors to be used in the invention there is preferably used one represented by the formula (5).

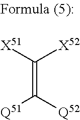

wherein Q⁵¹ and Q⁵² each independently represent an aromatic ring; and X⁵¹ and X⁵² each represent a hydrogen atom or substituent, with the proviso that at least one of X⁵¹ and X⁵² represents a cyano group, carbonyl group, sulfonyl group or aromatic heterocyclic group. The aromatic rings represented by Q⁵¹ and Q⁵² each may be an aromatic hydrocarbon ring or aromatic heterocyclic group. These rings may be monocyclic or may form condensed rings with other rings.

The aromatic hydrocarbon ring is preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, even more preferably a benzene ring.

The aromatic heterocyclic ring is preferably an aromatic heterocyclic group containing nitrogen atom or sulfur atom. Specific examples of the heterocyclic group include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine, triazine, and quinoline.

The aromatic rings represented by Q⁵¹ and Q⁵² each are preferably an aromatic hydrocarbon ring, more preferably a benzene ring. Q⁵¹ and Q⁵² each may further have substituents which are preferably the substituents T.

X⁵¹ and X⁵² each represent a hydrogen atom or substituent. At least one of X⁵¹ and X⁵² represents a cyano group, carbonyl group, sulfonyl group or aromatic heterocyclic group. As the substituents represented by X⁵¹ and X⁵² there may be used the aforementioned substituents T. The substituents represented by X⁵¹ and X⁵² may be further substituted by other substituents. X⁵¹ groups and X⁵² groups may be each condensed with each other to form a cyclic structure.

X⁵¹ and X⁵² is preferably a hydrogen atom, alkyl group, aryl group, cyano group, nitro group, carbonyl group, sulfonyl group or aromatic heterocyclic group, more preferably a cyano group, carbonyl group, sulfonyl group or aromatic heterocyclic group, even more preferably a cyano group or carbonyl group, particularly preferably a cyano group or alkoxycarbonyl group (—C(═O)OR⁵¹ (in which R⁵¹ represents a C₁-C₂₀ alkyl group, C₆-C₁₂ aryl group or combination thereof).

The compound of the formula (5) is preferably a compound represented by the following formula (5-1).

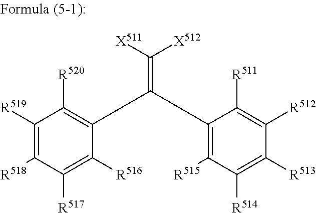

wherein R⁵¹¹, R⁵¹², R⁵¹³, R⁵¹⁴, R⁵¹⁵, R⁵¹⁶, R⁵¹⁷, R⁵¹⁸, R⁵¹⁹ and R⁵²⁰ each independently represent a hydrogen atom or substituent. As such substituents there may be used the aforementioned substituents T. These substituents may be further substituted by other substituents or may be condensed with each other to form a cyclic structure. X⁵¹¹ and X⁵¹² have the same meaning as X⁵¹ and X⁵² in the formula (5).

R⁵¹¹, R⁵¹², R⁵¹⁴, R⁵¹⁵, R⁵¹⁶, R⁵¹⁷, R⁵¹⁹ and R⁵²⁰ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R⁵¹³ and R⁵¹⁸ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₂₀ alkyl group, C₀-C₂₀ amino group, C₁-C₁₂ alkoxy group, C₆-C₁₂ alkyloxy group or hydroxyl, even more preferably a hydrogen atom, C₁-C₁₂ alkyl group or C₁-C₁₂ alkoxy group, particularly preferably a hydrogen atom.

The compound of the formula (5) is preferably a compound represented by the following formula (5-2).

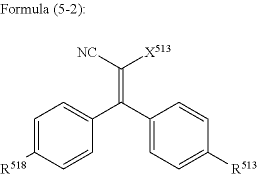

wherein R⁵¹³ and R⁵¹⁸ each are as defined in the formula (5-1), including their preferred range; and X⁵¹³ represents a hydrogen atom or substituent which may be one of the aforementioned substituents T. If possible, these substituents may be further substituted by other substituents.

X⁵¹³ represents a hydrogen atom or substituent. As the substituent there may be used one of the substituents T exemplified above. If possible, these substituents may be further substituted by other substituents. X⁵¹³ is preferably a hydrogen atom, alkyl group, aryl group, cyano group, nitro group, carbonyl group, sulfonyl group or aromatic heterocyclic group, more preferably a cyano group, carbonyl group, sulfonyl group or aromatic heterocyclic group, even more preferably a cyano group or carbonyl group, particularly preferably a cyano group or alkoxycarbonyl group (—C(═O)OR⁵² (in which R⁵² represents a C₁-C₂₀ alkyl group, C₆-C₁₂ aryl group or combination thereof).

The compound of the formula (5) is preferably a compound represented by the following formula (5-3).

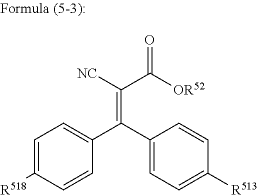

wherein R⁵¹³ and R⁵¹⁸ each are as defined in the formula (5-1), including their preferred range; and R⁵² represents a C₁-C₂₀ alkyl group. When both R⁵¹³ and R⁵¹⁸ are a hydrogen atom, R⁵² is preferably a C₂-C₁₂ alkyl group, more preferably a C₄-C₁₂ alkyl group, even more preferably a C₆-C₁₂ alkyl group, particularly preferably n-octyl group, t-octyl group, 2-ethylhexyl group, n-decyl group or n-dodecyl group, most preferably 2-ethylhexyl group.

When R⁵¹³ and R⁵¹⁸ each are a group other than hydrogen atom, R⁵² is preferably an alkyl group represented by the formula (5-3) having a molecular weight of 300 or more and 20 or less carbon atoms.

In the invention, the compound represented by the formula (5) can be synthesized by the method disclosed in “Journal of American chemical Society”, vol. 63, page 3,452, 1941.

Specific examples of the compound represented by the formula (5) will be given below, but the invention is not limited thereto.

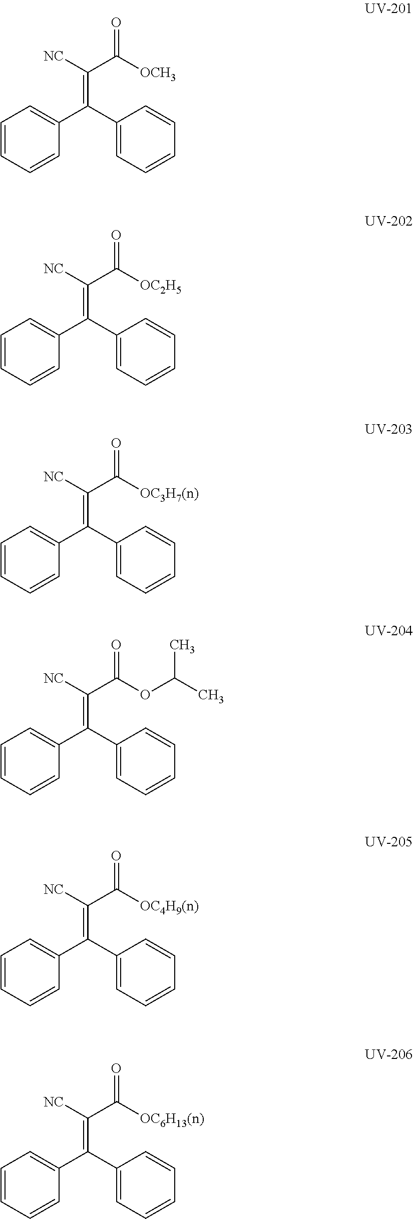

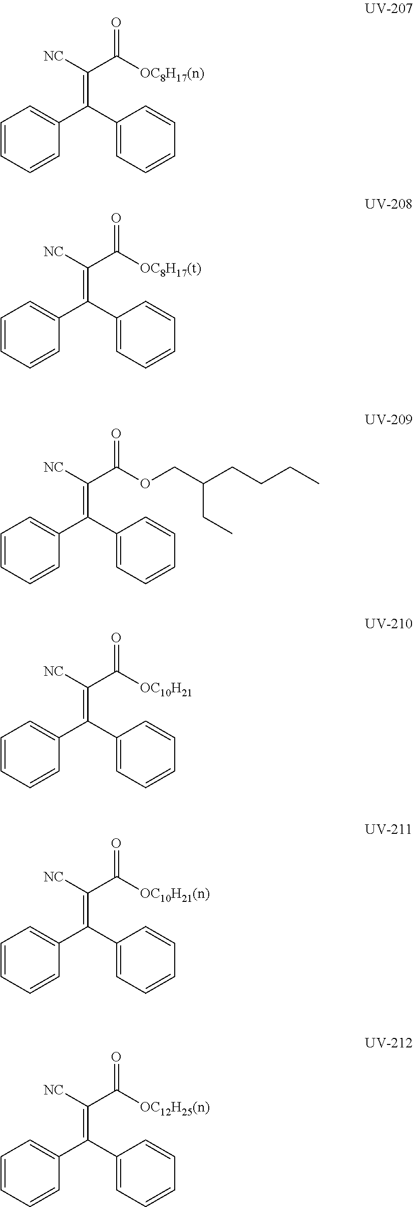

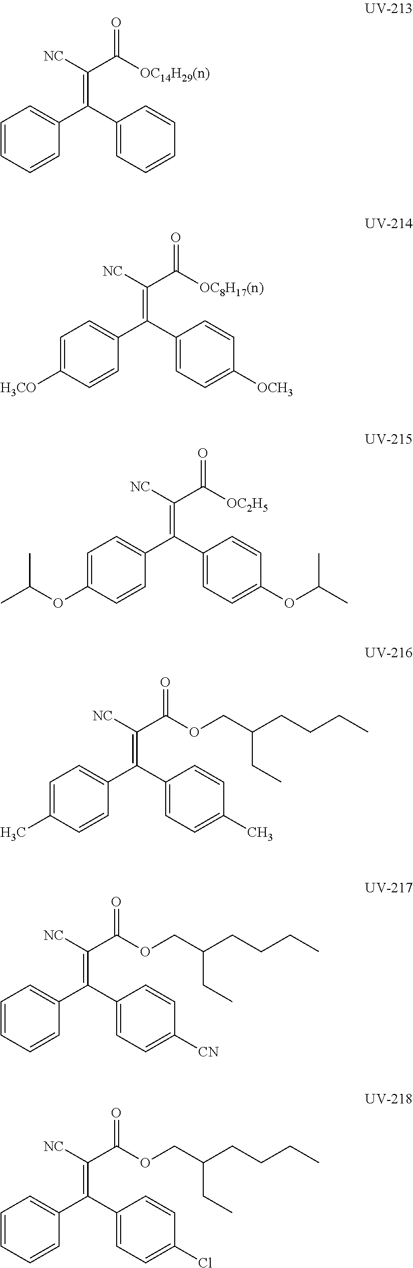

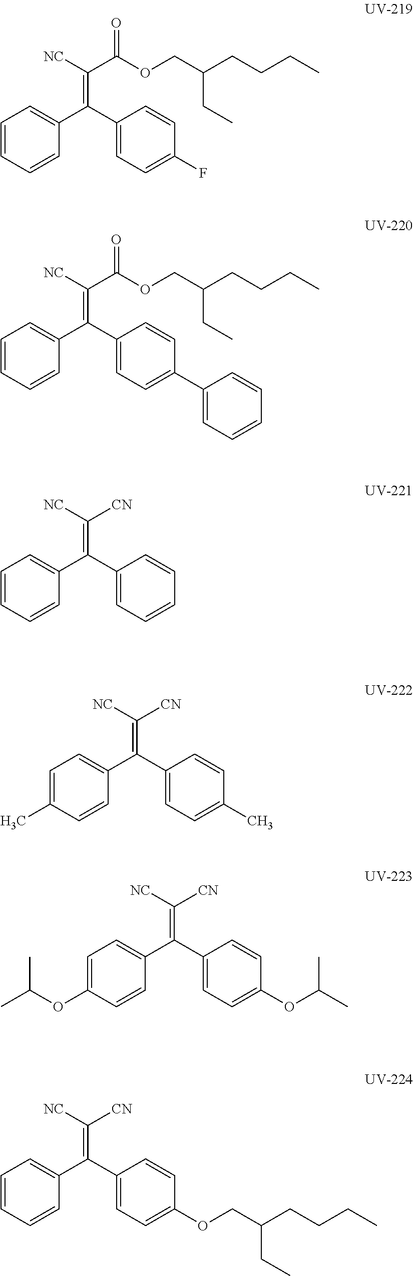

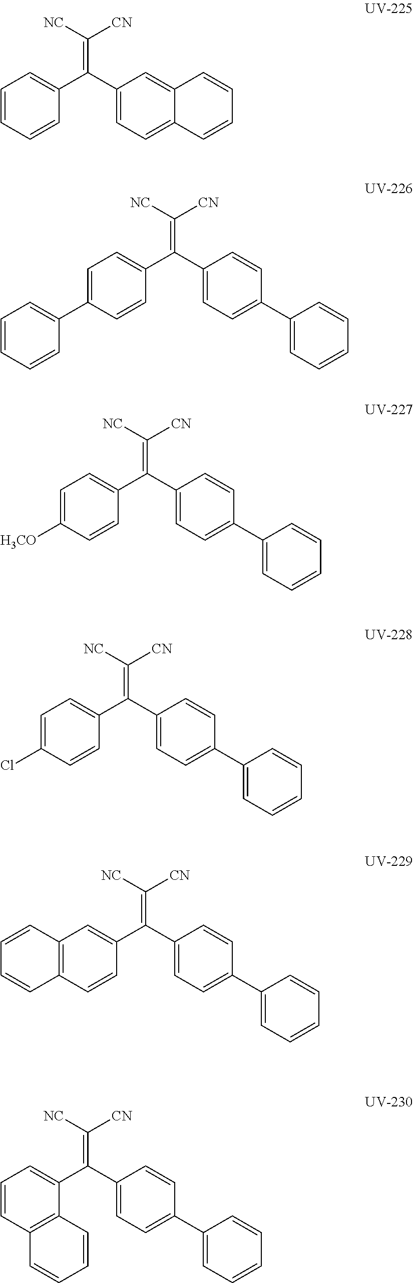

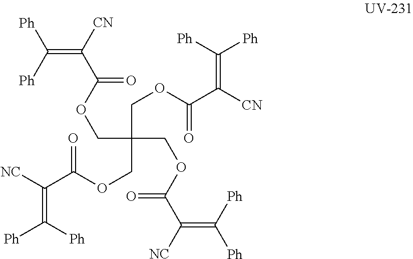

The cellulose acylate film of the invention exhibits a spectral transmission of from not smaller than 45% to not greater than 95% at a wavelength of 380 nm and 10% or less at a wavelength of 350 nm. Referring in detail to method for measuring spectral transmission, a sample having a size of 13 mm×40 mm was measured for transmission at a wavelength of from 300 nm to 450 nm at 25° C. and 60% RH using a Type U-3210 spectrophotometer (produced by Hitachi Limited). The width of tilt was determined by subtracting the wavelength at which the transmission is 5% from the wavelength at which the transmission is 72%. The critical wavelength was represented by the wavelength of (width of tilt/2)+5%. The absorption end was represented by the wavelength at which the transmission is 0.4%. Thus, the transmission at 380 nm and 350 nm were evaluated,

### <Plasticizer>

The cellulose acylate film of the invention may comprise a plasticizer incorporated therein as an additive. Preferred examples of the plasticizer employable herein include phosphoric acid esters, and carboxylic acid esters. The aforementioned plasticizer is preferably selected from the group consisting of triphenyl phosphate (TPP), tricresyl phosphate (TCP), cresyl diphenyl phosphate, octyl diphenyl phosphate, diphenyl biphenyl phosphate, trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethyl hexyl phthalate (DEHP), triethyl O-acetylcitrate (OACTE), tributyl O-acetylcitrate (OACTB), acetyl triacetyl citrate, acetyl tributyl citrate, butyl oleate, methyl acetyl ricinoleate, dibutyl sebacate, triacetin, tributylin, butyl phthalyl glycolate, ethyl phthalyl ethyl glycolate, methyl phthalyl ethyl glycolate, and butyl phthalyl butyl glycolate. The aforementioned plasticizer is preferably a (di)pentaerythritol ester, glycerol ester or diglycerol ester.

### <Deterioration Inhibitor>

The aforementioned deterioration inhibitor can inhibit the deterioration or decomposition of cellulose acylates such as cellulose triacetate. Examples of the deterioration inhibitor include compounds such as butylamine, hindered amine compound (JP-A-8-325537), guanidine compound (JP-A-5-271471), benzotriazole-based UV absorber (FP-A-6-235819) and benzophenone-based UV absorber (JP-A-6-118233).

### <Peel Accelerator and Infrared Absorber>

Examples of the peel accelerator include citric acid ethylesters. For infrared absorbers, reference can be made to JP-A-2001-194522.

### <Method for Adding Additives>

These additives may be added at any time during the preparation of the dope but may be added at an additive step of adding them during the final preparation step of preparing the dope. The added amount of the various materials are not specifically limited so far as their function can be developed. In the case where the cellulose acylate film is formed by multiple layers, the kind and content of the additives to be incorporated in the various layers may be different. As disclosed in JP-A-2001-151902, these techniques have heretofore been known. The glass transition point Tg of the cellulose acylate film as measured by a Type Vibron DVA-225 dynamic viscoelasticity measuring machine (produced by IT Keisoku Seigyo K. K.) and the elastic modulus of the cellulose acylate film as measured by a Type Strograph R2 tensile testing machine (produced by Toyo Seiki Seisaku-Sho, Ltd.) are preferably predetermined to a range of from 70° C. to 150° C. and a range of from 1,500 to 4,000 MPa, respectively, by properly selecting the kind and added amount of these additives. More preferably, the glass transition point Tg and the elastic modulus of the cellulose acylate film are from 80° C. to 135° C. and from 1,500 to 3,000 MPa, respectively. In other words, the glass transition point Tg and the elastic modulus of the cellulose acylate film of the invention are preferably predetermined to fall within the above defined ranges from the standpoint of workability to polarizing plate or adaptability to process of assembly to liquid crystal display device.

For the details of the additives which are preferably used, reference can be made to Kokai Giho 2001-1745, Japan Institute of Invention and Innovation, Mar. 15, 2001, pp. 16 and after.

### <Particulate Matting Agent>

The cellulose acylate film of the invention preferably has a particulate material incorporated therein as a matting agent. Examples of the particulate material to be used in the invention include silicon dioxide, titanium dioxide, aluminum oxide, zirconium oxide, calcium carbonate, talc, clay, baked kaolin, baked calcium silicate, hydrous calcium silicate, aluminum silicate, magnesium silicate, and calcium phosphate. The particulate material preferably contains silicon to reduce turbidity. Silicon dioxide is particularly preferred. The particulate silicon dioxide preferably has a primary average particle diameter of 20 nm or less and an apparent specific gravity of 70 g/l or more. Particulate silicon dioxide having a primary average particle diameter as small as from 5 nm to 16 nm is more desirable to reduce haze. The apparent specific gravity of the particulate silicon dioxide is preferably from 90 to 200 g/l, more preferably from 100 to 200 g/l. The more the apparent specific gravity of the particulate silicon dioxide is, the more likely can be prepared a high concentration dispersion and the better are haze and properties of agglomerated material.

The amount of the aforementioned particulate silicon dioxide to be used is preferably from 0.01 to 0.3 parts by mass based on 100 parts by mass of the polymer component containing cellulose acylate.

These finely divided particles normally form secondary particles having an average particle diameter of from 0.1 μm to 3.0 μm. These finely divided particles are present in the form of agglomerate of primary particles in the film to form an unevenness having a size of from 0.1 μm to 3.0 μm on the surface of the film. The secondary average particle diameter of these finely divided particles is preferably from not smaller than 0.2 μm to not greater than 1.5 μm, more preferably from not smaller than 0.4 μm to not greater than 1.2 most preferably from not smaller than 0.6 μm to not greater than 1.1 μm. When the secondary average particle diameter of these finely divided particles is more than 1.5 μm, the resulting cellulose acylate film exhibits a strong haze. When the secondary average particle diameter of these finely divided particles is less than 0.2 μm, the resulting effect of preventing the occurrence of squeak is reduced.

For the determination of primary and secondary particle diameter, particles in the film are observed under scanning electron microphotograph. The particle diameter is defined by the diameter of the circle circumscribing the particle. 200 particles which are located in dispersed positions are observed. The measurements are averaged to determine the average particle diameter.

As the particulate silicon dioxide there may be used a commercially available product such as Aerosil R972, R972V, R974, R812, 200, 200V, 300, 8202, OX50 and TT600 (produced by Nippon Aerosil Co., Ltd.). The particulate zirconium oxide is commercially available as Aerosil R976 and R811 (produced by Nippon Aerosil Co., Ltd.). These products can be used in the invention.

Particularly preferred among these products are Aerosil 200V and Aerosil R972V because they are a particulate silicon dioxide having a primary average particle diameter of 20 nm or less and an apparent specific gravity of 70 g/l or more that exerts a great effect of reducing friction coefficient while keeping the turbidity of the optical film low.

In the invention, in order to obtain a cellulose acylate film containing particles having a small secondary average particle diameter, various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficultly re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer. The invention is not limited to these methods. The concentration of silicon dioxide during the mixing and dispersion of the particulate silicon dioxide with a solvent or the like is preferably from 5 to 30% by mass, more preferably from 10 to 25% by mass, most preferably from 15 to 20% by mass. As the concentration of dispersion rises, the turbidity of the solution with respect to the added amount decreases to further reduce haze and agglomeration to advantage. The content of the matting agent in the final cellulose acylate dope solution is preferably from 0.01 to 1.0 g, more preferably from 0.03 to 0.3 g, most preferably from 0.08 to 0.16 g per m².

Preferred examples of the solvent which is a lower alcohol include methyl alcohol, ethyl alcohol, propyl alcohol, isopropyl alcohol, and butyl alcohol. The solvent other than lower alcohol is not specifically limited, but solvents which are used during the preparation of cellulose ester are preferably used.

The aforementioned organic solvent in which the cellulose acylate of the invention is dissolved will be further described hereinafter.

In the invention, as the organic solvent there may be used either a chlorine-based solvent mainly composed of chlorine-based organic solvent or a nonchlorine-based solvent free of chlorine-based organic solvent.

### <Chlorine-Based Solvent>

In order to prepare the cellulose acylate solution of the invention, as the main solvent there is preferably used a chlorine-based organic solvent. In the invention, the kind of the chlorine-based organic solvent is not specifically limited so far as the cellulose acylate can be dissolved and casted to form a film, thereby attaining its aim. The chlorine-based organic solvent is preferably dichloromethane or chloroform. In particular, dichloromethane is preferred. The chlorine-based organic solvent may be used in admixture with organic solvents other than chlorine-based organic solvent. In this case, it is necessary that dichloromethane be used in an amount of at least 50% by mass based on the total amount of the organic solvents. Other organic solvents to be used in combination with the chlorine-based organic solvent in the invention will be described hereinafter. In some detail, other organic solvents employable herein are preferably selected from the group consisting of ester, ketone, ether, alcohol and hydrocarbon having from 3 to 12 carbon atoms. The ester, ketone, ether and alcohol may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group at the same time. The number of carbon atoms in the solvent having two or more functional groups, if used, may fall within the range defined for the compound having any of these functional groups. Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The alcohol to be used in combination with the chlorine-based organic solvent may be preferably straight-chain, branched or cyclic. Preferred among these organic solvents is saturated aliphatic hydrocarbon. The hydroxyl group in the alcohol may be primary to tertiary. Examples of the alcohol employable herein include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol. Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene.

Examples of the combination of chlorine-based organic solvent and other organic solvents include the following formulations, but the invention is not limited thereto.

Dichloromethane/methanol/ethanol/butanol (80/10/5/5, parts by mass)

Dichloromethane/acetone/methanol/propanol (80/10/5/5, parts by mass)

Dichloromethane/methanol/butanol/cyclohexane (80/10/5/5, parts by mass)

Dichloromethane/methyl ethyl ketone/methanol/butanol (80/10/5/5, parts by mass)

Dichloromethane/acetone/methyl ethyl ketone/ethanol/isopropanol (75/10/10/5/7, parts by mass)

Dichloromethane/cyclopentanone/methanol/isopropanol (80/10/5/8, parts by mass)

Dichloromethane/methyl acetate/butanol (80/10/10, parts by mass)

Dichloromethane/cyclohexanone/methanol/hexane (70/20/5/5, parts by mass)

Dichloromethane/methyl ethyl ketone/acetone/methanol/ethanol (50/20/20/5/5, parts by mass)

Dichloromethane/1,3-dioxolane/methanol/ethanol (70/20/5/5, parts by mass)

Dichloromethane/dioxane/acetone/methanol/ethanol (60/20/10/5/5, parts by mass)

Dichloromethane/acetone/cyclopentanone/ethanol/isobutanol/cyclohexane (65/10/10/5/5/5, parts by mass)

Dichloromethane/methyl ethyl ketone/acetone/methanol/ethanol (70/10/10/5/5, parts by mass)

Dichloromethane/acetone/ethyl acetate/ethanol/butanol/hexane (65/10/10/5/5/5, parts by mass)

Dichloromethane/methyl acetoacetate/methanol/ethanol (65/20/10/5, parts by mass)

Dichloromethane/cyclopentanone/ethanol/butanol (65/20/10/5, parts by mass)

### <Nonchlorine-Based Solvent>

The nonchlorine-based solvent which can be preferably used to prepare the cellulose acylate solution of the invention will be described hereinafter. The nonchlorine-based organic solvent to be used in the invention is not specifically limited so far as the cellulose acylate can be dissolved and casted to form a film, thereby attaining its aim. The nonchlorine-based organic solvent employable herein is preferably selected from the group consisting of ester, ketone, ether and having from 3 to 12 carbon atoms. The ester, ketone and ether may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group. The number of carbon atoms in the solvent having two or more functional groups, if used, may fall within the range defined for the compound having any of these functional groups. Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The nonchlorine-based organic solvent to be used for cellulose acylate may be selected from the aforementioned various standpoints of view but is preferably as follows. In some detail, the nonchlorine-based solvent is preferably a mixed solvent mainly composed of the aforementioned nonchlorine-based organic solvent. This is a mixture of three or more different solvents wherein the first solvent is at least one or a mixture of methyl acetate, ethyl acetate, methyl formate, ethyl formate, acetone, dioxolane and dioxane, the second solvent is selected from the group consisting of ketones or acetoacetic acid esters having from 4 to 7 carbon atoms and the third solvent is selected from the group consisting of alcohols or hydrocarbons having from 1 to 10 carbon atoms, preferably alcohols having from 1 to 8 carbon atoms. In the case where the first solvent is a mixture of two or more solvents, the second solvent may be omitted. The first solvent is more preferably methyl acetate, acetone, methyl formate, ethyl formate or mixture thereof. The second solvent is preferably methyl ethyl ketone, cyclopentanone, cyclohexanone, methyl acetylacetate or mixture thereof.

The third solvent which is an alcohol may be straight-chain, branched or cyclic. Preferred among these alcohols are unsaturated aliphatic hydrocarbons. The hydroxyl group in the alcohol may be primary to tertiary. Examples of the alcohol include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol. Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene. The alcohols and hydrocarbons which are third solvents may be used singly or in admixture of two or more thereof without any limitation. Specific examples of the alcohol which is a third solvent include methanol, ethanol, 1-propanol, 2-propanol, 1-butanol, 2-butanol, cyclohexanol, cyclohexane, and hexane. Particularly preferred among these alcohols are methanol, ethanol, 1-propanol, 2-propanol, and 1-butanol.

Referring to the mixing ratio of the aforementioned three solvents, the mixing ratio of the first solvent, the second solvent and the third solvent are preferably from 20 to 95% by mass, from 2 to 60% by mass and from 2 to 30% by mass, more preferably from 30 to 90% by mass, from 3 to 50% by mass and from 3 to 25% by mass, particularly from 30 to 90% by mass, from 3 to 30% by mass and from 3 to 15% by mass, respectively, based on the total mass of the mixture. For the details of the nonchlorine-based organic solvents to be used in the invention, reference can be made to Kokai Giho No, 2001-1745, Mar. 15, 2001, pp. 12-16, Japan Institute of Invention and Innovation. Examples of the combination of nonchlorine-based organic solvents include the following formulations, but the invention is not limited thereto.

Methyl acetate/acetone/methanol/ethanol/butanol (75/10/5/5/5, parts by mass)

Methyl acetate/acetone/methanol/ethanol/propanol (75/10/5/5/5, parts by mass)

Methyl acetate/acetone/methanol/butanol/cyclohexane (75/10/5/5/5, parts by mass)

Methyl acetate/acetone/ethanol/butanol (81/8/7/4, parts by mass)

Methyl acetate/acetone/ethanol/butanol (82/10/4/4, parts by mass)

Methyl acetate/acetone/ethanol/butanol (80/10/4/6, parts by mass)

Methyl acetate/methyl ethyl ketone/methanol/butanol (80/10/5/5, parts by mass)

Methyl acetate/acetone/methyl ethyl ketone/ethanol/isopropanol (75/10/10/5/7, parts by mass)

Methyl acetate/cyclopentanone/methanol/isopropanol (80/10/5/8, parts by mass)

Methyl acetate/acetone/butanol (85/5/5, parts by mass)

Methyl acetate/cyclopentanone/acetone/methanol/butanol (60/15/15/5/6, parts by mass)

Methyl acetate/cyclohexanone/methanol/hexane (70/20/5/5, parts by mass)

Methyl acetate/methyl ethyl ketone/acetone/methanol/ethanol (50/20/5/5, parts by mass)

Methyl acetate/1,3-dioxolane/methanol/ethanol (70/20/5/5, parts by mass)

Methyl acetate/dioxane/acetone/methanol/ethanol (60/20/10/5/5, parts by mass)

Methyl acetate/acetone/cyclopentanone/ethanol/isobutanol/cyclohexane (65/10/10/5/5/5, parts by mass)

Methyl formate/methyl ethyl ketone/acetone/methanol/ethanol (50/20/20/5/5, parts by mass)

Methyl formate/acetone/ethyl acetate/ethanol/butanol/hexane (65/10/10/5/5/5, parts by mass)

Acetone/methyl acetoacetate/methanol/ethanol (65/20/10/5, parts by mass)

Acetone/cyclopentanone/methanol/butanol (65/20/10/5, parts by mass)

Acetone/1,3-dioxolane/ethanol/butanol (65/20/10/5, parts by mass)

1,3-Dioxolane/cyclohexanone/methyl ethyl ketone/methanol/butanol (55/20/10/5/5/5, parts by mass)

Further, cellulose acylate solutions prepared by the following methods may be used.

Method which comprises preparing a cellulose acylate solution with methyl acetate/acetone/ethanol/butanol (81/8/7/4, parts by mass), filtering and concentrating the solution, and then adding 2 parts by mass of butanol to the solution

Method which comprises preparing a cellulose acylate solution with methyl acetate/acetone/ethanol/butanol (84/10/4/2, parts by mass), filtering and concentrating the solution, and then adding 4 parts by mass of butanol to the solution

Method which comprises preparing a cellulose acylate solution with methyl acetate/acetone/ethanol (84/10/6, parts by mass), filtering and concentrating the solution, and then adding 5 parts by mass of butanol to the solution

The dope to be used in the invention comprises dichloromethane incorporated therein in an amount of 10% by mass or less based on the total mass of the organic solvents of the invention besides the aforementioned nonchlorine-based organic solvent of the invention.

### <Properties of Cellulose Acylate Solution>

The cellulose acylate solution of the invention preferably comprises cellulose acylate incorporated in the aforementioned organic solvent in an amount of from 10 to 30% by mass, more preferably from 13 to 27% by mass, particularly from 15 to 25% by mass from the standpoint of adaptability to film casting. The adjustment of the concentration of the cellulose acylate solution to the predetermined range may be effected at the dissolution step. Alternatively, a cellulose acylate solution which has been previously prepared in a low concentration (e.g., 9 to 14% by mass) may be adjusted to the predetermined concentration range at a concentrating step described later. Alternatively, a cellulose acylate solution which has been previously prepared in a high concentration may be adjusted to the predetermined lower concentration range by adding various additives thereto. Any of these methods may be used so far as the predetermined concentration range can be attained.

In the invention, the molecular weight of the associated cellulose acylate in the cellulose acylate solution which has been diluted with an organic solvent having the same formulation to a concentration of from 0.1 to 5% by mass is preferably from 150,000 to 15,000,000, more preferably from 180,000 to 9,000,000 from the standpoint of solubility in solvent. For the determination of the molecular weight of associated product, a static light scattering method may be used. The dissolution is preferably effected such that the concurrently determined square radius of inertia ranges from 10 to 200 nm, more preferably from 20 to 200 nm. Further, the dissolution is preferably effected such that the second virial coefficient ranges from −2×10⁻⁴ to +4×10⁻⁴, more preferably from −2×10⁻⁴ to +2×10⁻⁴

The definition of the molecular weight of the associated product, the square radius of inertia and the second virial coefficient will be described hereinafter. These properties are measured by static light scattering method in the following manner. The measurement is made within a dilute range for the convenience of device, but these measurements reflect the behavior of the dope within the high concentration range of the invention.

Firstly, the cellulose acylate is dissolved in the same solvent as used for dope to prepare solutions having a concentration of 0.1% by mass, 0.2% by mass, 0.3% by mass and 0.4% by mass, respectively. The cellulose acylate to be weighed is dried at 120° C. for 2 hours before use to prevent moistening. The cellulose acylate thus dried is then weighed at 25° C. and 10% RH. The dissolution of the cellulose acylate is effected according to the same method as used in the dope dissolution (ordinary temperature dissolution method, cooled dissolution method, high temperature dissolution method). Subsequently, these solutions with solvent are filtered through a Teflon filter having a pore diameter of 0.2 μm. The solutions thus filtered are each then measured for static light scattering every 10 degrees from 30 degrees to 140 degrees at 25° C. using a Type DLS-700 light scattering device (produced by Otsuka Electronics Co., Ltd.) The data thus obtained are then analyzed by Berry plotting method. For the determination of refractive index required for this analysis, the refractive index of the solvent is measured by an Abbe refractometer. For the determination of concentration gradient of refractive index (dn/dc), the same solvent and solution as used in the measurement of light scattering are measured using a type DRM-1021 different refractometer (produced by Otsuka Electronics Co., Ltd.).

### <Method for Producing Dope>

In general, the aforementioned raw materials are used to produce a dope at first. The method for producing a dope which is preferably effected in the invention will be described hereinafter.

Firstly, a solvent is transferred from the solvent tank to the dissolving tank. Subsequently, a cellulose acylate contained in a hopper is transferred to the dissolving tank while being metered. Separately, an additive solution is transferred from the additive tank to the dissolving tank. The additives, if they stay liquid at ordinary temperature, may be transferred to the dissolving tank in liquid form instead of solution form. Alternatively, the additives, if they are solid, may be transferred to the dissolving tank through a hopper or the like. In the case where a plurality of additives are added, a solution having a plurality of additives dissolved therein may be put in the additive tank. Alternatively, solutions having the respective additives dissolved therein may be put in a number of additive tanks, respectively, from which they are transferred to the dissolving tank through independent pipings.

In the aforementioned description, the solvent (including mixed solvent), the cellulose acylate and the additives are charged in the dissolving tank in this order, but the order of addition of these components is limited thereto. For example, the cellulose acylate is transferred to the dissolving tank while being metered, and a desired amount of the solvent is then transferred. The additives are not necessarily needed to be previously put in the dissolving tank. The additives may be mixed with a mixture of cellulose acylate and solvent (hereinafter occasionally referred to as “dope”).

The dissolving tank is equipped with a jacket for wrapping the outer surface thereof and a first agitator which rotates by a motor. The dissolving tank is preferably equipped with a second agitator which rotates by a motor. The first agitator is preferably equipped with an anchor blade. The second agitator is preferably a dissolver type eccentric agitator. By allowing heat transfer medium to flow through the gap between the dissolving tank and the jacket, the dissolving tank is temperature-controlled. The temperature of the dissolving tank is preferably from −10° C. to 55° C. By properly selecting the type of the first agitator and the second agitator, a swollen solution having a cellulose acylate swollen with a solvent is obtained.

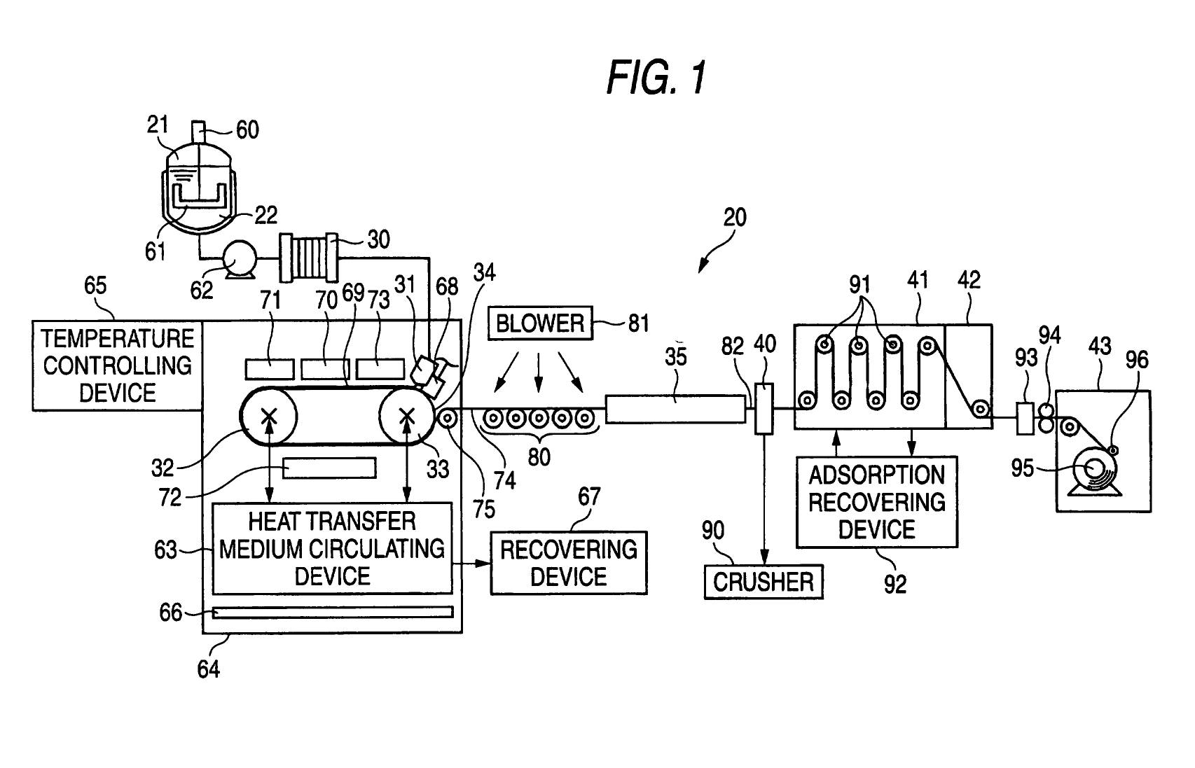

The swollen solution is transferred to a heating device by a pump. The heating device is preferably a piping with jacket. Further, the heating device is preferably arranged to press the swollen solution. The use of such a heating device makes it possible to dissolve the solid content in the swollen solution under heating or heat pressure and obtain a dope. This method will be hereinafter referred to as “hot dissolving method”. In this case, the temperature of the swollen solution is preferably from 50° C. to 120° C. A cold dissolving method involving the cooling of the swollen solution to a temperature of from −100° C. to −30° C. may be employed. By properly selecting the hot dissolving method and the cold dissolving method, the cellulose acylate can be sufficiently dissolved in the solvent. The dope which has been adjusted to about room temperature by a temperature controller is then filtered through a filtering device to remove impurities therefrom. The filter to be used in the filtering device preferably has an average pore diameter of 100 μm or less. The filtration flow rate is preferably 50 L/hr or more. The dope 22 which has been filtered is transferred to the stock tank 21 in the film production line 20 of FIG. 1, for example, where it is then stored.

In the aforementioned method which comprises preparing a swollen solution that is then processed to obtain a dope, the higher the concentration of cellulose acylate is, the longer is the time required. This can be a production cost problem. In this case, a dope having a lower concentration than the desired concentration is prepared. Thereafter, a concentration step for obtaining the desired concentration is preferably effected. In the case where this method is used, the dope which has been filtered through the filtering device is transferred to a flash device in which part of the solvent in the dope is then evaporated. The solvent gas produced by evaporation is condensed by a condenser (not shown) to a liquid which is then recovered by a recovering device. The solvent thus recovered is regenerated as a solvent for preparing dope by a regenerator. The solvent thus regenerated is then reused. The reuse of the solvent is advantageous from the standpoint of cost.

The dope thus concentrated is drawn out of the flash device by a pump. In order to withdraw bubbles generated in the dope, defoaming is preferably effected. Defoaming can be carried out by any known method. For example, ultrasonic irradiation method may be used. Subsequently, the dope is transferred to a filtering device where impurities are then removed therefrom. The temperature of the dope to be filtered is preferably from 0° C. to 200° C. The dope 22 is then transferred to the stock tank 21 where it is then stored.

In the aforementioned manner, a dope having a cellulose acylate concentration of from 5% to 40% by mass can be produced. The cellulose acylate concentration of the dope is more preferably from not lower than 15% by mass to not higher than 30% by mass, most preferably from not lower than 17% by mass to not higher than 25% by mass. The concentration of the additives (mainly plasticizer) is preferably from not lower than 1% by mass to not higher than 20% by mass based on 100% by mass of the entire solid content of the dope. For the details of dope producing method such as dissolving, adding and filtering materials, raw materials and additives in the solution film production method for obtaining cellulose acylate film, reference can be made to IP-A-2005-104148, paragraph [0517]-[0616]. These descriptions can apply to the invention.

### <Solution Film Producing Method>

The solution film producing method which is preferably effected in the invention will be described hereinafter.

An example of the method for producing a film from the dope 22 obtained above will be described hereinafter. FIG. 1 is a schematic diagram illustrating a film producing line 20. However, the invention is not limited to the film producing line shown in FIG. 1. The film producing line 20 is provided with a stock tank 21, a filtering device 30, a casting die 31, a casting band 34 extending over revolving rollers 32, 33, and a tenter drying machine 35. The film producing line 20 is further provided with a trimming device 40, a drying chamber 41, a cooling chamber 42, and a winding chamber 43.

The stock tank 21 has an agitator 61 attached thereto which rotates by a motor 60. The stock tank 41 is connected to the casting die 31 via a pump 62 and the filtering device 30.

The material of the casting die 31 is preferably a precipitation hardening stainless steel having an expansion coefficient of 2×10⁻⁵ (° C.⁻¹) or less. A stainless steel having almost the same corrosion resistance as that of SUS316 as determined by a forced corrosion test in an electrolytic aqueous solution can be also used as the material of the casting die 31. Further, a stainless steel which is so corrosion-resistant that it shows no pitting (porosity) on the gas-liquid interface even after 3 months of dipping in a mixture of dichloromethane, methanol and water can be also used. Further, a steel which has been allowed to stand for 1 month or more after being forged is preferably ground to prepare the casting die 31. In this arrangement, the dope 22 flows uniformly in the interior of the casting die 31, making it possible to prevent the occurrence of streak in the cast film 69 described later. The finished precision of the casting die 31 on the surface in contact with liquid is preferably 1 μm or less as calculated in terms of surface roughness. The straightness of the casting die 31 is preferably 1 μm/m or less in all directions. The clearance of slit can be automatically adjusted to a range of from 0.5 mm to 3.5 mm. Referring to the corner portion of the forward end of the lip of the casting die 31, working is made such that R is 50 μm or less over the entire width of slit. The shearing speed in the casting die 31 is preferably adjusted to a range of from 1 (1/sec) to 5,000 (1/sec).

The width of the casting die 31 is not specifically limited but is preferably from 1.1 to 2.0 times the width of the film as final product. In order to keep the film forming temperature at a predetermined value, the casting die 31 is preferably provided with a temperature controller (not shown). As the casting die 31 there is preferably used a coat hunger type die. The casting die 31 preferably has thickness adjusting bolts (heat bolts) provided therein at a predetermined pitch in the width direction and is provided with an automatic thickness adjusting mechanism using a heat bolt. In order to form a film, this heat bolt preferably sets profile depending on the amount of solution to be transferred through a gear pump 62 (preferably a high precision gear pump) by a predetermined program. The heat bolt may also make feedback control by an adjustment program based on the profile of an infrared thickness gauge (not shown) installed on the film production line 20. The adjustment is preferably made such that in the product film excluding the cast edge portion, the difference in thickness between two arbitrary points along the width of the product film is 1 μm or less and the crosswise difference between the minimum value and the maximum value of thickness is 3 μm or less, preferably 2 μm or less. A product film having a thickness precision adjusted to ±1.5 μm or less is preferably used.

The forward end of the lip of the casting die 31 preferably has a cured film formed thereon. The method for forming the cured film is not specifically limited but may be a ceramics coating method, hard chromium plating method, nitriding method or the like. The ceramics, if used as cured film, preferably can be ground, have a low porosity and hence no brittleness, a good corrosion resistance, a good adhesion to the casting die 31 and no adhesion to the dope 22. Specific examples of the ceramics employable herein include tungsten carbide (WC), Al₂O₃, TiN, and Cr₂O₃. Particularly preferred among these ceramics is WC. WC coating can be accomplished by a flame spraying method.

In order to prevent the dope which is discharged out of the slit end of the casting die 31 from being locally dried and solidified, the slit end preferably has a solvent supplying device (not shown) attached thereto. In this case, a solvent for solubilizing the dope (e.g., mixture of 86.5 parts by mass of dichlomethane, 13 parts by mass of acetone and 0.5 parts by mass of n-butanol) is preferably supplied into the both ends of the casting bead and the area in the vicinity of the three-phase-contact line defined by the end of the die slit and the open air. In order to prevent the entrance of foreign materials into the cast film, the solvent is preferably supplied at a rate of 0.1 mL/min to 1.0 mL/min each for the ends of the casting bead. As the pump for supplying this solution there is preferably used one having a percent pulsation of 5% or less.

Provided under the casting die 31 is a casting band 34 extending over revolving rollers 32, 33. The revolving rollers 32, 33 rotate by a driving device which is not shown. With the rotation of these revolving rollers, the casting band 34 runs endlessly. The casting band 34 preferably moves at a moving velocity or casting velocity of from not smaller than 10 m/min to not greater than 200 m/min, more preferably from not smaller than 15 m/min to not greater than 150 m/min, most preferably from not smaller than 20 m/min to not greater than 120 m/min. From the standpoint of film productivity, the casting velocity is preferably 10 m/min or more. The casting velocity is also preferably 200 m/min or less to form the casting bead stably so that the surface conditions of the cast film 69 are good.

In order to keep the surface temperature of the casting band 46 at a predetermined value, the revolving rollers 32, 33 are preferably equipped with a heat transfer medium circulating device 63. The casting band 34 is preferably arranged capable of being controlled to a surface temperature of from −20° C. to 40° C. Formed in the revolving rollers 32, 33 used in the present embodiment is a heat transfer medium channel (not shown) through which a heat transfer medium passes to keep the temperature of the revolving rollers 32, 33 at a predetermined value.

The width of the casting band 34 is not specifically limited but is preferably from 1.1 to 2.0 times the casting width of the dope 22. The casting band 34 preferably has a length of from 20 m to 200 m and a thickness of from 0.5 mm to 2.5 mm. The casting band 34 is preferably ground to a surface roughness of 0.05 or less. The casting band 34 is preferably made of stainless steel. More preferably, the casting band 34 is made of SUS316 to have a sufficient corrosion resistance and strength. The casting band 34 to be used herein preferably has an entire thickness unevenness of 0.5% or less.

Further, the revolving rollers 32, 33 may be used support as they are. In this case, the revolving rollers 32, 33 are preferably designed to rotate with such a high precision that the rotation unevenness is 0.2 mm or less. In this case, the average surface roughness of the revolving rollers 32, 33 is preferably 0.01 μm or less. To this end, these revolving rollers are plated with chromium on the surface thereof to have a sufficient hardness and durability. It is necessary that the surface defects of the support (casting band 34 or revolving rollers 32, 33) be minimized. In some detail, the support preferably has no pinholes having a size of 30 μm or more, pinholes having a size of from 10 μm to 30 μm in a number of 1 or less per m² and pinholes having a size of less than 10 μm in a number of 2 or less per m².

The casting die 31, casting band 34, etc. are received in a casting chamber 64. The casting chamber 64 is provided with a temperature controlling device 65 for keeping its internal temperature at a predetermined value and a condenser 66 for condensing and recovering the organic solvent volatilized. A recovering device 67 for recovering the organic solvent which has been condensed and liquefied is provided outside the casting chamber 64. It is also preferred that a pressure reducing chamber 68 for controlling the pressure on the back surface of the casting bead formed extending from the casting die 31 to the casting band 34 be provided. In the present embodiment, too, this pressure reducing chamber is used.

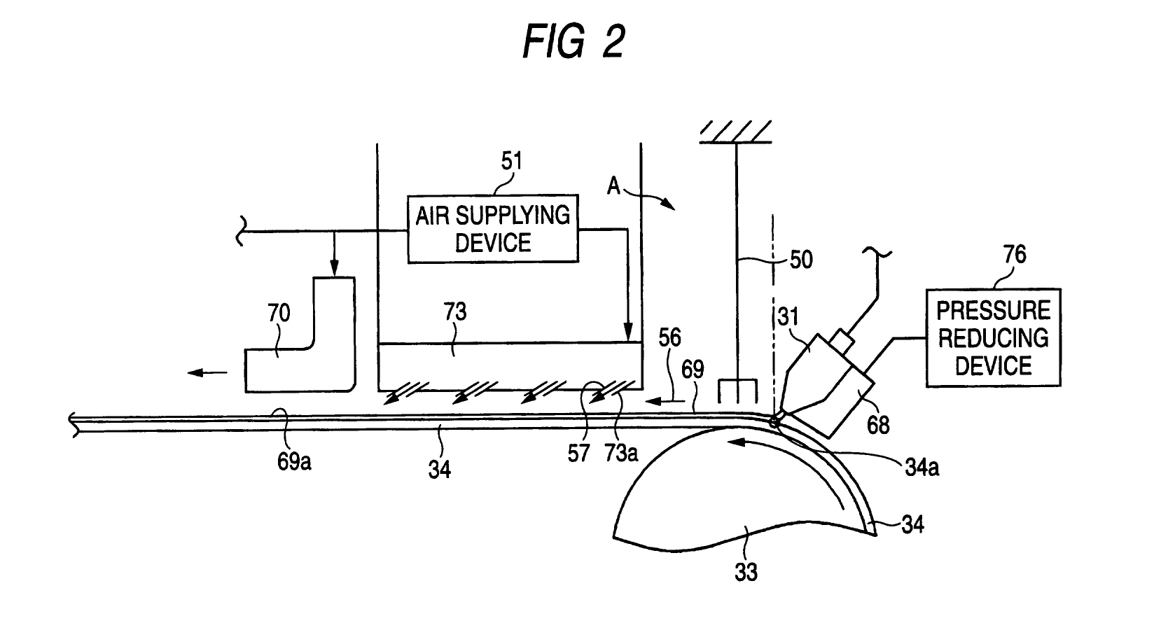

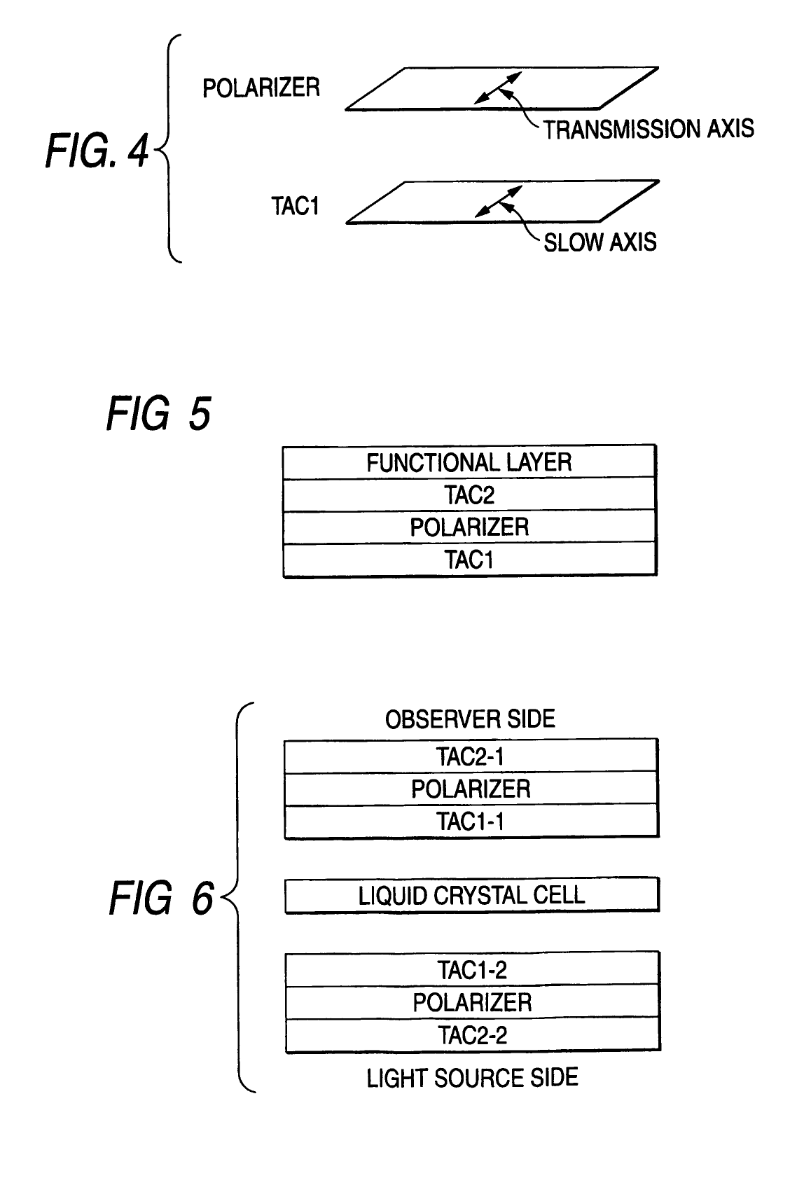

Air blowing ports 70, 71, 72 for evaporating the solvent in the cast film 69 are provided in the vicinity of the periphery of the casting band 34. As shown in FIG. 2, a labyrinth seal 50 is provided in the vicinity of the casting die 31 to suppress the change of surface conditions of the cast film 69 developed when drying air is blown against the cast film 69 which has been just formed. Provided interposed between the labyrinth seal 50 and the air blowing port 70 is an air blowing portion for rapid drying (hereinafter referred to as “rapid drying blowing port”) 73. To the rapid drying blowing port 73 and the other air blowing ports 70 to 72 are attached an air supplying device 51. The rapid drying blowing port 73 has a plurality of nozzles 73a so that drying air 57 is blown against the surface of the cast film 69 to form an initial film 69a on the surface of the cast film 69. Four nozzles are shown provided in the rapid drying air blowing port 73 in FIG. 4, but the invention is not limited thereto. The distance between the labyrinth seal 50 and the rapid drying air blowing port 73 is defined as L1 (mm). The region ranging from the labyrinth seal 50 and the rapid drying air blowing port 73 is referred to as “spontaneous wind region A”. The length of the rapid drying air blowing port 73 is defined as L2 (mm). The pressure reducing chamber 68 has a pressure reducing device (or root blower) 76 connected thereto. The period of time during which drying air 57 hits the cast film 69 is preferably 20 seconds or more. The blowing time of drying air 57 is preferably 20 seconds or more so that the formation of the initial film 69a can proceed to obtain a film having excellent surface conditions.

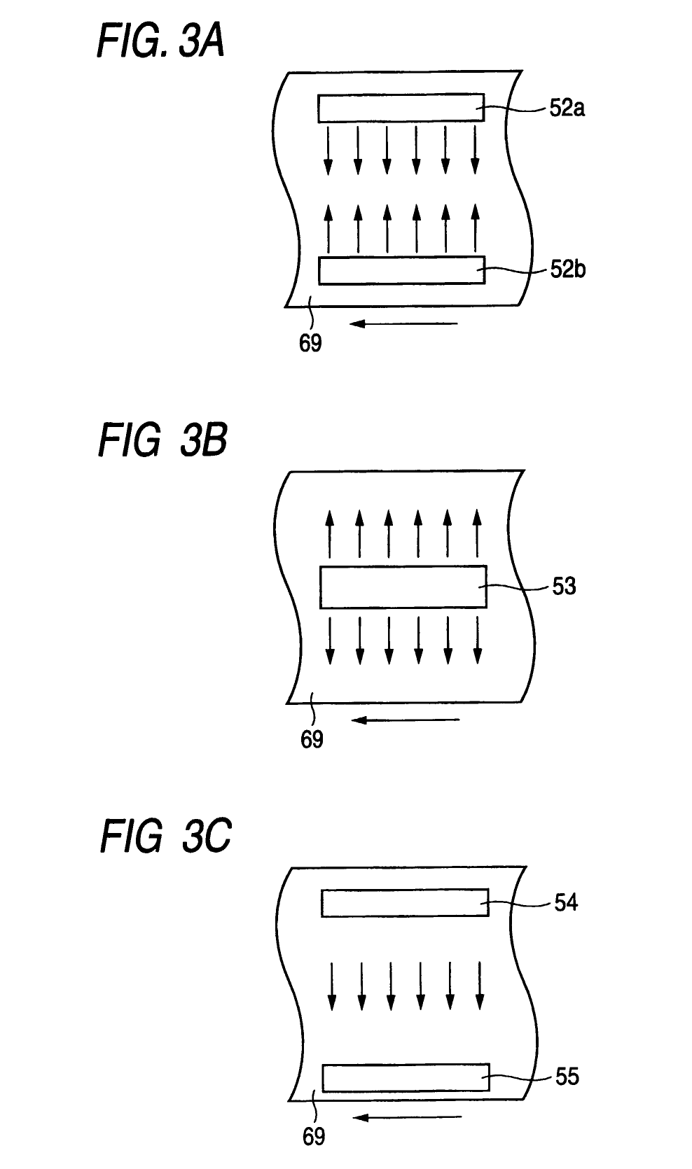

As shown in FIG. 3A to 3C, the direction of blowing of drying air from the nozzle may be in various embodiments. For example, as shown in FIG. 3A, drying air is blown from the nozzles 52a, 52b disposed on the both edges of the cast film 69 onto the central portion of the cast film 69. Alternatively, as shown in FIG. 3B, a nozzle 53 may be provided on the crosswise central portion of the cast film 69 so that drying air flows from the central portion to hit the both edges of the cast film 69. Further, as shown in FIG. 3C, drying air may be blown from the nozzle 54 provided on the cast film 69 toward the suction port 55 to hit the cast film 69. The shape of the nozzle is not specifically limited.

The transportation portion 80 is provided with a blower 81. To a trimming device 40 disposed downstream of the tenter drying machine 35 is connected a crusher 90 for finely cutting chips of the edges (also referred to as “ear”) of the film 82 thus cut away.

The drying chamber 41 is provided with a number of rollers 91. The drying chamber 41 has an adsorption recovering device 92 attached thereto for adsorbing and recovering the solvent gas produced by the evaporation of the solvent. In FIG. 1, a cooling chamber 42 is provided downstream of the drying chamber 41. A moisture conditioning chamber (not shown) may be provided interposed between the drying chamber 41 and the cooling chamber 42. A forced destaticizing device (destaticization bar) 93 is provided downstream of the cooling chamber 42 for adjusting the charged voltage of the film 82 to a predetermined range (e.g., −3 KV to +3 kV). In FIG. 1, the forced destaticizing device 93 is shown disposed downstream of the cooling chamber 42, but the invention is not limited to this disposition position. Further, in the present embodiment, a knurling roller 94 for embossing the both edges of the film 82 to knurl the film 82 is properly provided downstream of the forced destaticizing device 93. Inside the winding chamber 43 are provided a winding roller 95 for winding the film 82 and a press roller 96 for controlling the tension of the film during winding.

An example of the method for producing the film 82 on the aforementioned film production line 20 will be described hereinafter. The dope 22 is always uniformly uniformalized by the rotation of the agitator 61. The dope 22 may be mixed with additives such as plasticizer and ultraviolet absorber also during this agitation.

The dope 22 is transferred by the pump 62 to a filtering device 30 where it is then filtered. The dope 22 thus filtered is then flow-casted over the casting band 34 from the casting die 31. The driving of the revolving rollers 32, 33 is preferably adjusted such that the tension developed in the casting band 34 reaches a range of from 10⁴ N/m to 10⁵ N/m. The relative difference in velocity between the casting band 34 and the revolving rollers 32, 33 is adjusted to 0.01 m/min or less. The change of velocity of the casting band 34 is preferably adjusted to 0.5% or less and that the crosswise meandering of the casting band 34 developed per rotation is preferably adjusted to 1.5 mm or less. In order to control the meandering of the casting band 34, the position of the casting band 34 is more preferably adjusted by making feedback control on the position controller (not shown) of the casting band 34 on the basis of measurements of the position of the both ends of the casting band 34 given by a detector for detecting the position of the both ends of the casting band 34 (not shown). Further, the casting band 34 disposed directly under the casting die 31 is preferably adjusted such that the vertical positional change of the casting band 34 with the rotation of the revolving rollers 33 is 200 μm or less. Moreover, the temperature in the casting chamber 64 is preferably adjusted to a range of from −10° C. to 57° C. by a temperature controlling device 65. The solvent which has been evaporated in the casting chamber 64 is recovered by a recovering device 67, regenerated, and then reused as a solvent for preparing a dope.

A casting bead is formed over an area extending from the casting die 31 to the casting band 34. A cast film 69 is formed on the casting band 34. The temperature of the dope 22 during casting is preferably from −10° C. to 57° C. In order to stabilize the casting bead, the pressure on the back surface of the casting bead is preferably controlled to a predetermined value by a pressure reducing chamber 68. The pressure on the back surface of the casting bead is preferably reduced by a range of from 10 Pa to 2,000 Pa from the pressure on the front surface of the casting bead. Further, the pressure reducing chamber 68 is preferably provided with a jacket (not shown) so that the internal temperature therein is kept at a predetermined value. The temperature in the pressure reducing chamber 68 is not specifically limited but is preferably adjusted to not lower than the condensation point of the organic solvent used. In order to keep the shape of the casting bead as desired, the casting die 31 preferably has a suction device (not shown) attached thereto at the edge portion thereof. The edge air suction rate is preferably from 1 L/min to 100 L/min.

When discharged from the casting die 31, the dope 22 forms a casting bead which is then flow-casted over the casting band 34. The viscosity of the dope 22 during flow casting (as measured by rheometer) is preferably from not smaller than 10 Pa·s to not greater than 100 Pa·s, more preferably from not smaller than 12 Pa·s to not greater than 50 Pa·s, most preferably from not smaller than 15 Pa·s to not greater than 40 Pa·s. The casting bead forms a cast film 69 on the casting band 34. The position at which the casting bead comes in contact with the casting band 34 is referred to as “casting starting position 34a”. The viscosity of the dope 22 is preferably not smaller than 10 Pa·s so that the viscosity of the dope 22 is not too low, the dope 22 undergoes little unevenness due to drying air, the surface conditions of the cast film 69 are good and the initial film 69a can be easily formed. This viscosity range is advantageous also in that the solvent content is not too great, causing no violent volatilization of the solvent in the initial stage of drying of the cast film 69 and hence little maldrying (e.g., foaming) and making the rise of size of the solvent recovering device unnecessary.

The cast film 69 moves with the movement of the casting band 34. A natural wind (hereinafter referred to as “spontaneous wind”) occurs on the cast film 69. The region ranging from after casting to blowing of drying air is referred to as “spontaneous wind region A”. The spontaneous wind region A is provided with a labyrinth seal 50 so that downstream spontaneous wind 56 is prevented from flowing backward to a portion in the vicinity of the casting die 31. This spontaneous wind 56 is normally a weak wind that flows at a velocity of 2 m/s or less, or less than 3 m/s in the invention. However, when spontaneous wind 56, which is a turbulent flow, hits the surface of the cast film 69, the surface conditions of the cast film 69 are deteriorated. Therefore, the length L1 (mm) of the spontaneous wind region A is preferably as short as possible. However, from the standpoint of the relationship of the disposition of the various devices in the film production line 20, the length L1 (mm) is preferably 3,000 mm or less, more preferably 2,000 mm or less, even more preferably 1,000 mm or less. The period of time during which the cast film 69 passes through the spontaneous wind region A is preferably 15 seconds or less, more preferably 10 seconds or less, most preferably 7 seconds or less.

Subsequently, the cast film 69 is continuously conveyed to the position above which the rapid drying air blowing port 73 is disposed. Drying air 57 is blown from the nozzle 73a of the rapid drying air blowing port 73 toward the cast film 69. When drying air 57 hits the cast film 69, the cast film 69 forms an initial film 69a on the surface thereof. The leveling effect of the initial film 69a causes the surface of the cast film 69 to be smoothened and dried. In the invention, the formation of the initial film 69a is not limited to the method involving the hitting of drying air 57 to the surface of the cast film 69. For example, infrared heater heating, microwave heating or the like may be effected to form the initial film 69a.

The wind velocity of drying air 57 is preferably from not smaller than 3 m/s to not greater than 15 m/s, more preferably from not smaller than 4 m/s to not greater than 12 m/s, most preferably from not smaller than 4 m/s to not greater than 10 rn/s. The wind velocity of drying air 57 is preferably 3 m/s to smoothen the formation of the initial film 69a so that the deterioration of surface conditions of the cast film 69 before the formation of the initial film can be avoided. Further, the wind velocity of drying air 57 is preferably 15 m/s or less to prevent drying air 57 from hitting the cast film 69 too strongly so that an initial film 69a having excellent surface conditions can be formed.

The gas concentration in the drying air 57 is preferably 25% or less, more preferably 20% or less, most preferably 18% or less. The term “gas concentration” as used herein is meant to indicate the content of volatile solvents in the drying air 57 measured by infrared analysis. The cast film 69 which has been just formed contains a large amount of solvents. The gas concentration in the drying air 57 is preferably 25% or less so that the volatilization of the solvents from the cast film 69 having a great solvent content cannot be retarded, making it easy to form the initial film 69a.

The temperature of the drying air 57 is preferably from not smaller than 40° C. to not greater than 150° C., more preferably from not smaller than 45° C. to not greater than 120° C., most preferably from not smaller than 50° C. to not greater than 100° C. The temperature of the drying air 57 is preferably 40° C. or more to facilitate the progress of volatilization of solvents from the cast film 69 so that an initial film 69a having good surface conditions can be formed. Further, the temperature of the drying air 57 is preferably 150° C. or less to prevent the foaming of solvents in the cast film 69 and hence rapid volatilization so that an initial film 69a having good surface conditions can be easily formed.

In the invention, the period of time during which the spontaneous wind 56 hits the cast film 69 is preferably 15 seconds or less, more preferably 10 seconds or less, most preferably 7 seconds or less after flow casting. The period of time during which the spontaneous wind 56 hits the cast film 69 is preferably 15 seconds or less to avoid the formation of thickness unevenness on the surface of the cast film 69 due to rapid drying before the formation of a uniform initial film 69a on the surface of the cast film 69 so that a film 82 having uniform surface conditions can be obtained. Since the drying time is short, the productivity of the film 82 is good.

The solvent content of the cast film 69 at the starting of drying is preferably from not smaller than 200% by mass to not greater than 500% by mass, more preferably from not smaller than 250% by mass to not greater than 450% by mass, most preferably from not smaller than 300% by mass to not greater than 420% by mass as calculated in terms of solid content.

The rate of drop of the content of remaining solvents in the cast film developed for 30 seconds after the blowing of the drying air 57 to the cast film 69 is preferably from not smaller than 1% by mass to not greater than 15% by mass, more preferably from not smaller than 3% by mass to not greater than 12% by mass, most preferably from not smaller than 5% by mass to not greater than 10% by mass, per second. The drying rate is preferably 1% by mass/s or more to prevent the retardation of formation of the initial film 69a so that an initial film 69a having a sufficient film strength can be easily formed. Further, the drying rate is preferably 15% by mass/s or less to form the initial film 69a uniformly and inhibit the foaming of the cast film 69 or the deterioration of surface conditions of the cast film 69.

The cast film 69 moves with the running of the casting band 34. During this procedure, drying air is blown from the air blowing ports 70, 71 and 72 against the cast film 69 to accelerate the evaporation of solvents. Although the blowing of drying air can cause the change of surface conditions of the cast film 69, the labyrinth seal 50 inhibits this change. The surface temperature of the casting band 34 is preferably from −20° C. to 40° C.

The cast film 69 becomes self-supporting, and then is peeled off the casting band 34 as swollen film 74 while being supported on a peeling roller 75. The residual solvent content during peeling is preferably from 20% by mass to 250% by mass as calculated in terms of solid content. Thereafter, the swollen film 74 is conveyed through a transportation portion 80 provided with a number of rollers over which it is then transferred to a tenter drying machine 35. On the transportation portion 80, drying air having a desired temperature is blown from a blower 81 to accelerate the drying of the swollen film 74. During this procedure, the temperature of the drying air is preferably from 20° C. to 250° C. On the transportation portion 80, the rotary speed of the downstream roller can be predetermined higher than that of the upstream roller to provide the swollen film 74 with a draw tension.

The swollen film 74 which is being conveyed to the tenter drying machine 35 is dried while being conveyed with its both edges gripped by clips. The interior of the tenter drying machine 35 is preferably divided into drying zones each of which is properly adjusted in drying conditions. The swollen film 74 can be crosswise stretched using the tenter drying machine 35.

In order to prepare the cellulose acylate film of the invention, the swollen film 74 may be stretched in either or both of the flow casting direction and crosswise direction using the transportation portion 80 and/or tenter drying machine 35. In this case, the draw ratio is preferably from 1.01 to 1.3, more preferably from 1.01 to 1.15 both in the flow casting direction and crosswise direction. The ratio of increase of area caused by stretching in the flow casting direction and crosswise direction is preferably from 1.01 to 1.4, more preferably from 1.01 to 1.3. The ratio of increase of area can be determined by the product of draw ratio in the flow casting direction and draw ratio in the crosswise direction.

The crosswise stretching step may be followed by a relaxing step. At the relaxing step, the cellulose acylate film which has been crosswise stretched is kept at a predetermined temperature so that the stretched film is shrunk. The percent relaxation is preferably 20% or less, particularly preferably 15% or less. The temperature at which the stretched film is kept is preferably from the value 30° C. lower than the glass transition point of the aforementioned cellulose acylate to the value 30° C. higher than the glass transition point of the cellulose acylate. When the retention temperature is too high, the desired properties (retardation) cannot be obtained. On the contrary, when the retention temperature is too low, the molecular orientation at the stretching step is frozen, making it impossible to uniformalize the retardation value. The retention time is preferably from 10 seconds to 300 seconds, more preferably from 30 seconds to 180 seconds. When the retention time is too long, the resulting stress relaxing effect is too small to uniformalize the retardation value. When the retention time is too long, the thickness-direction dispersion of retardation value of the film increases.

The swollen film 74 is dried to a predetermined residual solvent content by the tenter drying machine 35, and then transferred downstream as a film 82. The film 82 is cut at the both edges thereof by a trimming device 40. The edges of the film 82 thus cut away are then transferred to a crusher 90 by a cutter blower which is not shown. Using the crusher 90, the film edges are crushed to chips. These chips are reused for dope preparation to advantage from the standpoint of cost. The step of cutting the both edges of the film can be omitted but is preferably effected at any of the flow casting step to the film winding step.

The film 82 which has been freed of both edges is transferred to a drying chamber 41 where it is then further dried. The temperature in the drying chamber 41 is not specifically limited but is preferably from 50° C. to 160° C. In the drying chamber 41, the film 82 is conveyed while extending over a roller 91. The solvent gas generated by the evaporation of solvents at this step is then adsorbed and recovered by an adsorption recovering device 92. The air which had thus been freed of solvent components is then again blown as drying air into the drying chamber 41. The drying chamber 41 is preferably divided into a plurality of compartments. By predrying the film 82 in a predrying chamber (not shown) provided interposed between the trimming device 40 and the drying chamber 41, the rapid rise of the film temperature in the drying chamber 41 can be prevented, making it possible to further inhibit the change of the shape of the film 82.

The film 82 is cooled normally to about room temperature in a cooling chamber 42. A moisture conditioning chamber (not shown) may be provided interposed between the drying chamber 41 and the cooling chamber 42. In this moisture conditioning chamber, air which has been conditioned to a desired humidity and temperature is preferably blown against the film 82. In this manner, the occurrence of curling of the film 82 or malwinding of the film 82 during winding can be inhibited.

The charged voltage of the film 82 during conveyance is predetermined to a desired range (e.g., −3 kV to +3 kV) by a forced destaticizing device (destaticization bar) 93. The forced destaticizing device is shown disposed downstream of the cooling chamber 42 in FIG. 1, but the invention is not limited to this position. Further, a knurling roller 94 is preferably provided to emboss the both edges of the film 82 so that the film 82 is knurled. The roughness of the area thus knurled is preferably from 1 μm to 200 μm.

Finally, the film 82 is wound on a winding roller 95 in a winding chamber 43. During this procedure, the film 82 is preferably wound on a press roller 96 while being provided with a desired tension. The tension is preferably allowed to change gradually from the winding starting time to the winding ending time. The size of the film 82 thus wound is preferably at least 100 m or more in the longitudinal direction (flow casting direction). The width of the film 82 is preferably 600 mm or more, more preferably from not smaller than 1,400 mm to not greater than 1,800 mm. The invention is also advantageous even when the width of the film 82 is more than 1,800 mm. The invention can apply even when a film 82 having a thickness as small as from not smaller than 15 μm to not greater than 100 μm is produced.

In order to flow-cast the dope in the solution film forming method of the invention, two or more dopes may be subjected to simultaneous or successive lamination co-casting. The both co-casting methods may be effected in combination. In the case where the simultaneous lamination co-casting method is effected, a casting die having a feed block attached thereto or a multi-manifold casting die may be used. In the film composed of a multiple of layers prepared by co-casting method, at least one of thickness of the air side layer and the support side layer is preferably from 0.5% to 30% of the total thickness of the film. In the case where the simultaneous lamination co-casting method is effected, the high viscosity dope is preferably wrapped by the low density dope when the dope is flow-casted from the die slit over the support. In the case where the simultaneous lamination co-casting method is effected, the dope in contact with the exterior preferably has a higher alcohol composition ratio than the internal dope in the casting bead formed over the range extending from the die slit to the support.

For the details of the structure of the casting die, pressure reducing chamber, support, etc, the drying conditions at co-casting, peeling and stretching steps, handling method, winding method after curling and planarity correction, solvent recovering method, and film recovering method, reference can be made to Japanese Patent Application No. 2004-264464, paragraph [0617]-[0889]. These descriptions can be also used in the invention.

### <Optically Compensatory Film>

An optically compensatory layer (optically anisotropic layer) described below can be provided on the cellulose acylate film of the invention directly or with other layers interposed therebetween to obtain an optically compensatory film.

### <Optically Compensatory Layer>

As the optically compensatory layer there may be used a birefringent film of polymer film, alignment film of liquid crystal polymer, alignment film of low molecular liquid crystal or combination thereof.

A method is preferably employed which comprises spreading a solution obtained by dissolving at least one polymer material selected from the group consisting of polyamides, polyimides, polyesters, polyether ketones, polyamideimides, polyesterimides and polyarylether ketones as a polymer film constituting the optically compensatory layer in a solvent over a substrate, and then drying the coat material so that the solvent is removed to form a film. In this case, the aforementioned polymer film and substrate may be stretched to develop optical anisotropy so that the film can be used as an optically anisotropic layer. Thus, the cellulose acylate film of the invention can be used as the aforementioned substrate to advantage. Alternatively, the aforementioned polymer film may be previously prepared on a separate substrate. The polymer film is peeled off the substrate, and then stuck to the cellulose acylate film of the invention to form a laminate which is used as an optically anisotropic layer. In this method, the thickness of the polymer film can be reduced. The thickness of the polymer film is preferably 50 μm or less, more preferably from 1 μm to 20 μm.

An optically anisotropic layer is obtained by controlling the thickness-direction retardation of a polymer film using a method which comprises biaxially stretching the polymer film in in-plane direction, a method which comprises stretching the polymer film in in-plane direction monoaxially or biaxially and in thickness-direction or like method. Alternatively, an optically anisotropic layer is obtained by a method which comprises bonding a heat-shrinkable film to a polymer film, and then stretching and/or shrinking the polymer film under the action of shrinking force developed by heating so that it is tilt-aligned. The optically compensatory film may be prepared by spreading an optically anisotropic polymer layer over a support to make a laminate or by a spreading a polymer layer over a support to make a laminate of a polymer layer and a support which is then stretched to develop optical anisotropy.

Examples of liquid crystal polymers include various main chain types or side-chain types of liquid crystal polymers having a liquid crystal alignment-providing conjugated linear atomic group (mesogen) incorporated in its main chain or side chains. Specific examples of the main chain type of liquid crystal polymers include polyester-based liquid crystal polymers, discotic polymers and cholesteric polymers having a mesogen group connected thereto at a flexibility-providing spacer portion, e.g., nematic alignment. Specific examples of the side-chain type of liquid crystal polymers include those having a mesogen moiety made of polysiloxane, polyacrylate, polymethacrylate or polymalonate as a main skeleton and a nematic alignment-providing para-substituted cyclic compound units connected thereto via a spacer portion composed of a conjugated atomic group as side chains. These alignment films of liquid crystal polymer are preferably those obtained by spreading a liquid crystal polymer solution over an aligned surface obtained by rubbing the surface of a thin film of polyimide, polyvinyl alcohol or the like formed on a glass sheet or obliquely vacuum depositing silicon oxide, and then subjecting the coat layer to heat treatment so that the liquid crystal polymer is aligned, particularly tilt-aligned.

The low molecular liquid crystal may be a rod-shaped or disc-shaped (discotic) liquid crystal compound.

### (Discotic Liquid Crystal Compound)

Examples of the discotic liquid crystal compound which can be used in the invention include compounds disclosed in various references (C. Destrade et al., “Mol. Crysr. Liq. Cryst.”, vol 71, page 111, 1981; “Quarterly Review of Chemistry”, The Chemical Society of Japan, No. 22, “Ekisho no Kagaku (Chemistry of Liquid Crystals)”, Chapter 5, Section 2 of Chapter 10, 1994; B. Kohne et al., “Angew. Chem. Soc. Chem. Comm.”, page 1794, 1985; J. Zhang et al., “J. Am. Chem. Soc.”, vol. 116, page 2655, 1994).

The optically compensatory layer preferably has discotic liquid crystal molecules fixed aligned therein. Most preferably, these discotic liquid crystal molecules have been fixed by polymerization reaction. Further, in the invention, these discotic liquid crystal molecules preferably have been fixed aligned perpendicular to the surface of the transparent protective film. For the polymerization of discotic liquid crystal molecules, reference can be made to JP-A-8-27284. In order to fix discotic liquid crystal molecules by polymerization, it is necessary that a polymerizable group be connected as a substituent to the disc-shaped core of the discotic liquid crystal molecules. However, when a polymerizable group is connected directly to the disc-shaped core of the discotic liquid crystal molecules, the discotic liquid crystal molecules can be difficultly kept aligned in the polymerization reaction. In order to avoid this trouble, a connecting group is incorporated in between the disc-shaped core and the polymerizable group. For the details of discotic liquid crystal molecules having a polymerizable group, reference can be made to JP-A-2001-4387.

### (Rod-Shaped Liquid Crystal Compound)

Examples of the rod-shaped liquid crystal compound employable herein include azomethines, azoxys, cyanobiphenyls, cyanophenylesters, benzoic acid esters, cyclohexanecarboxylic acid phenyl esters, cyanophenyl cyclophexanes, cyano-substituted phenylpyrimdines, alkoxy-substituted phenylpyrimidines, phenyldioxanes, tolans, and alkenyl cyclohexylbenzonitriles. Not only the aforementioned low molecular liquid crystal compounds but also polymer liquid crystal compounds can be used.

The optically anisotropic layer preferably has rod-shaped liquid crystal molecules fixed aligned therein. Most preferably, these rod-shaped liquid crystal molecules have been fixed by polymerization reaction. Further, in the invention, these rod-shaped liquid crystal molecules preferably have been fixed aligned perpendicular to the surface of the transparent protective film. Examples of the polymerizable rod-shaped liquid crystal compounds employable herein include compounds disclosed in “Makromol. Chem.”, vol. 190, page 2,255, 1989, “Advanced Materials”, vol. 5, page 107, 1993, U.S. Pat. Nos. 4,683,327, 5,622,648 and 5,770,107, WO95/22586, WO95/24455, WO97/00600, WO98/23580, WO98/52905, JP-A-1-272551, JP-A-6-16616, JP-A-7-110469, JP-A-11-80081, and JP-A-2001-328973.

The invention further concerns a polarizing plate comprising the cellulose acylate film incorporated therein as a protective film for polarizer.

### <Polarizing Plate>

A polarizing plate has a polarizer and two sheets of transparent protective film disposed on the respective side thereof. As at least one of the two sheets of protective film there may be used a cellulose acylate film of the invention. As the other protective film there may be used an ordinary cellulose acetate film. Examples of the polarizer employable herein include iodine-based polarizers, dye-based polarizers comprising dichroic dye, and polyene-based polarizers. The iodine-based polarizers and dye-based polarizers are normally produced from a polyvinyl alcohol-based film. In the case where the cellulose acylate film of the invention is used as a protective film for polarizing plate, the method for preparing the polarizing plate is not specifically limited, but the polarizing plate can be prepared by an ordinary method. For example, a method may be employed which comprises subjecting a cellulose acylate film obtained to alkaline treatment, and then sticking the cellulose acylate film thus alkaline-treated with an aqueous solution of a fully-saponified polyvinyl alcohol to the both surfaces of a polarizer prepared by dipping and stretching a polyvinyl alcohol film in an iodine solution. The alkaline treatment may be replaced by an adhesion-providing treatment as disclosed in JP-A-9-94915 and JP-A-6-118232. Examples of the adhesive for use in the sticking of the polarizer to the treated surface of the protective film include polyvinyl alcohol-based adhesives such as polyvinyl alcohol and polyvinyl butyral, and vinyl-based latexes such as butyl acrylate. A polarizing plate has a polarizer and a protective film for protecting the both surfaces thereof. The polarizing plate further has a protect film stuck to one side thereof and a separate film stuck to the other side thereof. The protective film and separate film are used for the purpose of protecting the polarizing plate during the shipment of the polarizing plate, the inspection of the product, etc. In this case, the protective film is stuck to the polarizing plate on the side thereof opposite the side on which the polarizing plate is stuck to the liquid crystal plate for the purpose of protecting the surface of the polarizing plate. The separate film is stuck to the polarizing plate on the side thereof on which the polarizing plate is stuck to the liquid crystal plate for the purpose of covering the adhesive layer to be stuck to the liquid crystal plate.

Referring to the method for sticking the cellulose acylate film of the invention to the polarizer, arrangement is preferably made such that the transmission axis of the polarizer and the slow axis of the cellulose acylate film of the invention coincide with each other. A polarizing plate prepared under polarizing plate crossed nicols was evaluated. As a result, it was found that when the precision in crossing of the slow axis of the cellulose acylate film of the invention with the absorption axis of the polarizer (axis perpendicular to the transmission axis of the polarizer) is greater than 1°, the polarization properties of the polarizing plate under polarizing plate crossed nicols are deteriorated, causing light leakage. This means that when such a polarizing plate is combined with a liquid crystal cell, the resulting liquid crystal display device cannot provide a sufficient black level or contrast. Accordingly, the deviation of the direction of the main refractive index nx of the cellulose acylate film of the invention from the direction of the transmission axis of the polarizing plate is 1° or less, preferably 0.5° or less.

### (Surface Treatment)

The cellulose acylate film of the invention may be optionally subjected to surface treatment to attain the enhancement of the adhesion of the cellulose acylate film to the various functional layers (e.g., undercoat layer and back layer). Examples of the surface treatment employable herein include glow discharge treatment, irradiation with ultraviolet rays, corona treatment, flame treatment, and acid or alkaline treatment. The glow discharge treatment employable herein may involve the use of low temperature plasma developed under a low gas pressure of from 10⁻³ to 20 Torr, even more preferably plasma under the atmospheric pressure. The plasma-excitable gas is a gas which can be excited by plasma under the aforementioned conditions. Examples of such a plasma-excitable gas include argon, helium, neon, krypton, xenon, nitrogen, carbon dioxide, fluorocarbon such as tetrafluoromethane, and mixture thereof. For the details of these plasma-excitable gases, reference can be made to Kokai Giho No. 2001-1745, Mar. 15, 2001, pp. 30-32, Japan Institute of Invention and Innovation. In the plasma treatment under the atmospheric pressure, which has been recently noted, a radiation energy of from 20 to 500 Kgy is used under an electric field of from 10 to 1,000 Kev. Preferably, a radiation energy of from 20 to 300 Kgy is used under an electric field of from 30 to 500 Kev. Particularly preferred among these surface treatments is alkaline saponification, which is extremely effective for the surface treatment of the cellulose acylate film.

The alkaline saponification is preferably carried out by dipping the cellulose acylate film directly in a saponifying solution tank or by spreading a saponifying solution over the cellulose acylate film.

Examples of the coating method employable herein include dip coating method, curtain coating method, extrusion coating method, bar coating method, and E type coating method. As the solvent for the alkaline saponification coating solution there is preferably selected a solvent which exhibits good wetting properties and can keep the surface conditions of the cellulose acylate film good without roughening the surface thereof because the saponifying solution is spread over the cellulose acylate film. In some detail, an alcohol-based solvent is preferably used. An isopropyl alcohol is particularly preferred. Further, an aqueous solution of a surface active agent may be used as a solvent. The alkali of the alkaline saponification coating solution is preferably an alkali soluble in the aforementioned solvent, more preferably KOH or NaOH. The pH value of the saponification coating solution is preferably 10 or more, more preferably 12 or more. During the alkaline saponification, the reaction is preferably effected at room temperature for not smaller than 1 second to not greater than 5 minutes, more preferably not smaller than 5 seconds to not greater than 5 minutes, particularly not smaller than 20 seconds to not greater than 3 minutes. The cellulose acylate film thus alkaline-saponified is preferably washed with water or an acid and then with water on the saponifying solution-coated surface thereof

### <Hard Coat Film, Anti-Glare Film, Anti-Reflection Film>

The cellulose acylate film of the invention can be applied also to hard coat film, anti-glare film and anti-reflection film to advantage. For the purpose of enhancing the viewability of flat panel display for LCD, PDP, CRT, EL, etc., at least one of hard coat layer, anti-glare layer and anti-reflection layer may be provided on one or both sides of the cellulose acylate film of the invention. For preferred embodiments of such an anti-glare film and anti-reflection film, reference can be made to Kokai Giho 2001-1745, Japan Institute of Invention and Innovation, pp. 54-57, Mar. 15, 2001. The cellulose acylate film of the invention can be used in these embodiments to advantage.

As the transparent protective film (also referred to as “transparent support”) in the following description there may be preferably used the cellulose acylate film of the invention.

### <Anti-Reflection Layer>

The transparent protective film disposed on the polarizing plate on the side thereof opposite the liquid crystal cell is preferably provided with a functional layer such as anti-reflection layer. In particular, in the invention, an anti-reflection layer comprising at least a light-scattering layer and a low refractive layer laminated on a transparent protective layer in this order or an anti-reflection layer comprising a middle refractive layer, a high refractive layer and a low refractive layer laminated on a transparent protective layer in this order is preferably used. Preferred examples of such an anti-reflection layer will be given below.

A preferred example of the anti-reflection layer comprising a light-scattering layer and a low refractive layer provided on a transparent protective layer will be described below.

The light-scattering layer according to the invention preferably has a particulate mat dispersed therein. The refractive index of the material of the light-scattering layer other than the particulate mat is preferably from 1.50 to 2.00. The refractive index of the low refractive layer is preferably from 1.35 to 1.49. In the invention, the light-scattering layer has both anti-glare properties and hard coating properties. The light-scattering layer may be formed by a single layer or a plurality of layers such as two to four layers.

The anti-reflection layer is preferably designed in its surface roughness such that the central line average roughness Ra is from 0.08 to 0.40 μm, the ten point averaged roughness Rz is 10 times or less Ra, the average distance between mountain and valley Sm is from 1 to 100 μM, the standard deviation of the height of mountains from the deepest portion in roughness is 0.5 μm or less, the standard deviation of the average distance between mountain and valley Sm with central line as reference is 20 μm or less and the proportion of the surface having an inclination angle of from 0 to 5 degrees is 10% or less, making it possible to attain sufficient anti-glare properties and visually uniform matte finish.

Further, when the tint of reflected light under C light source comprises a* value of −2 to 2 and b* value of −3 to 3 and the ratio of minimum reflectance to maximum reflectance at a wavelength of from 380 nm to 780 nm is from 0.5 to 0.99, the tint of reflected light is neutral to advantage. Moreover, when the b* value of transmitted light under C light source is predetermined to range from 0 to 3, the yellow tint of white display for use in display devices is reduced to advantage.

Further, when a lattice of having a size of 120 μm×40 μm is disposed interposed between the planar light source and the anti-reflection film of the invention so that the standard deviation of brightness distribution measured over the film is 20 or less, glare developed when the film of the invention is applied to a high precision panel can be eliminated to advantage.

When the optical properties of the anti-reflection layer according to the invention are such that the specular reflectance is 2.5% or less, the transmission is 90% or more and the 60° gloss is 70% or less, the reflection of external light can be inhibited, making it possible to enhance the viewability to advantage. In particular, the specular reflectance is more preferably 1% or less, most preferably 0.5% or less. When the haze is from 20% to 50%, the ratio of inner haze to total haze is from 0.3 to 1, the reduction of haze from that up to the light-scattering layer to that developed after the formation of the low refractive layer is 15% or less, the sharpness of transmitted image at an optical comb width of 0.5 mm is from 20% to 50% and the ratio of transmission of vertical transmitted light to transmission of transmitted light in the direction of 2 degrees from the vertical direction is from 1.5 to 5.0, the prevention of glare on a high precision LCD panel and the elimination of blurring of letters, etc. can be attained to advantage.

### <Low Refractive Layer>

The refractive index of the low refractive layer according to the invention is preferably from 1.20 to 1.49, more preferably from 1.30 to 1.44. Further, the low refractive layer preferably satisfies the following numerical formula (XI) to advantage from the standpoint of reduction of reflectance.

(m/4)×0.7<n¹d¹<(m/4)×1.3 (XI)

wherein m represents a positive odd number; n¹ represents the refractive index of the low refractive layer; and d¹ represents the thickness (nm) of the low refractive layer. λ is a wavelength ranging from 500 to 550 nm.

The materials constituting the low refractive layer according to the invention will be described hereinafter.

The low refractive layer according to the invention preferably comprises a fluorine-containing polymer incorporated therein as a low refractive binder. As such a fluorine-based polymer there is preferably used a thermally or ionizing radiation-crosslinkable fluorine-containing polymer having a dynamic friction coefficient of from 0.03 to 0.20, a contact angle of from 90° to 120° with respect to water and a purified water slip angle of 70° or less. As the peel force of the polarizing plate of the invention with respect to a commercially available adhesive tape during the mounting on the image display device decreases, the polarizing plate can be more easily peeled after the sticking of seal or memo to advantage. The peel force of the polarizing plate is preferably 5 N or less, more preferably 3 N or less, most preferably 1 N or less. The higher the surface hardness as measured by a microhardness meter is, the more difficultly can be damaged the low refractive layer. The surface hardness of the low refractive layer is preferably 0.3 GPa or more, more preferably 0.5 GPa or more.

Examples of the fluorine-containing polymer to be used in the low refractive layer include hydrolyzates and dehydration condensates of perfluoroalkyl group-containing silane compounds (e.g., (heptadecafluoro-1,1,2,2-tetrahydrodecyl)triethoxysilane) Other examples of the fluorine-containing polymer include fluorine-containing copolymers comprising a fluorine-containing monomer unit and a constituent unit for providing crosslinking reactivity as constituent components.

Specific examples of the fluorine-containing monomers include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.), and fully or partly fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinking functional group such as glycidyl(meth)acrylate and glycidyl vinyl ether, constituent units obtained by the polymerization of monomers having carboxyl group, hydroxyl group, amino group, sulfo group or the like (e.g., (meth)acrylic acid, methyl (meth)acrylate, hydroxylalkyl(meth)acrylate, allyl acrylate, hydroxyethyl vinyl ether, hydroxybutyl vinyl ether, maleic acid, crotonic acid), and constituent units obtained by introducing a crosslinking reactive group such as (meth)acryloyl group into these constituent units by a polymer reaction (e.g., by reacting acrylic acid chloride with hydroxyl group).

Besides the aforementioned fluorine-containing monomer units and constituent units for providing crosslinking reactivity, monomers free of fluorine atom may be properly copolymerized from the standpoint of solubility in the solvent, transparency of the film, etc. The monomer units which can be used in combination with the aforementioned monomer units are not specifically limited. Examples of these monomer units include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinyl ether, vinyl toluene, α-methyl styrene), vinylethers (e.g., methyl vinyl ether, ethyl vinyl ether, cyclohexyl vinyl ether), vinylesters (e.g., vinyl acetate, vinyl propionate, vinyl cinnarnate), acrylamides N-tert-butyl acrylamide, N-cyclohexyl acrylamide), methacrylamides, and acrylonitrile derivatives.

The aforementioned polymers may be used properly in combination with a hardener as disclosed in JP-A-10-25388 and JP-A-10-147739.

### <Light-Scattering Layer>

The light-scattering layer is normally formed for the purpose of providing the film with light-scattering properties developed by surface scattering and/or inner scattering and hard coating properties for the enhancement of scratch resistance of the film. Accordingly, the light-scattering layer normally comprises a binder for providing hard coating properties, a particulate mat for providing light diffusibility and optionally an inorganic filler for the enhancement of refractive index, the prevention of crosslink shrinkage and the enhancement of strength incorporated therein.

The thickness of the light-scattering layer is from 1 μm to 10 μm, more preferably from 1.2 μm to 6 μm from the standpoint of provision of hard coating properties and inhibition of occurrence of curling and worsening of brittleness.

The binder to be incorporated in the light-scattering layer is preferably a polymer having a saturated hydrocarbon chain or polyether chain as a main chain, more preferably a polymer having a saturated hydrocarbon chain as a main chain. The binder polymer preferably has a crosslinked structure. As the binder polymer having a saturated hydrocarbon chain as a main chain there is preferably used a (co)polymer of monomers having two or more ethylenically unsaturated groups. In order to provide the binder polymer with a higher refractive index, those containing an aromatic ring or at least one atom selected from the group consisting of halogen atoms other than fluorine, sulfur atom, phosphorus atom and nitrogen atom may be selected.

Examples of the monomer having two or more ethylenically unsaturated groups include esters of polyvalent alcohol with (meth)acrylic acid (e.g., ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol penta(meth)acrylate, dipentaerythritol tetra(meth)acrylate, dipentaerythritol penta(meth)acrylate, dipentaerithritol hexa(meth)acrylate, pentaerythritol hexa(meth)acrylate, 1,2,3-cyclohexane tetramethacrylate, polyurethane polyacrylate, polyester polyacrylate), modification products of the aforementioned ethylene oxides, vinylbenzene and derivatives thereof (e.g., 1,4-divinylbenzene, 4-vinyl benzoic acid-2-acryloylethylester, 1,4-divinyl cyclohexanone), vinylsulfones (e.g., divinylsulfone), acrylamides (e.g., methylenebisacrylamide), and methacrylamides. The aforementioned monomers may be used in combination of two or more thereof.

Specific examples of the high refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of the monomers having these ethylenically unsaturated groups can be effected by irradiation with ionizing radiation or heating in the presence of a photo-radical polymerization initiator or heat-radical polymerization initiator.

Accordingly, an anti-reflection layer can be formed by a process which comprises preparing a coating solution containing a monomer having an ethylenically unsaturated group, a photo-polymerization initiator or heat radical polymerization initiator, a particulate mat and an inorganic filler, spreading the coating solution over the protective layer, and then irradiating the coat with ionizing radiation or applying heat to the coat to cause polymerization reaction and curing. As such a photo-polymerization initiator or the like there may be used any compound known as such.

As the polymer having a polyether as a main chain there is preferably used an open-ring polymerization product of polyfunctional epoxy compound. The open-ring polymerization of the polyfunctional epoxy compound can be carried out by the irradiation of the polyfunctional epoxy compound with ionizing radiation or applying heat to the polyfunctional epoxy compound in the presence of a photo-acid generator or heat-acid generator.

Accordingly, the anti-reflection layer can be formed by a process which comprises preparing a coating solution containing a polyfunctional epoxy compound, a photo-acid generator or heat-acid generator, a particulate mat and an inorganic filler, spreading the coating solution over the protective layer, and then irradiating the coat layer with ionizing radiation or applying heat to the coat layer to cause polymerization reaction and curing.

Instead of or in addition to the monomer having two or more ethylenically unsaturated groups, a monomer having a crosslinkable functional group may be used to incorporate a crosslinkable functional group in the polymer so that the crosslinkable functional group is reacted to incorporate a crosslinked structure in the binder polymer.

Examples of the crosslinkable functional group include isocyanate group, epoxy group, aziridin group, oxazoline group, aldehyde group, carbonyl group, hydrazine group, carboxyl group, methylol group, and active methylene group. Vinylsulfonic acids, acid anhydrides, cyanoacrylate derivatives, melamines, etherified methylol, esters, urethane, and metal alkoxides such as tetramethoxysilane, too, may be used as monomers for introducing crosslinked structure. Functional groups which exhibit crosslinkability as a result of decomposition reaction such as block isocyanate group may be used. In other words, in the invention, the crosslinkable functional group may not be reactive as they are but may become reactive as a result of decomposition reaction.

These binder polymers having a crosslinkable functional group may be spread and heated to form a crosslinked structure.

The light-scattering layer comprises a particulate mat incorporated therein having an average particle diameter which is greater than that of filler particles and ranges from 1 to 10 μm, preferably from 1.5 to 7.0 μm, such as inorganic particulate compound and particulate resin for the purpose of providing itself with anti-glare properties.

Specific examples of the aforementioned particulate mat include inorganic particulate compounds such as particulate silica and particulate TiO₂, and particulate resins such as particulate acryl, particulate crosslinked acryl, particulate polystyrene, particulate crosslinked styrene, particulate melamine resin and particulate benzoguanamine resin. Preferred among these particulate resins are particulate crosslinked styrene, particulate crosslinked acryl, particulate crosslinked acryl styrene, and particulate silica. The particulate mat may be either spherical or amorphous.

Two or more particulate mats having different particle diameters may be used in combination. A particulate mat having a greater particle diameter may be used to provide the light-scattering layer with anti-glare properties. A particulate mat having a greater particle diameter may be used to provide the light-scattering layer with other optical properties.

Further, the distribution of the particle diameter of the mat particles is most preferably monodisperse. The particle diameter of the various particles are preferably as close to each other as possible. For example, in the case where a particle having a diameter of 20% or more greater than the average particle diameter is defined as coarse particle, the proportion of these coarse particles is preferably 1% or less, more preferably 0.1% or less, even more preferably 0.01% or less of the total number of particles. A particulate mat having a particle diameter distribution falling within the above defined range can be obtained by properly classifying the mat particles obtained by an ordinary synthesis method. By raising the number of classifying steps or intensifying the degree of classification, a matting agent having a better distribution can be obtained.

The aforementioned particulate mat is incorporated in the light-scattering layer in such a manner that the proportion of the particulate mat in the light-scattering layer is from 10 to 1,000 mg/m², more preferably from 100 to 700 mg/m².

For the measurement of the distribution of particle size of mat particles, a coulter counter method. The particle size distribution thus measured is then converted to distribution of number of particles.

The light-scattering layer preferably comprises an inorganic filler made of an oxide of at least one metal selected from the group consisting of titanium, zirconium, aluminum, indium, zinc, tin and antimony having an average particle diameter of 0.2 μm or less, preferably 0.1 μm or less, more preferably 0.06 μm or less incorporated therein in addition to the aforementioned particulate mat to enhance the refractive index thereof.

In order to enhance the difference of refractive index from the particulate mat, the light-scattering layer comprising a high refractive particulate mat incorporated therein preferably comprises a silicon oxide incorporated therein for keeping the refractive index thereof somewhat low. The preferred particle diameter of the particulate silicon oxide is the same as that of the aforementioned inorganic filler.

Specific examples of the inorganic filler to be incorporated in the light-scattering layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of enhancement of refractive index. The inorganic filler is preferably subjected to silane coupling treatment or titanium coupling treatment on the surface thereof. To this end, a surface treatment having a functional group reactive with the binder seed on the surface thereof is preferably used.

The amount of the inorganic filler to be incorporated is preferably from 10% to 90%, more preferably from 20% to 80%, particularly from 30% to 75% based on the total mass of the light-scattering layer.

Such a filler has a particle diameter which is sufficiently smaller than the wavelength of light and thus causes no scattering. Thus, a dispersion having such a filler dispersed in a binder polymer behaves as an optically uniform material.

The bulk refractive index of the mixture of binder and inorganic filler in the light-scattering layer is preferably from 1.48 to 2.00, more preferably from 1.50 to 1.80. In order to predetermine the bulk refractive index of the mixture within the above defined range, the kind and proportion of the binder and the inorganic filler may be properly selected. How to select these factors can be previously easily known experimentally.

In order to keep the light-scattering layer uniform in surface conditions such as uniformity in coating and drying and prevention of point defects, the coating solution for forming the light-scattering layer preferably comprises either or both of fluorine-based surface active agent and silicone-based surface active agent incorporated therein. In particular, a fluorine-based surface active agent is preferably used because it can be used in a smaller amount to exert an effect of eliminating surface defects such as unevenness in coating and drying and point defects of the anti-reflection film of the invention. Such a fluorine-based surface active agent is intended to render the coating solution adaptable to high speed coating while enhancing the uniformity in surface conditions, thereby raising the productivity.

The anti-reflection layer comprising a middle refractive layer, a high refractive layer and a low refractive layer laminated on a transparent protective layer in this order will be described hereinafter.

The anti-reflection layer comprising a layer structure having at least a middle refractive layer, a high refractive layer and a low refractive layer (outermost layer) laminated on a substrate in this order is designed so as to have a refractive index satisfying the following relationship.

Refractive index of high refractive layer>refractive index of middle refractive layer>refractive index of transparent support>refractive index of low refractive layer

Further, a hard coat layer may be provided interposed between the transparent support and the middle refractive layer. Moreover, the anti-reflection layer may comprise a middle refractive layer, a hard coat layer, a high refractive layer and a low refractive layer laminated on each other (For reference, see JP-A-8-122504, JP-A-8-110401, JP-A-10-300902, JP-A-2002-243906, and JP-A-2000-111706.) Further, the various layers may be provided with other functions. Examples of these layers include stain-proof low refractive layer, and antistatic high refractive layer (as disclosed in JP-A-10-206603, JP-A-2002-243906).

The haze of the anti-reflection layer is preferably 5% or less, more preferably 3% or less. The strength of the anti-reflection layer is preferably not lower than H, more preferably not lower than 2H, most preferably not lower than 3H as determined by pencil hardness test method according to JIS K5400.

### <High Refractive Layer and Middle Refractive Layer>

The layer having a high refractive index in the anti-reflection layer preferably is formed by a hardened layer containing at least a high refractive inorganic particulate compound having an average particle diameter of 100 nm or less and a matrix binder.

As the high refractive inorganic particulate compound there may be used an inorganic compound having a refractive index of 1.65 or more, preferably 1.9 or more. Examples of such a high refractive inorganic particulate compound include oxides of Ti, Zn, Sb, Sn, Zr, Ce, Ta, La and In, and composite oxides of these metal atoms.

In order to provide such a particulate material, the following requirements need to be satisfied. For example, the surface of the particles must be treated with a surface treatment (e.g., silane coupling agent as disclosed in JP-A-11-295503, JP-A-11-153703, and JP-A-2000-9908, anionic compound or organic metal coupling agent as disclosed in JP-A-2001-310432). Further, the particles must have a core-shell structure comprising a high refractive particle as a core (as disclosed in JP-A-2001-166104, JPA-2001-310432). A specific dispersant must be used at the same time (as disclosed in JP-A-11-153703, U.S. Pat. No. 6,210,858B1, JP-A-2002-2776069).

Examples of the matrix-forming materials include known thermoplastic resins, thermosetting resins, etc. Preferred examples of the matrix-forming materials include polyfunctional compound-containing compositions having two or more of at least any of radically polymerizable group and/or cationically polymerizable group, compositions having an organic metal compound containing a hydrolyzable group, and at least one selected from the group consisting of compositions containing a partial condensate thereof. Examples of these materials include compounds as disclosed in JP-A-2000-47004, JP-A-2001-315242, JP-A-2001-31871, and JP-A-2001-296401.

Further, a colloidal metal oxide obtained from a hydrolytic condensate of metal alkoxide and a curable layer obtained from a metal alkoxide composition are preferably used. For the details of these materials, reference can be made to JP-A-2001-293818.

The refractive index of the high refractive layer is preferably from 1.70 to 2.20 The thickness of the high refractive layer is preferably from 5 nm to 10 μm, more preferably from 10 mu to 1 μm.

The refractive index of the middle refractive layer is adjusted so as to fall between the refractive index of the low refractive layer and the high refractive layer. The refractive index of the middle refractive layer is preferably from 1.50 to 1.70. The thickness of the middle refractive layer is preferably from 5 nm to 10 μm, more preferably from 10 nm to 1 μm.

### <Low Refractive Layer>

The low refractive layer is laminated on the high refractive layer. The refractive index of the low refractive layer is preferably from 1.20 to 1.55, more preferably from 1.30 to 1.50.

The low refractive layer is preferably designed as an outermost layer having scratch resistance and stain resistance. In order to drastically raise the scratch resistance of the low refractive layer, a thin layer which can effectively provide surface slipperiness may be formed on the low refractive layer by introducing a known silicone or fluorine thereinto.

The refractive index of the fluorine-containing compound is preferably from 1.35 to 1.50, more preferably from 1.36 to 1.47. As the fluorine-containing compound there is preferably used a compound containing a crosslinkable or polymerizable functional group having fluorine atoms in an amount of from 35 to 80% by mass.

Examples of such a compound include those disclosed in JP-A-9-222503, paragraphs [0018]-[0026], JP-A-11-38202, paragraphs [0019]-[0030], JP-A-2001-40284, paragraphs [0027]-[0028], and JP-A-2000-284102.

As the silicone compound there is preferably used a compound having a polysiloxane structure wherein a curable functional group or polymerizable functional group is incorporated in the polymer chain to form a bridged structure in the film. Examples of such a compound include reactive silicones (e.g., SILAPLANE, produced by CHISSO CORPORATION), and polysiloxanes having silanol group at both ends thereof (as disclosed in JP-A-11-258403).

In order to effect the crosslinking or polymerization reaction of at least any of fluorine-containing polymer and/or siloxane polymer having crosslinkable or polymerizable group, the coating composition for forming the outermost layer containing a polymerization initiator, a sensitizer, etc. is preferably irradiated with light or heated at the same time with or after spreading to form a low refractive layer.

Further, a sol-gel conversion-cured film obtained by curing an organic metal compound such as silane coupling agent and a silane coupling agent containing a specific fluorine-containing hydrocarbon group in the presence of a catalyst is preferably used.

Examples of such a sol-gel cured film include polyfluoroalkyl group-containing silane compounds and partial hydrolytic condensates thereof (compounds as disclosed in JP-A-58-142958, JP-A-58-147483, JP-A-58-147484, JP-A-9-157582, and JP-A-11-106704), and silyl compounds having poly(perfluoroalkylether) group as a fluorine-containing long chain (compounds as disclosed in JP-A-2000-117902, JP-A-2001-48590, JP-A-2002-53804).

The low refractive layer may comprise a filler (e.g., low refractive inorganic compound having a primary average particle diameter of from 1 to 150 nm such as particulate silicon dioxide (silica) and particulate fluorine-containing material (magnesium fluoride, calcium fluoride, barium fluoride), organic particulate material as disclosed in JP-A-11-3820, paragraphs [0020]-[0038]), a silane coupling agent, a lubricant, a surface active agent, etc. incorporated therein as additives other than the aforementioned additives.

In the case where the low refractive layer is disposed under the outermost layer, the low refractive layer may be formed by a gas phase method (vacuum metallizing method, sputtering method, ion plating method, plasma CVD method, etc.). A coating method is desirable because the low refractive layer can be produced at reduced cost.

The thickness of the low refractive layer is preferably from 30 to 200 nm, more preferably from 50 to 150 nm, most preferably from 60 to 120 nm.

Further, a hard coat layer, a front scattering layer, a primer layer, an antistatic layer, an undercoating layer, a protective layer, etc. may be provided.

### <Hard Coat Layer>

The hard coat layer is normally provided on the surface of the protective layer to give a physical strength to the transparent protective layer having an anti-reflection layer provided thereon. In particular, the hard coat layer is preferably provided interposed between the transparent support and the aforementioned high refractive layer. The hard coat layer is preferably formed by the crosslinking reaction or polymerization reaction of a photosetting and/or thermosetting compound. The curable functional group is preferably a photopolymerizable functional group. Further, an organic metal compound or organic alkoxysilyl compound containing a hydrolyzable functional group is desirable.

Specific examples of these compounds include the same compounds as exemplified with reference to the high refractive layer. Specific examples of the composition constituting the hard coat layer include those described in JPA-2002-144913, JP-A-2000-9908, and WO00/46617.

The high refractive layer may act also as a hard coat layer. In this case, particles may be finely dispersed in a hard coat layer in the same manner as described with reference to the high refractive layer to form a high refractive layer.

The hard coat layer may comprise particles having an average particle diameter of from 0.2 to 10 μm incorporated therein to act also as an anti-glare layer provided with anti-glare properties.

The thickness of the hard coat layer may be properly designed depending on the purpose. The thickness of the hard coat layer is preferably from 0.2 to 10 μm, more preferably from 0.5 to 7 μm.

The strength of the hard coat layer is preferably not lower than H, more preferably not lower than 2H, most preferably not lower than 3H as determined by pencil hardness test according to JIS K5400. The abrasion of the test specimen is preferably as little as possible when subjected to taper test according to JIS K5400.

### <Anti-Static Layer>

The antistatic layer, if provided, is preferably given an electrical conductivity of 10⁻⁸ (Ωcm⁻³) or less as calculated in terms of volume resistivity. The use of a hygroscopic material, a water-soluble inorganic salt, a certain kind of a surface active agent, a cation polymer, an anion polymer, colloidal silica, etc. makes it possible to provide a volume resistivity of 10⁻⁸ (Ω·cm⁻³). However, these materials have a great dependence on temperature and humidity and thus cannot provide a sufficient electrical conductivity at low humidity. Therefore, as the electrically conductive layer material there is preferably used a metal oxide. Some metal oxides have a color. The use of colorless material among these metal oxides as an electrically conductive layer material makes it possible to inhibit the coloration of the entire film to advantage. Examples of metal that forms a colorless metal oxide include Zn, Ti, Al, In, Si, Mg, Ba, Mo, W, and V. Metal oxides mainly composed of these metals are preferably used. Specific examples of these metal oxides include ZnO, TiO₂, SnO₂, Al₂O₃, In₂O₃, SiO₂, MgO, BaO, MoO₃, V₂O₅, and composites thereof. Particularly preferred among these metal oxides are ZnO, TiO₂, and SnO₂. Referring to the incorporation of different kinds of atoms, Al, In, etc. are effectively added to ZnO. Sb, Nb, halogen atoms, etc. are effectively added to SnO₂. Nb, Ta, etc. are effectively added to TiO₂. Further, as disclosed in JP-B-59-6235, materials comprising the aforementioned metal oxide attached to other crystalline metal particles or fibrous materials (e.g., titanium oxide) may be used. Volume resistivity and surface resistivity are different physical values and thus cannot be simply compared with each other. However, in order to provide an electrical conductivity of 10⁻⁸ (Ωcm⁻³) or less as calculated in terms of volume resistivity, it suffices if the electrically conductive layer has an electrical conductivity of 10⁻¹⁰ (Ω/□) or less, more preferably 10⁻⁸ (Ω/□), as calculated in terms of surface resistivity. It is necessary that the surface resistivity of the electrically conductive layer be measured when the antistatic layer is provided as an outermost layer. The measurement of surface resistivity can be effected at a step in the course of the formation of laminated film described herein.

### <Liquid Crystal Display Device)

The cellulose acylate film of the invention may be used in various display mode liquid crystal cells. There have been proposed various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), ECB (Electrically Controlled Birefringence), and HAN (Hybrid Alignment Nematic). There has also been proposed display modes obtained by domain division. The cellulose acylate film of the invention is effective for liquid crystal display devices of any display mode. The cellulose acylate film of the invention is effective also for any of transmission type, reflection type and semi-transmission type liquid crystal display devices.

### (TN Type Liquid Crystal Display Device)

The cellulose acylate film of the invention may be used as support for optically compensatory sheet or protective film for polarizing plate of TN type liquid crystal display device comprising a TN mode liquid crystal cell. TN mode liquid crystal cells and TN type liquid crystal display devices have long been known. For the details of optically compensatory sheet to be used in TN type liquid crystal display devices, reference can be made to JP-A-3-9325, JP-A-6-148429, JP-A-8-50206, and JP-A-9-26572. Reference can be made also to Mori et al, “Jpn. J. Appl. Phys.”, Vol, 36 (1997), p. 143, and “Jpn. J. Appl, Phys.”, Vol. 36 (1997), p. 1,068.

### (Stn Type Liquid Crystal Display Device)

The cellulose acylate film of the invention may be used as a support for optically compensatory sheet or protective film for polarizing plate of STN type liquid crystal display device having an STN mode liquid crystal cell. In general, in an STN type liquid crystal display device, rod-shaped liquid crystal molecules in the liquid crystal cell are twisted at an angle of from 90° to 360° and the product (And) of the refractive anisotropy (Δn) of the rod-shaped liquid crystal molecules and the cell gap (d) is from 300 nm to 1,500 nm. For the optically compensatory sheet to be incorporated in STN type liquid crystal display device, reference can be made to JP-A-2000-105316.

### (VA Type Liquid Crystal Display Device)

The cellulose acylate film of the invention may be used as a support for optically compensatory sheet of VA type liquid crystal display device having a VA mode liquid crystal cell to advantage in particular. The cellulose acylate film of the invention may be used also as a protective film for polarizing plate. Re retardation value and Rth retardation value of the optically compensatory sheet to be incorporated in VA type liquid crystal display device are preferably from 0 nm to 150 nm and from 70 nm to 400 nm, respectively. Re retardation value of the optically compensatory sheet is more preferably from 20 nm to 70 nm. In the case where the VA type liquid crystal display device comprises two sheets of optically anisotropic polymer film incorporated therein, Rth retardation value of the optically anisotropic polymer film is preferably from 70 nm to 250 nm. In the case where the VA type liquid crystal display device comprises one sheet of optically anisotropic polymer film incorporated therein, Rth retardation value of the optically anisotropic polymer film is preferably from 150 nm to 400 nm. The VA type liquid crystal display device may be of a domain division type as disclosed in JP-A-10-123576.

### (IPS Type Liquid Crystal Display Device and ECB Type Liquid Crystal Display Device)

The cellulose acylate film of the invention can be used as a support for optically compensatory sheet or polarizing plate protective film of IPS type and ECB type liquid crystal display devices having an IPS mode and ECB mode liquid crystal cells to great advantage. In these modes, the liquid crystal molecules are aligned substantially parallel to the surface of the substrate during black display. When no voltage is applied to the liquid crystal, the liquid crystal molecules are aligned parallel to the surface of the substrate to make black display. In these embodiments, the polarizing plate comprising the cellulose acylate film of the invention contributes to the enhancement of viewing angle and the improvement of contrast. In this embodiment, a polarizing plate comprising a cellulose acylate film of the invention as the protective film disposed interposed between the liquid crystal cell and the polarizing plate (protective film on the cell side) among the protective film for the polarizing plate disposed on the upper and lower side of the liquid crystal cell is preferably used at least on one side. More preferably, an optically anisotropic layer is disposed interposed between the protective film for polarizing plate and the liquid crystal cell such that the retardation value of the optically anisotropic layer is preferably predetermined to twice or less Δn·d of the liquid crystal layer.

### (OCB Type Liquid Crystal Display Device and HAN Type Liquid Crystal Display Device)

The cellulose acylate film of the invention may be used also as a support for optically compensatory sheet or protective film for polarizing plate of OCB type liquid crystal display device having an OCB mode liquid crystal cell or HAN type liquid crystal display device having an HAN mode liquid crystal cell to advantage. The optically compensatory sheet to be incorporated in OCB type liquid crystal display device or HAN type liquid crystal display device preferably has no direction in which the absolute retardation value is minimum regardless of which it is in the plane of the optically compensatory sheet or normal to the optically compensatory sheet. The optical properties of the optically compensatory sheet to be incorporated in OCB type liquid crystal display device or HAN type liquid crystal display device are determined by the optical properties of the optically anisotropic layer, the optical properties of the support and the arrangement of the optically anisotropic layer and the support with respect to each other. For the details of the optically compensatory sheet to be incorporated in OCB type liquid crystal display device or HAN type liquid crystal display device, reference can be made to JP-A-9-197397. Reference can be made also to Mori et al, “Jpn. J. Appl. Phys.”, Vol. 38 (1999), p. 2,837.

### (Reflection Type Liquid Crystal Display Device)

The cellulose acylate film of the invention can be used as a support or protective film of polarizing plate of an optically compensatory sheet for TN type, STN type, HAN type or GH (Guest-Host) type reflective liquid crystal display device. These display modes have long been known. For the details of TN type reflective liquid crystal display device, reference can be made to JP-A-10-123478, WO9848320 and Japanese Patent No. 3,022,477. For the details of the optically compensatory sheet to be incorporated in reflective liquid crystal display device, reference can be made to WO00-65384,

### (Other Liquid Crystal Display Devices)

The cellulose acylate film of the invention can be used also as a support or protective film for polarizing plate of optically compensatory sheet of ASM type liquid crystal display device having an ASM (Axially Symmetric Aligned Microcell) mode liquid crystal cell to advantage. An ASM mode liquid crystal cell is characterized in that the thickness of the cell is maintained by a positionable resin spacer. Other properties of ASM mode liquid crystal cell are the same as that of TN mode liquid crystal cell. For the details of ASM mode liquid crystal cell and ASM mode liquid crystal display device, reference can be made to Kume et al., “SID98 Digest”, 1089, 1998.

### EXAMPLE

The invention will be further described in the following examples, but the invention is not limited thereto.

### Example 1

### Preparation of Cellulose Acylate Films (F1 to F14)

### <Preparation of Cellulose Acylate Film>

[Preparation of Cotton Material from which Cellulose Acylate is Made]

Cellulose acylates having different acyl substitution degrees set forth in Table 1 below were prepared. These cellulose acylates were each then allowed to undergo acylation reaction with a carboxylic acid in the presence of sulfuric aid (7.8 parts by mass based on 100 parts by mass of cellulose) as a catalyst at 40° C. Thereafter, the amount of the sulfuric acid as a catalyst, the water content and the ripening time were adjusted to adjust the total substitution degree. The ripening temperature was 40° C. These cellulose acylates were each then washed with acetone to remove its low molecular components. In the following description, these materials will be generically referred to as “cotton material”.

### [Preparation of Cellulose Acylate Stock Solution (CAL-1)]

The following components were charged into a mixing tank where they were then dissolved with stirring to prepare a cellulose acylate stock solution.

Cellulose acylate solution (CAL-1)

| | |
|---|---|
| Cellulose acylate set forth in Table 1 | 100.0 parts by mass |
| Methylene chloride | 402.0 parts by mass |
| Methanol | 60.0 parts by mass |

### [Preparation of Matting Agent Dispersion (ML-1)]

20 parts by mass of a particulate silica having an average particle diameter of 16 nm {“AEROSIL R972”, produced by NIPPON AEROSIL CO., LTD.} and 80 parts by mass of methanol were thoroughly stirred for 30 minutes to prepare a particulate silica dispersion. The dispersion thus prepared was charged with the following components into a dispersing machine where they were then dissolved with stirring for 30 minutes or more to prepare a matting agent dispersion (ML-1).

Matting agent dispersion (ML-1)

| | |
|---|---|
| Dispersion of particulate silica | 10.0 parts by mass |
| (average particle diameter: 16 nm) | |
| Methylene chloride (first solvent) | 76.3 parts by mass |
| Methanol (second solvent) | 3.4 parts by mass |
| Cellulose acylate stock solution | 10.3 parts by mass |

### [Preparation of Additive Solution (AD-1)]

The following components were charged into a mixing tank where they were then heated and dissolved with stirring to prepare an additive solution (AD-1).

Formulation of additive solution (AD-1)

| | |
|---|---|
| Rth decreasing agent (Compound 119 | 49.3 parts by mass |
| exemplified herein) | |
| Wavelength dispersion adjustor (UV-102 | 7.6 parts by mass |
| exemplified herein) | |
| Methylene chloride (first solvent) | 58.4 parts by mass |
| Methanol (second solvent) | 8.7 parts by mass |
| Cellulose acylate stock solution | 12.8 parts by mass |

100 parts by mass of the aforementioned cellulose acylate stock solution, 1.35 parts by mass of the aforementioned matting agent solution (ML-1) and the additive solution (AD-1) were mixed at a ratio set forth in Table 1 below to prepare dopes for Films F1 to F8.

### [Preparation of Cellulose Acylate Stock Solution (CAL-2)]

The following components were charged into a mixing tank where they were then dissolved with stirring to prepare a cellulose acylate stock solution (CAL-2).

Cellulose acylate solution (CAL-2)

| | |
|---|---|
| Cellulose acylate set forth in Table 1 | 100.0 parts by mass |
| Triphenyl phosphate | 7.9 parts by mass |
| Biphenyl diphenyl phosphate | 3.9 parts by mass |
| Methylene chloride | 402.0 parts by mass |
| Methanol | 60.0 parts by mass |

100 parts by mass of the aforementioned cellulose acylate stock solution and 1.35 parts by mass of the matting agent solution (ML-1) were mixed to prepare dopes for Films F9 to F12.

### [Preparation of Cellulose Acylate Stock Solution (CAL-3)]

The cellulose acylate set forth in Table 1 was processed in the same manner as the cellulose acylate stock solution (CAL-1) to prepare a cellulose acylate stock solution (CAL-3) 100 parts by mass of the aforementioned cellulose acylate stock solution (CAL-3), 1.35 parts by mass of the aforementioned matting agent solution (ML-1) and the additive solution (AD-1) which had been prepared in the same manner as described above were mixed at a ratio set forth in Table 1 below to prepare dopes for Films F13 and F14.

### <Flow Casting>

### [Ejection/Preceding Addition/Flow Casting/Bead Pressure Reduction]

Using a film production line 20 shown in FIG. 1, a film 82 was produced. A dope 22 in a stock tank 21 was transferred into a filtering device 30 by a high precision gear pump 62. The gear pump 62 is capable of boosting the pump 62 at the primary side thereof. The pumping of the dope was conducted with feedback control over the upstream side of the gear pump 62 by an inverter motor such that the pressure at the primary side reached 0.8 MPa. As the gear pump 62 there was used one having a volume efficiency of 99.2% and a percent ejection variation of 0.5% or less. The ejection pressure was 1.5 MPa. The dope 22 which had passed through the filtering device 30 was then transferred into a casting die 31.

The casting die 31 had a width of 1.8 m. Using this casting die 31, the dope 22 was then flow-casted while the flow rate thereof was being adjusted at the ejection portion of the casting die 31 such that the dried film 82 had a thickness of 80 μm. The viscosity of the dope 22 during this procedure was 20 Pa·s. The flow casting width of the dope 22 from the ejection portion of the casting die 31 was 1,700 mm. The flow casting speed was 20 m/min. In order to adjust the temperature of the dope 22 to 36° C., the casting die 31 was provided with a jacket (not shown) so that the inlet temperature of the heat transfer medium supplied into the jacket was 36° C.

The casting die 31 and all the pipings were kept at 36° C. during film formation. As the casting die 31 there was used a coat hunger type die. The casting die 31 had thickness adjusting bolts provided therein at a pitch of 20 mm and was provided with an automatic thickness adjusting mechanism using a heat bolt. This heat bolt is also capable of setting profile depending on the amount of solution to be transferred through the gear pump 62 by a predetermined program. As the heat bolt there was used one capable of making feedback control by an adjustment program based on the profile of an infrared thickness gauge (not shown) installed on the film production line 20. The adjustment was made such that in the film from which a 20 mm edge had been removed, the difference in thickness between two arbitrary points which are 50 mm apart from each other was 1 μm or less and the crosswise dispersion of thickness was 3 μm/m or less. The total thickness was adjusted to ±1.5% or less.

Installed at the primary side of the casting die 31 was a pressure reducing chamber 68 for reducing the pressure in this portion. The degree of pressure reduction by the pressure reducing chamber 68 was adjusted such that a pressure difference of from 1 Pa to 5,000 Pa was made between before and after the casting bead. This adjustment was made according to the casting speed. During this procedure, the pressure difference between the both sides of the casting bead was predetermined such that the length of the casting bead was from 20 mm to 50 min. As the pressure reducing chamber 68 there was used one equipped with a mechanism capable of predetermining the temperature thereof higher than the condensing temperature of gas around the casting portion. A labyrinth seal 50 (shown in FIG. 2) was provided in front of the bead at the die ejection port. An opening was provided at the both ends of the die ejection portion of the casting die. To the casting die 31 was attached an edge suction device (not shown) for adjusting the disturbance at the both edges of the casting bead.

### [Casting Die]

As the material of the casting die 31 there was used a precipitation hardening stainless steel having an expansion coefficient of 2×10⁻⁵ (° C.⁻¹) or less. This stainless steel had almost the same corrosion resistance as that of SUS316 as determined by a forced corrosion test in an electrolytic aqueous solution. This stainless steel was also so corrosion-resistant that it showed no pitting (porosity) on the gas-liquid interface even after 3 months of dipping in a mixture of dichloromethane, methanol and water. The finished precision of the casting die 31 on the surface in contact with liquid was 1 μm or less as calculated in terms of surface roughness. The straightness of the casting die 31 was 1 μm/m or less in all directions. The clearance of slit was adjusted to 1.5 mm. Referring to the corner portion of the forward end of the lip of the casting die 31, working was made such that R was 50 μm or less over the entire width of slit. The shearing speed of the dope 22 in the casting die 31 was from 1 (1/sec) to 5,000 (1/sec). The forward end of the lip of the casting die 31 was coated with WC (tungsten carbite) by a spray coating method.

In order to prevent the local drying and solidification of the dope 22 which is discharged out of the ejection portion of the casting die 31, a mixed solvent A for solubilizing the dope 22 was supplied into the interface of the both edges of the casting bead with the ejection port each at a rate of 0.5 ml/min. The percent pulsation of the pump for supplying the mixed solvent was 5% or less. Using the pressure reducing chamber 68, the pressure on the rear side of the casting bead was predetermined 150 Pa lower than that on the front side of the casting bead. In order to keep the internal temperature of the pressure reducing chamber 68 at a constant value, a jacket (not shown) was attached. Supplied into the jacket was a heat transfer medium which had been adjusted to 35° C. The aforementioned edge suction device is capable of adjusting the edge suction air flow rate to a range of from 1 L/min to 100 L/min. In the present example, the edge suction device was properly adjusted such that the edge suction air flow rate was from 30 L/min to 40 L/min.

### [Metallic Support]

Referring to the support, a stainless steel endless band having a width of 2.1 m and a length of 70 m was used as a casting band 34. The casting band 34 was polished such that the thickness and surface roughness thereof reached 1.5 mm and 0.05 μm or less, respectively. The material of the casting band 34 was SUS316. A stainless steel having a sufficient corrosion resistance and strength was used. The entire thickness unevenness of the casting band 34 was 0.5% or less. The casting band 34 was driven by two revolving rollers 32, 33. During this procedure, the tension of the casting band 34 in the conveying direction was adjusted to 1.5×10⁵ N/m². Adjustment was also made such that the relative difference in speed between the casting band 34 and the revolving rollers 32, 33 reached 0.01 m/min or less. During this procedure, the variation of speed of the casting band 34 was adjusted to 0.5% or less. The position of the both ends of the casting band 34 was detected and controlled such that the crosswise meandering in one rotation was limited to 1.5 mm or less. The vertical positional variation of the forward end of the die lip directly under the casting die 31 relative to the casting band 34 was adjusted to 200 μm or less. The casting band 34 was installed in a casting chamber 64 having a wind pressure variation controlling unit (not shown). The dope 22 was flow-casted from the casting die 31 over the casting band 34.

As each of the revolving rollers 32, 33 there was used one capable of being supplied with a heat transfer medium so that the temperature of the casting band 34 can be adjusted. The revolving roller 33, which was disposed on the casting die 34 side, was supplied with a 5° C. heat transfer medium. The other revolving roller 32 was supplied with a 40° C. heat transfer medium for drying. The surface temperature of the central portion of the casting band 34 shortly before flow casting was 15° C. The temperature difference between the both sides of the central portion was 6° C. or less. The casting band 34 is preferably free of surface defects. In some detail, a casting band having no pinholes having a size of 30 μm or more, pinholes having a size of from 10 μm to 30 μm in a number of 1 or less per m² and pinholes having a size of less than 10 μm in a number of 2 or less per m² was used.

### [Flow Casting/Drying]

The temperature in the casting chamber 64 was kept at 35° C. by a temperature adjusting device 65. The dope 22 was casted over the casting band 34 to form a cast film 69. A rapid drying air blowing port 73 was provided. A drying air 57 was blown against the surface of the cast film 69 to form an initial film 69a. During this procedure, the passing time in the spontaneous wind region A and the wind velocity and temperature of the drying air 57 were adjusted as set forth in Table 1. The velocity of the spontaneous wind and the gas concentration of the drying air 57 were adjusted to 0.2 m/s and 16%, respectively. The cast film 69 at the rapid drying air port 73 showed a drying rate of 7% by mass/s as calculated in terms of dried amount.

A 135° C. drying air was blown from the blowing port 70 disposed upstream of the casting band 34 above the casting band 34. A 140° C. drying air was blown from the blowing port 71 disposed downstream of the casting band 34. A 65° C. drying air was blown from the blowing port 72 disposed under the casting band 34. The saturated temperature of each of these drying airs was close to −8° C. The oxygen concentration in the drying atmosphere over the casting band 34 was kept at 5 vol-%. The air was replaced by nitrogen gas to keep the oxygen concentration at 5 vol-%. In order to condense and recover the solvent in the casting chamber 64, a condenser 66 was provided. The outlet temperature of the condenser 66 was predetermined at −10° C.

A labyrinth seal 50 was used to suppress the static pressure variation in the vicinity of the casting die 31 to ±1 Pa or less. When the proportion of solvent in the cast film 69 reached 50% by mass as calculated in terms of dried amount, the cast film was then peeled off the casting band 34 as a wet film 74 while being supported by a peeling roller 75. The percent solvent content as calculated in terms of dried amount is a value calculated by the equation {(x−y)/y}×100 supposing that the mss of the film sampled is x and the dried mass of the film thus sampled is y. The peeling tension was 1×10² N/m². In order to suppress malpeeling, the peeling speed relative to the rotary speed of the casting band 34 (peeling roller draw) was properly adjusted to a range of from 100.1% to 110%. The surface temperature of the wet film 74 thus peeled was 15° C. The solvent gas generated by drying was condensed and liquefied in a−10° C. condenser 66 from it was then recovered by a recovering device 67. The solvent thus recovered was adjusted such that the water content reached 0.5% or less. The drying air thus freed of solvent was then reheated and reused as drying air. The wet film 74 was conveyed to a tenter drying machine 35 over rollers in a transportation portion 80. In the transportation portion 80, drying air at 40° C. was blown from the blower 81 to the wet film 74. While being conveyed over the rollers in the transportation portion 80, the wet film 74 was given a tension of about 30 N.

### [Tenter Conveyance/Drying/Trimming]

The wet film 74 which had been transferred to a tenter drying machine 35 was conveyed through the drying zone in the tenter drying machine 35 while being clipped at both edges thereof by a clip. During this procedure, the film was dried with drying air. The clip was cooled by supplying a 20° C. heat transfer medium. The clip was conveyed by a chain. The variation of speed of the sprocket was 0.5% or less. The tenter drying machine 35 was divided into three zones. The temperature of drying air flowing in these zones were 90° C., 110° C. and 120° C., respectively, in the downstream order. The gas composition of the drying air was based on the saturated gas concentration at −10° C. The average drying speed in the tenter drying machine 35 was 120% by mass/min as calculated in terms of dried amount. The conditions of the drying zones were adjusted such that the residual solvent content in the film 82 at the outlet of the tenter drying machine 35 reached 7% by mass.

The ratio of the distance between the clipping starting position and the declipping position to the length from the inlet to the outlet of the tenter drying machine 35 was adjusted to 90%. The solvent which had been evaporated in the tenter drying machine 35 was condensed and liquefied at a temperature of −10° C. and then recovered. A condenser was provided for condensation and recovery. The outlet temperature of the condenser was predetermined to −8° C. The solvent thus condensed was then adjusted to a water content of 0.5% by mass or less before being reused. A film 82 was then discharged out of the tenter drying machine 35.

The film 82 was then trimmed at the both edges thereof by a trimming device 40 within 30 seconds after the outlet of the tenter drying machine 35. Using an NT type cutter, the film 82 was trimmed by 50 mm at the both edges thereof. The portion thus trimmed was then blown by a cutter blower (not shown) into a crusher 90 where it was then crushed to chips having a size of about 80 mm² on the average. These chips were reused with cellulose acylate flakes as raw material of dope. The oxygen concentration in the drying atmosphere in the tenter drying machine 35 was kept at 5 vol-%. In order to keep the oxygen concentration at 5 vol-%, the air was replaced by nitrogen gas. Prior to being dried at high temperature in a drying chamber 41 described later, the film 82 was pre-dried in a predrying chamber (not shown) into which a 100° C. drying air was being supplied.

### [Post-Drying/Destaticization]

The film 82 was dried at high temperature in the drying chamber 41. The drying chamber 41 was divided into four compartments. Drying airs of 120° C., 130° C., 130° C. and 130° C. were supplied into these compartments, respectively, by a blower (not shown). With the conveyance tension of the film 82 by the roller 91 set at 100 N/m, the film 82 was dried for about 10 minutes until the final residual solvent content reached 0.3% by mass. The lapping angle (central angle of lapping of the film) of the roller 91 was 90 degrees or 180 degrees. The material of the roller 91 was aluminum or carbon steel. The surface of the roller 91 was plated with hard chromium. The surface of the roller 91 was flat or matted by blasting. The deflection of the position of the film by the rotation of the rollers 91 were all 50 μm or less. The deflection of the roller at a tension of 100 N/m was predetermined to 0.5 mm or less.

The solvent gas contained in the drying air was adsorbed and recovered away by an adsorption recovering device 92. The adsorbent used at this step was activated charcoal. Adsorption was effected with dried nitrogen. The solvent thus recovered was adjusted to a water content of 0.3% by mass or less, and then reused as a solvent for the preparation of dope. The drying air contains plasticizer, UV absorbent and other high boiling materials besides the solvent gas. Therefore, these components were removed in a cooling device and a preadsorber for cooling and removal, regenerated, and then recycled. The desorption conditions were predetermined such that VOC (volatile organic compound) in the outdoor discharge gas finally reached 10 ppm or less. The proportion of the solvent recovered by condensation method in the total amount of solvents evaporated was 90% by mass. Most of the remaining solvent was recovered by adsorption.

The film 82 thus dried was then conveyed into a first moisture conditioning chamber (not shown). A 110° C. drying air was supplied into the transportation portion between the drying chamber 41 and the first moisture conditioning chamber. Air having a temperature of 50° C. and a dew point of 20° C. was supplied into the first moisture conditioning chamber. Subsequently, the film 82 was conveyed into a second moisture conditioning chamber (not shown) for inhibiting the occurrence of curling of the film 82. In the second moisture conditioning chamber, air having a temperature of 90° C. and a humidity of 70% was brought into direct contact with the film 82.

### [Knurling, Winding Conditions]

The film 82 thus moisture-conditioned was cooled to 30° C. or less at a cooling chamber 42, and then again trimmed by a trimming device (not shown). A forced destaticizing device (destaticization bar) 93 was installed to keep the charged voltage of the film 82 during transportation to a range of −3 kV to +3 kV. The film 82 was further knurled at both edges thereof by a knurling roller 94. Knurling was carried out by embossing the film 82 on one side thereof. The knurling width was 10 mm. The pressure of the knurling roller 94 was predetermined such that the height of the surface roughness was 12 μm higher than the average thickness of the film 82 on the average.

Subsequently, the film 82 was conveyed into the winding chamber 43. The winding chamber 43 was kept at an inner temperature of 28° C. and a humidity of 70%. Installed in the winding chamber 43 was an ionized air destaticizer (not shown) such that the charged voltage of the film 82 was from −1.5 kV to +1.5 kV. The product of the film (thickness: 80 μm) 82 thus obtained had a width of 1,475 mm. As the winding roller 95 there was used one having a diameter of 169 mm. The tension pattern was such that the tension at the starting of winding was 300 N/m and the tension at the end of winding was 200 N/m. The total length of winding was 3,940 m. The width of variation of deviation during winding (also referred to as “oscillate width”) was predetermined to ±5 mm. The period of winding deviation relative to the winding roller 95 was predetermined to 400 m. The pressure of the press roller 96 against the winding roller 95 was predetermined to 50 N/m. During winding, the film 82 had a temperature of 25° C., a water content of 1.4% by mass and a residual solvent content of 0.3% by mass. The film 82 showed an average drying speed of 20% by mass/min as calculated in terms of dried amount through all the steps. Neither loose winding nor wrinkling occurred. No deviation of winding occurred even at a 10G impact test. The external appearance of the roll was good.

The rolled film 82 was stored in a 25° C.-55% RH storage rack for 1 month. The rolled film 82 was then examined in the same manner as mentioned above. No significant changes were recognized. No adhesion was observed in the roll. After the preparation of the film 82, the cast film 69 formed by the dope was not shown left unpeeled off the casting band 34.

The cellulose acylate film thus prepared was cut parallel to the side of the film to prepare measurement samples at seven crosswise positions. Using KOBRA 21ADH (produced by Ouji Scientific Instruments Co., Ltd.), these samples were each measured for retardation at a wavelength of 590 nm. These samples were each measured for retardation in the direction of 40° and −40° from the line normal to the surface of the film. These measurements were then used to calculate Rth. The measurements at seven positions were then averaged to obtain Re₍₅₉₀₎ and Rth₍₅₉₀₎ of the film. The results obtained in this experiment are set forth in Table 1.

TABLE 1

| | | | | | | Passing | | | | | | | | |
|---|---|---|---|---|---|---|---|---|---|---|---|---|---|---|
| | | | | | | time | | | | | | | | |
| | | | | Optical | Wave- | through | Rapid | | | | | | | |
| | Cellulose | Acetyl | | anisottropy | length | spontaneous | drying | Rapid | | | | | | |
| | acylate | substi- | Propionyl | decreasing | dispersion | wind | air | drying | Thick- | | | \|Re − | \|Rth − | P-V |
| Film | stock | tution | substitution | agent | adjustor | region | velocity | air temp | ness | Re | Rth | Re\|*1 | Rth\|*2 | value |
| No. | solution | degree | degree | (mass %) | (mass %) | (sec) | (m/s) | (° C.) | (μm) | (nm) | (nm) | (nm) | (nm) | (μm) |
| F1 | CAL-1 | 2.94 | — | 12 | 1.8 | 5 | 8 | 100 | 80 | 1 | −8 | 1 | 11 | 0.4 |
| F2 | CAL-1 | 2.94 | — | 12 | 1.8 | 5 | 12 | 100 | 80 | 1 | −13 | 0 | 8 | 0.8 |
| F3 | CAL-1 | 2.94 | — | 12 | 1.8 | 15 | 8 | 100 | 80 | 0 | −4 | 2 | 10 | 1.0 |
| F4 | CAL-1 | 2.94 | — | 12 | 1.8 | 5 | 8 | 60 | 80 | 0 | −6 | 1 | 10 | 0.7 |
| F5 | CAL-1 | 2.94 | — | 12 | 1.8 | 5 | 8 | 25 | 80 | 1 | −3 | 1 | 11 | 1.0 |
| F6 | CAL-1 | 2.94 | — | 12 | 1.8 | 5 | 3 | 100 | 80 | 1 | −7 | 2 | 9 | 0.6 |
| F7 | CAL-1 | 2.94 | — | 12 | 1.8 | 5 | 20 | 100 | 80 | 2 | −14 | 0 | 10 | 1.1 |
| F8 | CAL-1 | 2.94 | — | 12 | 1.8 | 20 | 3 | 25 | 80 | 1 | −2 | 2 | 12 | 1.3 |
| F9 | CAL-2 | 2.86 | — | None | None | 5 | 8 | 100 | 80 | 0 | 37 | 12 | 33 | 0.4 |
| F10 | CAL-2 | 2.86 | — | None | None | 5 | 8 | 25 | 80 | 2 | 45 | 11 | 35 | 1.0 |
| F11 | CAL-2 | 2.86 | — | None | None | 5 | 3 | 100 | 80 | 0 | 41 | 12 | 34 | 0.5 |
| F12 | CAL-2 | 2.86 | — | None | None | 20 | 3 | 25 | 80 | 2 | 49 | 15 | 39 | 1.2 |
| F13 | CAL-3 | 2.08 | 0.79 | 12 | 1.8 | 5 | 8 | 100 | 80 | 0 | 20 | 6 | 23 | 0.4 |
| F14 | CAL-3 | 2.08 | 0.79 | 12 | 1.8 | 20 | 8 | 25 | 80 | 3 | 24 | 7 | 72 | 1.1 |

*1|Re(400) − Re(700)|
*2|Rth(400) − Rth(700)|

### Example 2

### Preparation of Optically Compensatory Film Having Optically Anisotropic Layer

### Example 2-1

### Preparation of Optically Compensatory Films (F15 to F28) Having Optically Anisotropic Layer

### (Saponification)

The films (F1 to F14) prepared in Example 1 were each passed over a 60° C. induction type heated roll so that the surface thereof was heated to 40° C., coated with an alkaline solution having the following formulation at a rate of 14 ml/m² using a bar coater, retained under a steam type infrared heater heated to 110° C. (produced by Noritake Co., Limited) for 10 seconds, and then coated with purified water at a rate of 3 ml/m² using a bar coater. At this point, the temperature of the film was 40° C. Subsequently, the films were each rinsed by a curtain coater and dehydrated by an air knife three times, and then retained in a 70° C. drying zone for 2 seconds so that it was dried.

<Formulation of alkaline solution>

| | |
|---|---|
| Potassium hydroxide | 4.7 parts by mass |
| Water | 15.7 parts by mass |
| Isopropanol | 64.8 parts by mass |
| Propylene glycol | 14.9 parts by mass |
| C₁₆H₃₃O(CH₂CH₂O)₁₀H (surface active agent) | 1.0 parts by mass |

### (Formation of Alignment Film)

Using a #14 wire bar coater, a coating solution having the following formulation was spread over the cellulose acylate film thus prepared in an amount of 24 ml/m². The coated cellulose acylate film was dried with 60° C. hot air for 60 seconds and then with 90° C. hot air for 150 seconds. Subsequently, the cellulose acylate film was subjected to rubbing in the direction of clockwise 180° with the longitudinal direction (conveying direction) of the cellulose acylate film as 0°.

<Formulation of alignment film coating solution>

| | | |
|---|---|---|
| Modified polyvinyl alcohol | 40 | parts by mass |
| having the following formulation | | |
| Water | 728 | parts by mass |
| Methanol | 228 | parts by mass |
| Glutaraldehyde (crosslinking agent) | 2 | parts by mass |
| Ester citrate (AS3, produced by | 0.69 | parts by mass |
| Sankio Chemical Co., Ltd.) | | |

Modified polyvinyl alcohol

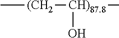

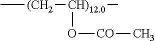

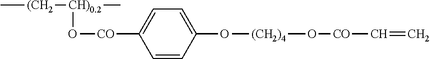

### (Formation of Optically Anisotropic Layer)

A coating solution obtained by dissolving 91.0 Kg of the following discotic liquid crystal compound, 9.0 Kg of an ethylene oxide-modified trimethylolpropane triacrylate (V#360, produced by OSAKA ORGANIC CHEMICAL INDUSTRY LTD.), 2.0 Kg of a cellulose acetate butyrate (CAB551-0.2, produced by Eastman Chemical Ltd.), 0.5 Kg of a cellulose acetate butyrate (CAB531-1, produced by Eastman Chemical Ltd.), 3.0 Kg of a photopolymerization initiator (Irgacure 907, produced by Ciba Geigy Inc.) and 1.0 Kg of a sensitizer (Kayacure DETX, produced by NIPPON KAYAKU CO., LTD.) in 207 Kg of methyl ethyl ketone and then adding 0.4 Kg of a fluoroaliphatic group-containing copolymer (Megafac F780, produced by DAINIPPON INK AND CHEMICALS, INCORPORATED) to the solution was continuously spread over the alignment film which was being conveyed at a rate of 20 m/min using a #3.2 wire bar which was being rotated at 391 rpm in the same direction as the direction of conveyance of the film. The film was then dried at a step where the film was continuously heated from room temperature to 100° C. to remove solvent. Thereafter, the film was heated for about 90 seconds in a 135° C. drying zone in such a manner that hot air hit the surface of the film at a rate of 1.5 m/sec in the direction parallel to that of conveyance of the film so that the discotic liquid crystal compound was aligned. Subsequently, the film was passed to a 80° C. drying zone where the film was irradiated with ultraviolet rays at an illuminance of 600 mW for 4 seconds using an ultraviolet radiator (ultraviolet lamp: output: 160 W/cm; length of light emitted: 1.6 m) with the surface temperature of the film kept at about 100° C. so that the crosslinking reaction proceeded to fix the discotic liquid crystal compound to its alignment. Thereafter, the film was allowed to cool to room temperature, and then wound cylindrically to form a rolled film. Thus, rolled optically compensatory films F15 to F28 were prepared from the films F1 to F14 prepared in Example 1, respectively.

The optically anisotropic layer exhibited an Re retardation value of 45 nm as measured by the method defined herein. The average direction of molecular symmetric axes of the optically anisotropic layer was −0.3° from the longitudinal direction of the optically compensatory film.

### Discotic Liquid Crystal Compound

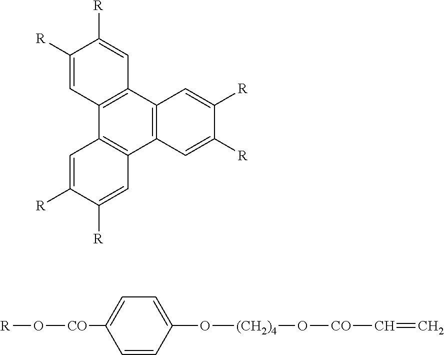

### Example 2-2

### Preparation of Optically Compensatory Films Having Optically Anisotropic Layer (F29 to F42)

A polyimide synthesized from 2,2′-bis(3,4-discarboxyphenyl)hexafluoropropane and 2,2′-bis(trifluoromethyl)-4,4′-diaminobiphenyl was dissolved in cyclohexanone to prepare a 15% by mass solution. The polyimide solution thus prepared was spread over the films (F1 to F14) prepared in Example 1 to a dry thickness of 6 μm, and then dried at 150° C. for 5 minutes. The film was then crosswise stretched in a 150° C. atmosphere using a tenter stretching machine by a factor of 15% to obtain films (F29 to F42).

### Example 3

### Preparation of Protective Films with Anti-Reflection Capacity (F43 to F56)

### (Preparation of Light-Scattering Layer Coating Solution)

50 g of a mixture of pentaerythritol triacrylate and pentaerythritol tetraacryalte (PETA, produced by NIPPON KAYAKU CO., LTD.) was diluted with 38.5 g of toluene. To the solution was then added 2 g of a polymerization initiator (Irgacure 184, produced by Ciba Geigy Specialty Chemicals Co., Ltd.). The mixture was then stirred. The refractive index of the coat layer obtained by spreading and ultraviolet-curing the solution was 1.51.

To the solution were then added 1.7 g of a 30% toluene dispersion of a particulate crosslinked polystyrene having an average particle diameter of 3.5 μm (refractive index: 1.60, SX-350, produced by Soken Chemical & Engineering Co., Ltd.) and 13.3 g of a 30% toluene dispersion of a particulate crosslinked acryl-styrene having an average particle diameter of 3.5 μm (refractive index: 1.55, produced by Soken Chemical & Engineering Co., Ltd.) which had both been dispersed at 10,000 rpm by a polytron dispersing machine for 20 minutes. Finally, to the solution were added 0.75 g of the following fluorine-based surface modifier (FP-1) and 10 g of a silane coupling agent (KBM-5103, produced by Shin-Etsu Chemical Co., Ltd.) to obtain a completed solution.

The aforementioned mixture was then filtered through a polypropylene filter having a pore diameter of 30 μm to prepare a light-scattering layer coating solution.

### Fluorine-Based Surface Modifier (FP-1)

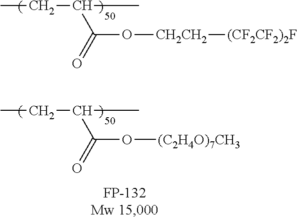

### (Preparation of Low Refractive Layer Coating Solution)

Firstly, a sol a was prepared in the following manner. In some detail, 120 parts of methyl ethyl ketone, 100 parts of an acryloyloxypropyl trimethoxysilane (KBM5103, produced by Shin-Etsu Chemical Co., Ltd.) and 3 parts of diisopropoxyaluminum ethyl acetoacetate were charged in a reaction vessel equipped with an agitator and a reflux condenser to make mixture. To the mixture were then added 30 parts of deionized water. The mixture was reacted at 60° C. for 4 hours, and then allowed to cool to room temperature to obtain a sol a. The mass-average molecular weight of the sol was 1,600. The proportion of components having a molecular weight of from 1,000 to 20,000 in the oligomer components was 100%. The gas chromatography of the sol showed that no acryloyloxypropyl trimethoxysilane which is a raw material had been left.

13 g of a thermally-crosslinkable fluorine-containing polymer (JN-7228; solid concentration: 6%; produced by JSR Co., Ltd.) having a refractive index of 1.42, 1.3 g of silica sol (silica having a particle size different from that MEK-ST; average particle size: 45 nm; solid concentration: 30%; produced by NISSAN CHEMICAL INDUSTRIES, LTD.), 0.6 g of the sol a thus prepared, 5 g of methyl ethyl ketone and 0.6 g of cyclohexanone were mixed with stirring. The solution was then filtered through a polypropylene filter having a pore diameter of 1 μn to prepare a low refractive layer coating solution.

(Preparation of Transparent Protective Film with Anti-Reflection Layer)

The aforementioned coating solution for functional layer (light-scattering layer) was spread over each of the films (F1 to F14) prepared in Example 1 which was being unwound from a roll at a gravure rotary speed of 30 rpm and a conveying speed of 30 m/min using a mircogravure roll with a diameter of 50 mm having 180 lines/inch and a depth of 40 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a functional layer to a thickness of 6 μm. The film was then wound.

The coating solution for low refractive layer thus prepared was spread over the triacetyl cellulose film having a functional layer (light-scattering layer) provided thereon which was being unwound at a gravure rotary speed of 30 rpm and a conveying speed of 15 m/min using a mircogravure roll with a diameter of 50 mm having 180 lines/inch and a depth of 40 μm and a doctor blade. The coated film was dried at 120° C. for 150 seconds and then at 140° C. for 8 minutes. The film was irradiated with ultraviolet rays at an illuminance of 400 mW/cm² and a dose of 900 mJ/cm² from an air-cooled metal halide lamp having an output of 240 W/cm (produced by EYE GRAPHICS CO., LTD.) in an atmosphere in which the air within had been purged with nitrogen to form a low refractive layer to a thickness of 100 nm. The film was then wound. Thus, protective films with anti-reflection capacity (F43 to F56) were prepared.

The anti-reflection films (F43 to F56) thus prepared were each then evaluated for surface conditions of coat layer. The evaluation of the surface conditions of coat layer was carried out by a method involving the observation of the film thus prepared by the transmission of light from three-wavelength fluorescent lamp and a method involving the reflective examination of the film having a black sheet or a polarizing plate blackened in crossed nicols under a three-wavelength fluorescent lamp or artificial sunshine.

1: Definite unevenness observed; 3: Slight unevenness observed; 5: No unevenness observed; 2, 4: Intermediate level

The results are set forth in Table 4.

### Example 4

### Preparation of Polarizing Plate

A polyvinyl alcohol (PVA) film having a thickness of 80 μm was dipped in an aqueous solution of iodine having an iodine concentration of 0.05% by mass at 30° C. for 60 seconds so that it was dyed, longitudinally stretched by a factor of 5 while being dipped in an aqueous solution of boric acid having a boric cid concentration of 4% by mass for 60 seconds, and then dried at 50° C. for 4 minutes to obtain a polarizing film having a thickness of 20 μm.

The films (F1, F8 to F10, F13 to F42) prepared in Examples 1 to 3 were each stuck to one side of a polarizer with a polyvinyl alcohol-based adhesive. The saponification of the cellulose acylate film was effected in the following manner.

A 1.5 N aqueous solution of sodium hydroxide was prepared. The aqueous solution was then kept at 55° C. A 0.01 N diluted aqueous solution of sulfuric acid was prepared. The aqueous solution was then kept at 35° C. The cellulose acylate film prepared was dipped in the aforementioned aqueous solution of sodium hydroxide for 2 minutes, and then dipped in water so that the aqueous solution of sodium hydroxide was thoroughly washed away. Subsequently, the cellulose acylate film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

A commercially available cellulose triester film (Fujitac TD80UF, produced by Fuji Photo Film Co., Ltd.) was saponified, stuck to the other side of the polarizer with a polyvinyl alcohol-based adhesive, and then dried at 70° C. for 10 minutes or more to prepare polarizing plates (P1 to P34).

Arrangement was made such that the transmission axis of the polarizer and the slow axis of the cellulose acylate film prepared in Examples 1 to 3 were disposed parallel to each other (FIG. 4) and the transmission axis of the polarizer and the slow axis of the commercially available cellulose triester film were disposed perpendicular to each other.

An acrylic adhesive was stuck to the polarizing plate prepared above on the cell side thereof. A separate film was then stuck to the acrylic adhesive. A protect film was stuck to the polarizing plate on the other side thereof.

### Example 5

### Mounting on Panel

### Example 5-1

The front and rear polarizing plates and the retarder film were peeled off a Type 32LC100 IPS mode liquid crystal TV (produced by TOSHIBA CORPORATION). The polarizing plates P1 to P6 prepared in Example 4 were each then stuck to the front and back sides of the liquid crystal. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side.

The evaluation of unevenness was made front ways, at 45° and at 135° in black display. The measurements were evaluated as follows.

1: Definite fog-like unevenness observed; 3: Slight fog-like unevenness observed; 5: No unevenness observed; 2,4: Intermediate level

The results are set forth in Table 2.

TABLE 2

| | | Evaluation of | |
|---|---|---|---|
| Polarizing | | unevenness in | |
| plate No. | Film No. | black display | Remarks |
| P1 | F1 | 5 | Inventive |
| P2 | F8 | 2 | Comparative |
| P3 | F9 | 5 | Inventive |
| P4 | F10 | 4 | Inventive |
| P5 | F13 | 5 | Inventive |
| P6 | F14 | 3 | Comparative |

### Example 5-2

The front and rear polarizing plates and the retarder film were peeled off a Type LC-20V1 TN mode liquid crystal TV (produced by SHARP CORPORATION), A commercially available polarizing plate free of viewing angle compensation plate (HLC2-5618, produced by SANRITZ CORPORATION) was stuck to the viewing side of the liquid crystal display device. The polarizing plates P7 to P20 prepared in Example 4 were each then stuck to the back side of the liquid crystal display device. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side. The samples were each then evaluated for unevenness in the same manner as in Example 5-1. The results are set forth in Table 3.

### Example 5-3

The front and rear polarizing plates and the retarder film were peeled off a Type LC-2005-S VA mode liquid crystal TV (produced by SHARP CORPORATION) A commercially available polarizing plate free of viewing angle compensation plate (BLC2-5618, produced by SANRITZ CORPORATION) was stuck to the viewing side of the liquid crystal display device. The polarizing plates P21 to P34 prepared in Example 4 were each then stuck to the back side of the liquid crystal display device. During this procedure, arrangement was made such that the absorption axis of the polarizing plate on the viewing side was disposed along the horizontal direction of the panel, the absorption axis of the polarizing plate on the backlight side was disposed on the vertical direction of the panel and the adhesive surface was disposed on the liquid crystal cell side. The samples were each then evaluated for unevenness in the same manner as in Example 5-1. The results are set forth in Table 3.

TABLE 3

| | | | Evaluation of | |
|---|---|---|---|---|
| Polarizing | Film | Support | unevenness in | |
| plate No. | No. | film No. | black display | Remarks |
| P7 | F15 | F1 | 5 | Inventive |
| P8 | F16 | F2 | 3 | Inventive |
| P9 | F17 | F3 | 3 | Inventive |
| P10 | F18 | F4 | 4 | Inventive |
| P11 | F19 | F5 | 3 | Inventive |
| P12 | F20 | F6 | 4 | Inventive |
| P13 | F21 | F7 | 2 | Comparative |
| P14 | F22 | F8 | 1 | Comparative |
| P15 | F23 | F9 | 5 | Inventive |
| P16 | F24 | F10 | 3 | Inventive |
| P17 | F25 | F11 | 5 | Inventive |
| P18 | F26 | F12 | 1 | Comparative |
| P19 | F27 | F13 | 5 | Inventive |
| P20 | F28 | F14 | 2 | Comparative |
| P21 | F29 | F1 | 5 | Inventive |
| P22 | F30 | F2 | 3 | Inventive |
| P23 | F31 | F3 | 3 | Inventive |
| P24 | F32 | F4 | 5 | Inventive |
| P25 | F33 | F5 | 4 | Inventive |
| P26 | F34 | F6 | 5 | Inventive |
| P27 | F35 | F7 | 2 | Comparative |
| P28 | F36 | F8 | 2 | Comparative |
| P29 | F37 | F9 | 5 | Inventive |
| P30 | F38 | F10 | 3 | Inventive |
| P31 | F39 | F11 | 4 | Inventive |
| P32 | F40 | F12 | 1 | Comparative |
| P33 | F41 | F13 | 4 | Inventive |
| P34 | F42 | F14 | 1 | Comparative |

TABLE 4

| | | Evaluation | |
|---|---|---|---|
| | | of unevenness | |
| | Support film | in reflected | |
| Film No. | No. | color | Remarks |
| F43 | F1 | 5 | Inventive |
| F44 | F2 | 3 | Inventive |
| F45 | F3 | 3 | Inventive |
| F46 | F4 | 4 | Inventive |
| F47 | F5 | 3 | Inventive |
| F48 | F6 | 5 | Inventive |
| F49 | F7 | 2 | Comparative |
| F50 | F8 | 1 | Comparative |
| F51 | F9 | 5 | Inventive |
| F52 | F10 | 3 | Inventive |
| F53 | F11 | 4 | Inventive |
| F54 | F12 | 1 | Comparative |
| F55 | F13 | 5 | Inventive |
| F56 | F14 | 2 | Comparative |

### INDUSTRIAL APPLICABILITY

In accordance with the solution method for preparing a film of the invention, a solution method for preparing a film which comprises flow-casting a dope containing a polymer and a solvent over a support which is endlessly running to form a cast film on the support, and then peeling the cast film as a film is employed wherein drying air is blown against the cast film from a blowing port within 15 seconds or less from the formation of the cast film on the support, making it possible to produce a film having improved planarity without using any special apparatus and lowering the film forming rate.

Further, when the cellulose acylate film of the invention is used for image display devices, an optical film having little optical unevenness can be provided.

The entire disclosure of each and every foreign patent application from which the benefit of foreign priority has been claimed in the present application is incorporated herein by reference, as if fully set forth.

1. A cellulose acylate film that has a maximum thickness difference (P−V value) of 1 μm or less within a range of a diameter of 60 mm with an arbitrary point as center, and that has an in-plane retardation Re_{(λ)} satisfying a relationship Re₍₅₉₀₎≦5 nm and a thickness-direction retardation Rth_{(λ)} satisfying a relationship |Rth₍₅₉₀₎|≦60 nm,
wherein Re_{(λ)} represents an in-plane retardation (Re) value (unit: nm) at a wavelength of λnm; and
Rth_{(λ)} represents a thickness-direction retardation (Rth) value (unit: nm) at a wavelength of λnm.

2. The cellulose acylate film according to claim 1,
wherein the in-plane retardation Re_{(λ)} and the thickness-direction retardation Rth_{(λ)} satisfy relationships |Re₍₄₀₀₎−Re₍₇₀₀₎|≦10 and |Rth₍₄₀₀₎−Rth₍₇₀₀₎|≦35, respectively.

3. The cellulose acylate film according to claim 1, which comprises:
a cellulose acylate having an acyl substitution degree of from 2.85 to 3.00; and
at least one compound represented by any of formulae (1) and (2) as a compound for decreasing Re(λ) and Rth(λ) in an amount of from 0.01% to 30% by mass based on an amount of the cellulose acylate: 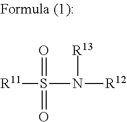
wherein R¹¹ represents an alkyl group or an aryl group; and
R¹² and R¹³ each independently represent a hydrogen atom, an alkyl group or an aryl group: 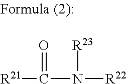
wherein R²¹ represents an alkyl group or an aryl group; and
R²² and R²³ each independently represent a hydrogen atom, an alkyl group or an aryl group.

4. The cellulose acylate film according to claim 1, which has a thickness of the film of from 40 μm to 180 μm.

5. A solution method for preparing a film of claim 1, which comprises:
flow-casting a dope containing a polymer and a solvent from a casting die over a support which is endlessly running to form a cast film on the support from the dope; and then blowing drying air onto the cast film at a velocity of 3 m/s or more since 15 seconds or less after the flow casting of the dope over the support on condition that an air flows over a surface of the cast film at a velocity of less than 3 m/s before a hitting of the drying air against the cast film; and
peeling the cast film as a film.

6. The solution method according to claim 5,
wherein a temperature of the drying air is from not lower than 40° C. to not higher than 150° C.

7. A solution method for preparing a film of claim 1, which comprises:
flow-casting a dope containing a polymer and a solvent from a casting die over a support which is endlessly running to form a cast film on the support from the dope; and then
peeling the cast film as a film,
wherein an initial film which acts as a film for initiating a formation of the film is formed on a surface of the cast film to exert a leveling effect by which the surface of the cast film is smoothened.

8. An optically compensatory film, which comprises:
a cellulose acylate film according to claim 1; and
an optically anisotropic layer provided on the cellulose acylate film.

9. The optically compensatory film according to claim 8,
wherein the optically anisotropic layer contains a discotic liquid crystal layer.

10. The optically compensatory film according to claim 8,
wherein the optically anisotropic layer contains a rod-shaped liquid crystal layer.

11. The optically compensatory film according to claim 8,
wherein the optically anisotropic layer contains a polymer film.

12. The optically compensatory film according to claim 11,
wherein the polymer film contained in the optically anisotropic layer contains at least one polymer material selected from the group consisting of polyamide, polyimide, polyester, polyether ketone, polyamideimide, polyesterimide and polyarylether ketone.

13. An anti-reflection film, which comprises:
a cellulose acylate film according to claim 1; and
at least one layer selected from the group consisting of a hard coat layer, an anti-glare layer and an anti-reflection layer provided on the cellulose acylate film.

14. A polarizing plate, which comprises:
a polarizer; and
a cellulose acylate film according to claim 1 as a protective film for the polarizer.

15. The polarizing plate according to claim 14, which further comprises at least one of a hard coat layer, an anti-glare layer and an anti-reflection layer on a surface of a protective film disposed on a side of the polarizing plate opposite a liquid crystal cell.

16. An image display device, which comprises a cellulose acylate film according to claim 1.

17. An image display device, which comprises a polarizing plate according to claim 14.
